(19) United States
(12) Patent Application Publication
(10) Pub. No.: US 2026/0200959 A1
(43) Pub. Date: Jul. 16, 2026

(54) METHODS FOR PRODUCING AND PURIFYING ORGANOTIN COMPOUNDS, SUPPRESSING FORMATION OF DIALKYL TIN COMPOUNDS, AND SELECTIVELY REMOVING TETRAKIS(DIALKYLAMINO) TIN COMPOUNDS

(71) Applicants: Gelest, Inc., Morrisville, PA (US); Mitsubishi Chemical Corporation, Tokyo (JP)

(72) Inventors: Li YANG, Belle Mead, NJ (US); Thao NGUYEN, Fairless Hills, PA (US); Koki ISHII, Tokyo (JP); Yuta HIOKI, Tokyo (JP); Koki MATSUZAKA, Tokyo (JP)

(21) Appl. No.: 19/437,580

(22) Filed: Dec. 31, 2025

Related U.S. Application Data
(62) Division of application No. 18/825,707, filed on Sep. 5, 2024.
(60) Provisional application No. 63/537,260, filed on Sep. 8, 2023.
(60) Provisional application No. 63/663,442, filed on Jun. 24, 2024.

(30) Foreign Application Priority Data
Dec. 1, 2023 (JP) 2023-204285

(51) Int. Cl. C07F 7/22

(52) U.S. Cl. CPC C07F 7/2284; C07F 7/2296

(57) ABSTRACT

Aspects of the disclosure relate to methods for producing organotin compounds with high purity, which may involve the use of specific additives or reaction conditions. Methods for purifying organotin compounds and suppressing the formation of impurities in organotin compounds are also described.

### CROSS-REFERENCE TO RELATED APPLICATIONS

This application claims priority to U.S. provisional application No. 63/663,442, filed Jun. 24, 2024; U.S. provisional application No. 63/537,260, filed Sep. 8, 2023; and Japanese application number JP 2023-204285, filed Dec. 1, 2023, the disclosures of which are herein incorporated by reference in their entireties.

### BACKGROUND OF THE INVENTION

In recent years, against the backdrop of a paradigm of shift to an advanced information society, there is a need to handle larger amounts of information faster and with higher precision. Technologies related to integrated circuits and semiconductor devices are advancing rapidly each day.

Advancement of semiconductor designs requires microfeatures to be formed on semiconductor substrates. Individual features may be about 22 nanometers (nm) or smaller, and in some cases less than 10 nm. One challenge in the manufacturing of devices with such microfeatures is the ability to reliably and reproducibly form photolithographic masks with sufficient resolution. Achieving feature sizes smaller than the wavelength of light requires the use of complex high-resolution techniques such as multiple patterning. Hence, the development of photolithographic techniques that use light with even shorter wavelengths, such as extreme ultraviolet (EUV) with wavelengths from 10 nm to 15 nm (e.g., 13.5 nm), holds great importance.

Conventional organic chemically amplified resists (CARs) have low adsorption coefficients, especially in the EUV range. As a result, the diffusion of photoactive chemical species may be blurred, and line edge roughness may occur. Therefore, CAR has potential drawbacks when used in EUV lithography. Accordingly, there is a need for improved EUV photoresist materials with the properties of thinner thickness, better absorbance, and better etch resistance.

As semiconductor fabrication continues to advance, feature sizes continue to shrink, driving the need for new processing methods. Certain organotin compounds have been shown to be useful in the deposition of tin oxide hydroxide coatings in applications such as extreme ultraviolet (EUV) lithography techniques. For example, alkyl tin compounds provide radiation sensitive Sn—C bonds that can be used to pattern structures lithographically.

Materials used in microelectronic fabrication are required to be extremely pure with tight limits placed on organic contamination (e.g., reaction by-products), metallic contamination, and particulate contamination. Purity requirements are stringent in general, and particularly for lithography applications because the chemical is in contact with the semiconductor substrates and the organometallic impurities in compounds such as diisopropylbis(dimethylamino)tin, (iPr)₂Sn(NMe₂)₂, can affect the properties of the resultant film. Exact targets for purities are determined by a variety of factors, including performance metrics, but typical minimum purity targets are 3N+. Residual metals present in the chemicals can be deposited onto the semiconductor substrate and degrade the electrical performance of the device being fabricated. Typical specification for metals are less than 10 ppb for individual metals and total metal not to exceed ~100 ppb.

Recently, materials with liquid chemical vapor deposition (CVD), such as organotins, have begun to be used as resist materials specifically for EUV applications. To achieve high-quality film formation, extremely high-purity resist materials are required. For this reason, tin compounds having one organic group (hereinafter sometimes referred to as “monoalkyltin compounds”) have been synthesized (JP-A2020-122959).

However, purification of such compounds is typically required. For example, before using a monoalkyltin compound as a resist material, water, residual solvent used in the synthesis, and metal-based impurities are removed by distillation (JP-A2020-122959).

It is known that during their synthesis or purification, organotin compounds may be involved in side reactions such as disproportionation reactions to produce by-products. In particular, monoalkyltin compounds are prone to generating decomposition products. Especially, because dialkyltin compounds generated as by-products in the reaction process have similar boiling points and are difficult to remove by distillation, the amounts of such impurities must be reduced by adjusting the reaction conditions and post-treatment conditions. A method for obtaining high-purity monoalkyltin compounds has been disclosed in U.S. Patent Application Publication No. 2022/0242888, in which high-purity monoalkyltin compounds can be obtained by reactions at low temperatures in combination with the use of excessive reaction reagents.

As noted above, the processing and performance of semiconductor materials can be sensitive to dialkyl tin contaminants. Dialkyl tin impurities, R₂Sn(NMe₂)₂, where R is an alkyl group, are the source of off-gassing after vapor phase deposition or spin-on coating processes due to the oxostannate cluster films being less dense when the film contains dialkyl groups. To produce microelectronic products using EUV lithography, proper control of dialkyl tin contaminants is required. The high purity required from the mono-alkyl tin precursor manufacturing process becomes a challenge. In general, the syntheses of monoalkyl tin triamides have previously employed lithium dimethylamide reagents reacted with alkyl tin trichloride, or followed by a lithium/Grignard reagent (alkylating agent) to convert the tin tetraamides to the desired triamides.

Kocheshkov-like comproportionation during scheme (I) and the disproportion scheme (II), shown below, during purification are the two main challenges when preparing primary alkyl tin triamides, such as methyl and longer alkyl tin triamides, which contain no more than 1% dialkyl tin after purification. Studies have shown that comproportionation occurs independent of the reaction temperature, down to −78° C. In fact, lower temperatures have been found to slow the substitution reaction, which increases the risk of comproportionation

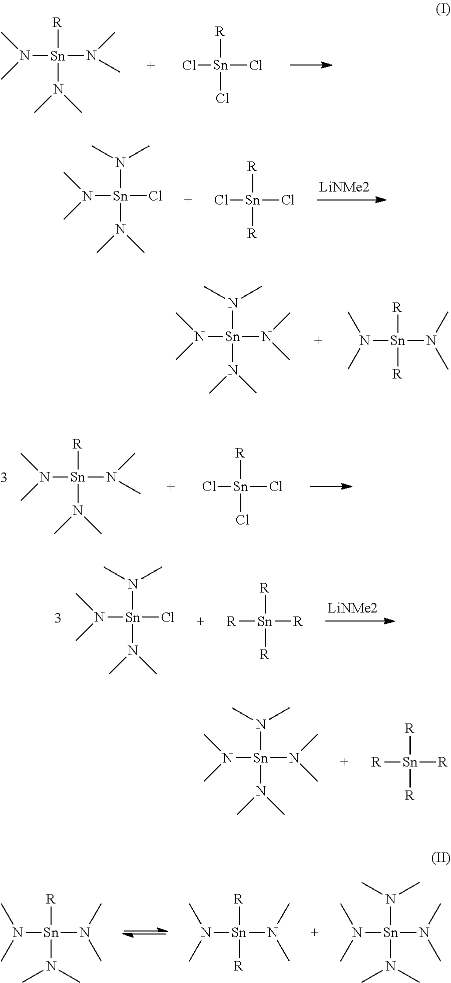

The preparation of monoalkyl tin triamide compounds may be accomplished by two different known synthetic pathways. When the alkyl group contains a primary and/or a secondary moiety, such as methyl tris(dimethylamino)tin (MeSn(NMe₂)₃) or isopropyl tris(dimethylamino)tin (iPrSn(NMe₂)₃), the synthesis may be performed using lithium dimethylamide and alkyl tin trichloride (amination) according to the method of Lorberth (Journal of Organometallic Chemistry; 16(2), 235-48 (1969)); see also Jones and Lappert (Organometal. Chem. Rev.; 1, 67 (1966)), as shown in scheme (III). However, this reaction typically produces significant amounts of dialkyl tin and other tin impurities.

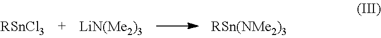

Alternatively, when the alkyl group contains a tertiary alkyl moiety, such as tert-butyl tris(dimethylamino)tin (t-BuSn(NMe₂)₃), the compounds must be synthesized using an alkylating reagent to convert tin tetraamides by controlling the stoichiometry according to the method reported by Hanssgen et al. (Journal of Organometallic Chemistry, 293(2), 191-5 (1985)), as shown in scheme (IV).

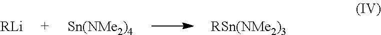

The reaction of scheme (IV) using an alkylating reagent and tetraamides is not effective for the preparation of primary and secondary monoalkyl tin triamide compounds. Rather, the use of a primary alkylating reagent will convert tin tetraamides to trialkyltin amides and unreacted tetraamides, even when using the correct stoichiometry. Secondary alkylating reagents will also convert tin tetraamides to polyalkyl tin compounds.

When the alkyl group in the monoalkyltin triamide compound is a tertiary alkyl group such as t-BuSnCl₃, Hanssgen et al. also reports that this compound decomposes rapidly at room temperature, yielding SnCl₂ and t-BuCl. Therefore, tertiary monoalkyl tin triamide compounds cannot be prepared by synthesis with lithium dimethylamide and alkyl tin trichloride.

In the synthesis reaction of organotin compounds, by-products may be generated due to disproportionation reactions caused by heating. In particular, monoalkyltin compounds are prone to generating decomposition products,

Distillation is a well-developed technology for separating materials in a mixture based on their relative volatility. The exact embodiment of the distillation process depends on the properties, the composition, and the amount of the mixture to be separated. Distillation can and has been used to reduce metallic contamination in multitudes of materials, including organometallic compounds.

However, for these compounds, it is difficult to increase the purity through a distillation process involving heating. With respect to distillation techniques for obtaining high-purity monoalkyltin compounds, techniques of using distillation columns with a high theoretical number of stages and multiple distillations have been disclosed (see, for example, JP-A2020-530199).

As additives for the distillation of organotin compounds, tetradentate ligands or chelating agents such as tris(2-aminoethyl) amine (TREN) and triethylenetetramine (triene) have also been disclosed, such as in JP-A2023-27327) which mentions the effect of promoting distillation purification by complexing these additives with unreacted chemical species.

Unstable monoalkyltin compounds have high decomposition rates at the temperatures required for distillation. In addition, the boiling points of several impurities in the crude product are close to each other. Thus, distillation with advanced separation performance is necessary for the purification of monoalkyltin compounds. Due to these reasons, the distillation and purification of monoalkyltin compounds have multiple challenges.

Even in the case of purification using known additives and chelating agents prior to distillation, the optimal additive structure, amount, and adding method, reaction method, post-treatment method, and distillation method have not been fully investigated for the impurities that pose challenges for the distillation and purification of monoalkyltin compounds.

Especially in industrial manufacturing, where large scales, high productivity, high economy, high uniformity, efficient agitation conditions, process liquid handleability (viscosity, slurry properties, etc.), and stable production are required, a more optimal method is needed.

The ability to prepare and isolate alkylamino tin compounds having desired extremely high purity levels would be very attractive for use in the microelectronic industry.

### SUMMARY OF THE INVENTION

Aspects of the disclosure relate to a method for synthesizing a monoalkyl tin triamide compound having formula (1) by reacting a monoalkyl tin trihalide compound having formula (5) with a metal amide compound having formula (6) or (7), wherein the reaction is performed in the presence of tin a tetrahalide having formula (4):

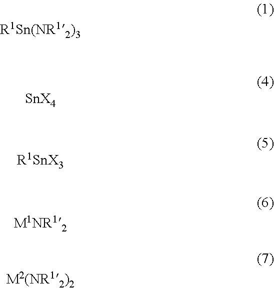

wherein R¹ is an alkyl group having about 1 to 30 carbon atoms which may be substituted with at least one halogen, oxygen, or nitrogen atom; R^{1′} is an alkyl group having about 1 to 10 carbon atoms; M¹ is a monovalent metal, M² is a divalent metal, and each X is independently F, Cl, Br, or I.

Further aspects of the disclosure relate to a method of synthesizing a monoalkyl tin triamide compound having formula (1):

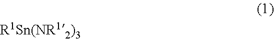

wherein R¹ and R^{1′} are each independently a primary alkyl group having about 1 to about 10 carbon atoms or a secondary alkyl group having about 3 to about 10 carbon atoms, the method comprising:
(a) preparing a metal dialkylamide solution
(b) preparing a mixture comprising a tin tetrahalide compound having formula (4) and a monoalkyl tin trihalide compound having formula (5); and
(c) adding the mixture to the metal dialkylamide solution:

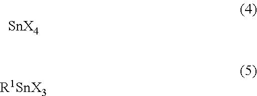

wherein each X is independently F, Cl, Br, or I.

Additional aspects of the disclosure relate to a method of synthesizing a monoalkyl tin triamide compound having formula (1) and containing no detectable amount of a dialkyl tin diamide compound having formula (2):

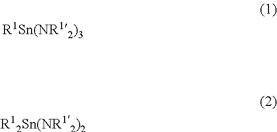

wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dialkylamide having a concentration in the solution of up to about 10 wt %;
(b) preparing a premix solution comprising tetrachlorotin and an alkyltrichloro tin compound R¹SnCl₃ in a second solvent, wherein an amount of the tetrachlorotin in the premix solution is about 0.1 to about 5 mol % relative to the amount of the alkyl trichlorotin compound;
(c) adding the premix solution to the lithium dimethylamide at about −10° C. to about 10° C. to produce a reaction mixture, wherein the amount of lithium dimethylamide in the reaction mixture is at least about 3.09 equivalents relative to the amount of the alkyl trichlorotin compound;
(d) removing the LiCl salt product by filtration; and
(e) removing the first solvent and the second solvent under vacuum to produce a product containing the monoalkyl tin triamide having formula (1) and no detectable amount of the dialkyl tin diamide compound having formula (2).

Further aspects of the disclosure relate to a method of synthesizing a monoalkyl tin triamide compound having formula (1) and containing no detectable amount of a dialkyl tin diamide compound having formula (2):

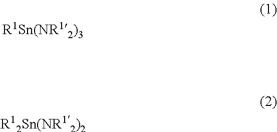

wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dimethylamide having a concentration in the solution of up to about 10 wt %;
(b) adding a solution of tetrachlorotin in a second solvent to the lithium dialkylamide at about −15° C. to about 0° C. to produce a reaction mixture containing about 0.3% to about 2 mol % tetrakis(dialkylamino)tin relative to an amount of the lithium dialkylamide;
(c) adding a solution of an alkyl trichlorotin compound R¹SnCl₃ in a third solvent to the reaction mixture at about −15° C. to about 10° C., wherein the amount of lithium dimethylamide in the reaction mixture is at least about 3.09 equivalents relative to the amount of the alkyl trichlorotin compound and wherein the amount of tetrachlorotin in the reaction mixture is about 0.1 mol % to about 5 mol % relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

Additional aspects of the disclosure relate to a method of synthesizing a monoalkyl tin triamide compound having formula (1) and containing no detectable amount of a dialkyl tin diamide compound having formula (2):

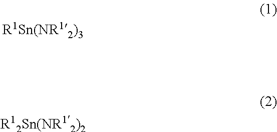

wherein R¹ and R^{1′} are each independently a primary alkyl group having about 1 to 10 carbon atoms or a secondary alkyl group having about 3 to 10 carbon atoms, the method comprising:
(a) lithiating a dialkylamine in a solution containing a first solvent to produce a lithium dimethylamide having a concentration in the solution of up to about 10 wt %;
(b) adding a solution of tetrakis(dialkylamino)tin in a second solvent to the lithium dimethylamide at about −15° C. to about 0° C. to produce a reaction mixture, wherein an amount of tetrakis(dialkylamino)tin in the reaction mixture is about 0.3 mol % to about 2 mol % relative to the amount of the lithium dialkylamide;
(c) adding a solution of an alkyl trichlorotin compound RiSnCl₃ in a third solvent to the reaction mixture at about −15° C. to about 0° C., wherein the amount of lithium dimethylamide in the reaction mixture is at least about 3.09 equivalents relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

Further aspects of the disclosure are directed to a method for producing a tin composition (P1) comprising a monoalkyl tin compound having formula (A1) and a purity of at least about 80 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T 1:

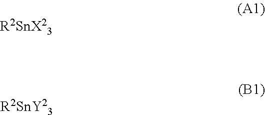

wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13.

Additional aspects of the disclosure relate to a method for producing a tin composition (P1) comprising a monoalkyl tin compound having formula (A1) and a purity of at least about 80 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1, wherein the blending is performed at the contact temperature T1 for at least half of the time period t, and wherein a lower limit of T1 is a temperature at which a formation ratio (A1)/(A2) of the monoalkyl tin compound having formula (A1) from a reaction intermediate R²SnX²₂Y² to the dialkyltin compound having formula (A2) from a disproportionation of R²SnX²₂Y² is 600 or more and an upper limit of T1 is less than a lowest value of the decomposition temperatures of (B1), (A1) and (M1), and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T1:

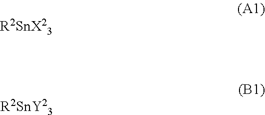

wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13.

Further aspects of the disclosure are directed to a method for producing a tin composition (P11) comprising a monoalkyl tin compound having formula (A11), the method comprising contacting a raw material tin compound having formula (B11) and a reactant (M11) in an organic solvent and blending the raw material tin compound having formula (B11) and the reactant (M11) in the organic solvent for a blending time period t at a contact temperature T1, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B11) is blended with the reactant (M11) at the contact temperature T1, or
(b) at least 50% by weight of the reactant (M11) is blended with the raw material tin compound having formula (B 11) at the contact temperature T1:

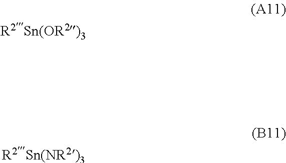

wherein each R^{2″″} is independently a secondary or tertiary organic group having about 3 to 30 carbon atoms, which may be substituted with at least one halogen atom, oxygen atom or nitrogen atom; each R^{2′} is independently an organic group having about 1 to 10 carbon atoms, which may be the same or different and may be substituted with at least one halogen atom; each R^{2″} is independently an organic group having about 2 to 10 carbon atoms, which may be the same or different and may be substituted with at least one halogen atom, and wherein when there is more than one R^{2″} in a molecule, the structures may be different from each other, and may be bonded together to form a cyclic structure; and
wherein (M11) is a compound having formula HOR^{2″}.

Additional aspects of the disclosure are directed to a method for producing a tin composition (P1) comprising a monoalkyl tin compound having formula (A1) and a purity of at least about 80 mol %, the method comprising contacting a raw material tin compound having formula (B1) and a reactant (M2) in an organic solvent and blending the raw material tin compound having formula (B1) and the reactant (M2) in the organic solvent for a blending time period t at a contact temperature T1, wherein the blending is performed at the contact temperature T1 for at least half of the time period t, wherein the contact temperature T1 is in a range of about 10° C. to about 70° C., and wherein:
at least 50% by weight of the raw material tin compound (B1) is blended with the reactant (M2), or the blade tip speed, calculated by the following formula as the agitation speed when at least 50% by weight of the raw material tin compound (B1) is blended with the reactant (M2), is 1.2 m/s or higher.

Blade tip speed (m/s)=3.14×number of revolutions (rpm)×diameter of mixing blade (m)/60:

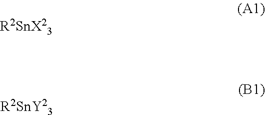

wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M2) is a compound having formula MX², MX²₂, MX²₃, or IX² where M represents a metal atom of Group 1, 2, 12, or 13.

Further aspects of the disclosure are related to a method for producing a tin composition (P1) comprising a monoalkyl tin compound having formula (A1) and a purity of at least about 80 mol %, the method comprising contacting a raw material tin compound having formula (B1) and a reactant (M2) in an organic solvent and blending the raw material tin compound having formula (B1) and the reactant (M2) in the organic solvent for a blending time period t at a contact temperature T1, wherein the blending is performed at the contact temperature T1 for at least half of the time period t, and wherein the contact temperature T1 is in a range of about 10° C. to about 70° C., and wherein
the organic solvent has a moisture content of 10 to 80 ppm:

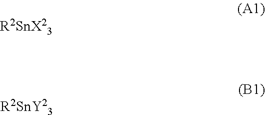

wherein R² is an organic group having about 1 to 30 carbon atoms, which may be substituted with at least one halogen, oxygen or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M2) is a compound having formula MX², MX²₂, MX²₃, or HX² where M represents a metal atom of Group 1, 2, 12, or 13.

Further aspects of the disclosure are directed to a method for producing an organotin compound, comprising steps of:
mixing a crude product containing an organotin compound having formula (a1) with an additive (b1) to form a mixture (x1) containing the crude product and the additive (b1), and
recovering the organotin compound (a1) having a purity of 95 mol % or higher by distilling the mixture (x1) containing the crude product and the additive (b1):

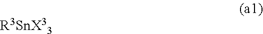

wherein in the formula (a1), R³ represents a hydrocarbon group having about 1 to 30 carbon atoms, which may each be substituted with a halogen atom, an oxygen atom, or a nitrogen atom,
each X³ is independently OR^{3′} or NR^{3′}₂, wherein R^{3′} is a hydrocarbon group having about 1 to 30 carbon atoms, which may each be substituted with a halogen atom, an oxygen atom, or a nitrogen atom, the three R^{3′} may be the same or different from each other; and R³ and R^{3′} may be bonded to each other to form a cyclic structure;
the additive (b1) is a hydrocarbon compound containing about 2 to about 20 carbon atoms substituted with at least one nitrogen and/or oxygen atom and satisfies a condition (1a) and a condition (2):
condition (1a): when the number of nitrogen atoms in the hydrocarbon compound is m and the number of oxygen atoms is n, m is 0, 1, 2 or 3, n is 0, 1, 2 or 3, and m+n is 2 or 3;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Further aspects of the disclosure are related to a method for producing an organotin compound, comprising steps of:
mixing a crude product containing an organotin compound having formula (a1) with an additive (b2) to form a mixture (x2) containing the crude product and the additive (b2),
wherein the mixture (x2) further contains an organotin compound having formula (a3), and wherein an amount of the additive (b2) in the mixture is about 0.5 to 10 times an amount of the organotin compound having formula (a3):

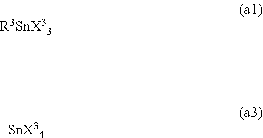

wherein R³ represents a hydrocarbon group having about 1 to 30 carbon atoms, which may each be substituted with a halogen atom, an oxygen atom, or a nitrogen atom, and
each X³ is independently OR^{3′} or N^{3′}₂, wherein R^{3′} is a hydrocarbon group having about 1 to 30 carbon atoms, which may be substituted with a halogen atom, an oxygen atom, or a nitrogen atom, the three R^{3′} may be the same or different from each other; and R³ and R^{3′} may be bonded to each other to form a cyclic structure;
the additive (b2) is a hydrocarbon compound containing about 2 to about 20 carbon atoms substituted with at least one nitrogen and/or oxygen atom and satisfies a condition (1b) and a condition (2):
condition (1b): when the number of nitrogen atoms in the hydrocarbon compound is m and the number of oxygen atoms is n, m is 0, 1, 2, 3, 4, or 5, n is 0, 1, 2, 3, 4, or 5, and m+n is 2, 3 4, 5,6, 7, 8, 9, or 10;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Additional aspects of the disclosure are directed to a method for producing an organotin compound, comprising steps of:
mixing a crude product containing an organotin compound having formula (a1) with an additive (b3) to form a mixture (x3) containing the crude product and the additive (b3), and
recovering the organotin compound (a1) with a purity of 95 mol % or higher by distilling the mixture (x3) containing the crude product and the additive (b3);

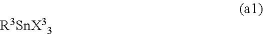

wherein in the formula (a1), R³ represents a hydrocarbon group having about 1 to 30 carbon atoms, which may be substituted with a halogen atom, an oxygen atom, or a nitrogen atom, and
each X³ is independently OR^{3′} or NR^{3′}₂, wherein R^{3′} is a hydrocarbon group having about 1 to 30 carbon atoms, which may be substituted with a halogen atom, an oxygen atom, or a nitrogen atom, the three R^{3′} may be the same or different from each other; and R³ and R^{3′} may be bonded to each other to form a cyclic structure; and
the additive (b3) is a polymer resin containing sulfur atoms.

Additional aspects of the disclosure relate to a method for producing an organotin compound, comprising steps of:
mixing a crude product containing an organotin compound having formula (a1) with an additive (b2) and an organic solvent to form a mixture (x4) containing the crude product, the additive (b2), and the organic solvent, and
recovering the organotin compound (a1) with a purity of 95 mol % or higher by distilling the mixture (x4) containing the crude product, the additive (b2), and the organic solvent, wherein
a content of the organic solvent in the mixture (x4) is 100 parts by mass or more relative to 100 parts by mass of the additive (b2);

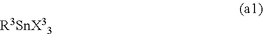

wherein R³ represents a hydrocarbon group having about 1 to 30 carbon atoms, which may be substituted with a halogen atom, an oxygen atom, or a nitrogen atom, and
each X³ is independently OR^{3′} or NR^{3′}₂, wherein R^{3′} is a hydrocarbon group having about 1 to 30 carbon atoms, which may be substituted with a halogen atom, an oxygen atom, or a nitrogen atom, the three R^{2′} may be the same or different from each other; and R³ and R^{3′} may be bonded to each other to form a cyclic structure;
the additive (b2) is a hydrocarbon compound containing about 2 to about 20 carbon atoms substituted with at least one nitrogen and/or oxygen atom and satisfies a condition (1b) and a condition (2):
condition (1b): when the number of nitrogen atoms in the hydrocarbon compound is m and the number of oxygen atoms is n, m is 0, 1, 2, 3, 4, or 5, n is 0, 1, 2, 3, 4, or 5, and m+n is 2, 3 4, 5,6, 7, 8, 9, or 10;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Further aspects of the disclosure relate to a method for producing a tin composition (P1) comprising a monoalkyl tin compound having formula (A1) and a purity of at least about 95 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1 to produce a crude product, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T1:

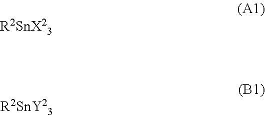

wherein R² is an organic group having about 1 to 30 carbon atoms, which may be substituted with at least one halogen, oxygen or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13;
the method further comprising:
mixing the crude product with an additive (b1) to form a mixture (y1) containing the crude product and the additive (b1), and
recovering the tin composition (P1) comprising the monoalkyl tin compound having formula (A1) and a purity of at least about 95 mol %, by distilling the mixture (y1) containing the crude product and the additive (b1):
wherein the additive (b1) is a hydrocarbon compound containing about 2 to about 20 carbon atoms substituted with at least one nitrogen and/or oxygen atom and satisfies a condition (1a) and a condition (2):
condition (1a): when the number of nitrogen atoms in the hydrocarbon compound is m and the number of oxygen atoms is n, m is 0, 1, 2 or 3, n is 0, 1, 2 or 3, and m+n is 2 or 3;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Further aspects of the disclosure are directed to a method for synthesizing a monoalkyl tin triamide compound having formula (1) and a purity of at least about 95% by reacting a monoalkyl tin trihalide compound having formula (5) with a metal amide compound having formula (6) or (7) to form a crude product, wherein the reaction is performed in the presence of tin tetrahalide having formula (4):

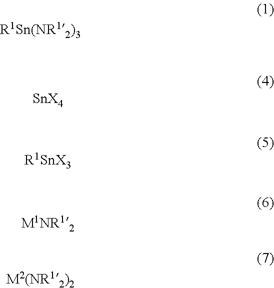

wherein R¹ and R^{1′} are each independently a primary alkyl group having about 1 to about 10 carbon atoms or a secondary alkyl group having about 3 to about 10 carbon atoms; M¹ is a monovalent metal, M² is a divalent metal, and each X is independently F, Cl, Br, or I;
the method further comprising:
mixing the crude product with an additive (b1) to form a mixture (z1) containing the crude product and the additive (b1), and
recovering the monoalkyl tin compound having formula (1) and a purity of at least about 95 mol % by distilling the mixture (z1) containing the crude product and the additive (b1):
wherein the additive (b1) is a hydrocarbon compound containing about 2 to about 20 carbon atoms substituted with at least one nitrogen and/or oxygen atom and satisfies a condition (1a) and a condition (2):
condition (1a): when the number of nitrogen atoms in the hydrocarbon compound is m and the number of oxygen atoms is n, m is 0, 1, 2 or 3, n is 0, 1, 2 or 3, and m+n is 2 or 3;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Additional aspects of the disclosure are directed to a method of purifying a mixture containing a monoalkyl tin triamide compound having formula (1), no detectable amount of a dialkyl tin diamide compound having formula (2), and about 0.1 to about 5 mol % of a tetrakis(dialkylamino)tin compound having formula (8):

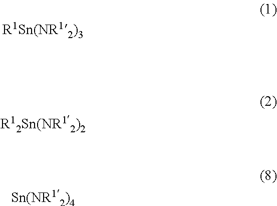

wherein R¹ and R^{1′} are each independently a primary alkyl group having about 1 to about 10 carbon atoms or a secondary alkyl group having about 3 to about 10 carbon atoms, the method comprising:
adding at least one weak acid, at least one weak base, at least one weak acid polymer, or at least one weak base polymer to the mixture containing compounds (1) and (8) at about 15° C. to about 30° C. to produce a reaction mixture, wherein an amount of the at least one weak acid, the at least one weak base, the at least one weak acid polymer, or the at least one weak base polymer in the reaction mixture is at least about 2 equivalents relative to the amount of compound (8); and
removing reaction byproducts to produce a mixture containing the monoalkyl tin triamide having formula (1), no detectable amount of the dialkyl tin diamide compound having formula (2), and no detectable amount of the tetrakis(dimethylamino)tin compound having formula (8).

Further aspects of the disclosure are related to a method of purifying a mixture containing a monoalkyl tin triamide compound having formula (1), less than 0.05 mol % of a dialkyl tin diamide compound having formula (2), and about 0.1 to about 5 mol % of a tetrakis(dialkylamino)tin compound having formula (8):

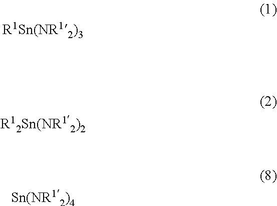

wherein R¹ and R^{1′} are each independently a primary alkyl group having about 1 to about 10 carbon atoms or a secondary alkyl group having about 3 to about 10 carbon atoms, the method comprising:
(a) adding at least one weak acid, at least one weak base, at least one weak acid polymer, or at least one weak base polymer to the mixture containing compounds (1) and (8) at about 15° C. to about 30° C. to produce a reaction mixture, wherein an amount of the at least one weak acid, the at least one weak base, the at least one weak acid polymer, or the at least one weak base polymer in the reaction mixture is at least about 2 equivalents relative to the amount of compound (8); and
(b) removing reaction byproducts to produce a mixture containing the monoalkyl tin triamide having formula (1), less than 0.05 mol % of the dialkyl tin diamide compound having formula (2), and less than 0.1 mol % of the tetrakis(dimethylamino)tin compound having formula (8).

Advantageous refinements of the invention, which can be implemented alone or in combination, are specified in the dependent claims.

In summary, the following embodiments are proposed as particularly preferred in the scope of the present invention:

Embodiment 1: A method for synthesizing a monoalkyl tin triamide compound having formula (1) by reacting a monoalkyl tin trihalide compound having formula (5) with a metal amide compound having formula (6) or (7), wherein the reaction is performed in the presence of tin a tetrahalide having formula (4):

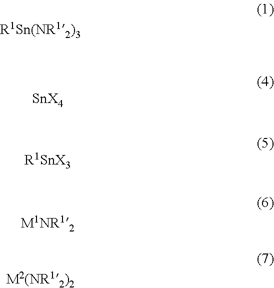

wherein R¹ is an alkyl group having about 1 to 30 carbon atoms which may be substituted with at least one halogen, oxygen, or nitrogen atom; R^{1′} is an alkyl group having about 1 to 10 carbon atoms; M¹ is a monovalent metal, M² is a divalent metal, and each X is independently F, Cl, Br, or I.

Embodiment 2: A method of synthesizing a monoalkyl tin triamide compound having formula (1):

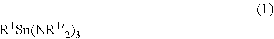

wherein R¹ and R^{1′} are each independently a primary alkyl group having about 1 to about 10 carbon atoms or a secondary alkyl group having about 3 to about 10 carbon atoms, the method comprising:
(a) preparing a metal dialkylamide solution
(b) preparing a mixture comprising a tin tetrahalide compound having formula (4) and a monoalkyl tin trihalide compound having formula (5); and
(c) adding the mixture to the metal dialkylamide solution:

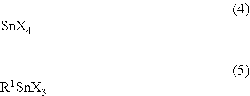

wherein each X is independently F, Cl, Br, or I.

Embodiment 3: A method of synthesizing a monoalkyl tin triamide compound having formula (1) and containing no detectable amount of a dialkyl tin diamide compound having formula (2):

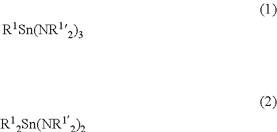

wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dialkylamide having a concentration in the solution of up to about 10 wt %;
(b) preparing a premix solution comprising tetrachlorotin and an alkyltrichloro tin compound R¹SnCl₃ in a second solvent, wherein an amount of the tetrachlorotin in the premix solution is about 0.1 to about 5 mol % relative to the amount of the alkyl trichlorotin compound;
(c) adding the premix solution to the lithium dimethylamide at about −10° C. to about 10° C. to produce a reaction mixture, wherein the amount of lithium dimethylamide in the reaction mixture is at least about 3.09 equivalents relative to the amount of the alkyl trichlorotin compound;
(d) removing the LiCl salt product by filtration; and
(e) removing the first solvent and the second solvent under vacuum to produce a product containing the monoalkyl tin triamide having formula (1) and no detectable amount of the dialkyl tin diamide compound having formula (2).

Embodiment 4: A method of synthesizing a monoalkyl tin triamide compound having formula (1) and containing no detectable amount of a dialkyl tin diamide compound having formula (2):

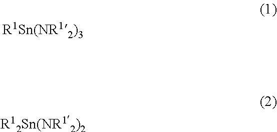

wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dimethylamide having a concentration in the solution of up to about 10 wt %;
(b) adding a solution of tetrachlorotin in a second solvent to the lithium dialkylamide at about −15° C. to about 0° C. to produce a reaction mixture containing about 0.3% to about 2 mol % tetrakis(dialkylamino)tin relative to an amount of the lithium dialkylamide;
(c) adding a solution of an alkyl trichlorotin compound R¹SnCl₃ in a third solvent to the reaction mixture at about −15° C. to about 10° C., wherein the amount of lithium dimethylamide in the reaction mixture is at least about 3.09 equivalents relative to the amount of the alkyl trichlorotin compound and wherein the amount of tetrachlorotin in the reaction mixture is about 0.1 mol % to about 5 mol % relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

Embodiment 5: A method of synthesizing a monoalkyl tin triamide compound having formula (1) and containing no detectable amount of a dialkyl tin diamide compound having formula (2):

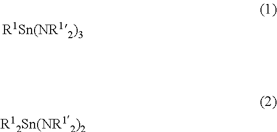

wherein R¹ and R^{1′} are each independently a primary alkyl group having about 1 to 10 carbon atoms or a secondary alkyl group having about 3 to 10 carbon atoms, the method comprising:
(a) lithiating a dialkylamine in a solution containing a first solvent to produce a lithium dimethylamide having a concentration in the solution of up to about 10 wt %;
(b) adding a solution of tetrakis(dialkylamino)tin in a second solvent to the lithium dimethylamide at about −15° C. to about 0° C. to produce a reaction mixture, wherein an amount of tetrakis(dialkylamino)tin in the reaction mixture is about 0.3 mol % to about 2 mol % relative to the amount of the lithium dialkylamide;
(c) adding a solution of an alkyl trichlorotin compound R¹SnCl₃ in a third solvent to the reaction mixture at about −15° C. to about 0° C., wherein the amount of lithium dimethylamide in the reaction mixture is at least about 3.09 equivalents relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

Embodiment 6: The method according to Embodiment 3, wherein R¹ is an isopropyl group and the compound having formula (1) has formula (3):

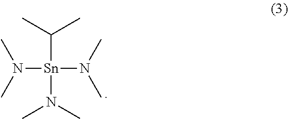

Embodiment 7: The method according to Embodiment 4, wherein R¹ is an isopropyl group and the compound having formula (1) has formula (3):

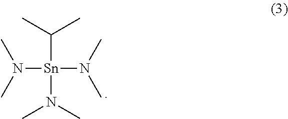

Embodiment 8: The method according to Embodiment 5, wherein R¹ is an isopropyl group and the compound having formula (1) has formula (3):

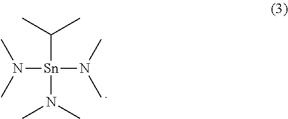

Embodiment 9: The method according to Embodiment 1, wherein R¹ is an isopropyl group and the compound having formula (1) has formula (3):

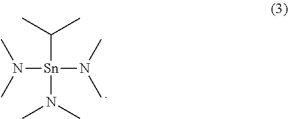

Embodiment 10: The method according to Embodiment 6, wherein the compound having formula (1) contains no detectable amount of substances having a chemical shift in a ¹¹⁹Sn NMR spectrum around −84 ppm.

Embodiment 11: The method according to Embodiment 7, wherein the compound having formula (1) contains no detectable amount of substances having a chemical shift in a ¹¹⁹Sn NMR spectrum around −84 ppm.

Embodiment 12: The method according to Embodiment 8, wherein the compound having formula (1) contains no detectable amount of substances having a chemical shift in a ¹¹⁹Sn NMR spectrum around −84 ppm.

Embodiment 13: A method for producing a tin composition (P1) comprising a monoalkyl tin compound having formula (A1) and a purity of at least about 80 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T1:

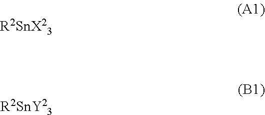

wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13.

Embodiment 14: A method for producing a tin composition (P1) comprising a monoalkyl tin compound having formula (A1) and a purity of at least about 80 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1, wherein the blending is performed at the contact temperature T1 for at least half of the time period t, and wherein a lower limit of T1 is a temperature at which a formation ratio (A1)/(A2) of the monoalkyl tin compound having formula (A1) from a reaction intermediate R²SnX²₂Y² to the dialkyltin compound having formula (A2) from a disproportionation of R²SnX²₂Y² is 600 or more and an upper limit of T1 is less than a lowest value of the decomposition temperatures of (B1), (A1) and (M1), and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T1:

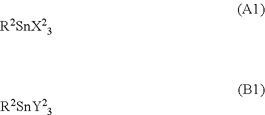

wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13.

Embodiment 15: The method according to Embodiment 13, wherein a temperature fluctuation range when the raw material tin compound (B1) and the reactant (M1) are in contact is 10° C. or less.

Embodiment 16: The method according to Embodiment 14, wherein a temperature range of T1 is about 22° C. to about 30° C.

Embodiment 17: The method according to Embodiment 13, wherein the method is performed using a reactor with a jacket than can be heated and cooled, and wherein a temperature difference between the contact temperature (T1) and a jacket temperature is maintained within about 10° C.

Embodiment 18: A method for producing a tin composition (P11) comprising a monoalkyl tin compound having formula (A11), the method comprising contacting a raw material tin compound having formula (B11) and a reactant (M11) in an organic solvent and blending the raw material tin compound having formula (B11) and the reactant (M11) in the organic solvent for a blending time period t at a contact temperature T1, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B 11) is blended with the reactant (M11) at the contact temperature T1, or
(b) at least 50% by weight of the reactant (M11) is blended with the raw material tin compound having formula (B 11) at the contact temperature T1:

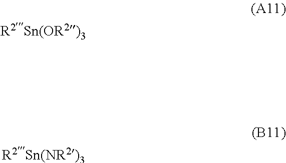

wherein each R^{2″″} is independently a secondary or tertiary organic group having about 3 to 30 carbon atoms, which may be substituted with at least one halogen atom, oxygen atom or nitrogen atom; each R^{2′} is independently an organic group having about 1 to 10 carbon atoms, which may be the same or different and may be substituted with at least one halogen atom; each R^{2″} is independently an organic group having about 2 to 10 carbon atoms, which may be the same or different and may be substituted with at least one halogen atom, and wherein when there is more than one R^{2″″} in a molecule, the structures may be different from each other, and may be bonded together to form a cyclic structure; and
wherein (M11) is a compound having formula HOR^{2″}.

Embodiment 19: The method according to Embodiment 18, wherein a temperature fluctuation range when the raw tin compound (B 11) and the reactant (M11) are in contact is 10° C. or less.

Embodiment 20: The method according to Embodiment 18, wherein a temperature range of T1 is about 22° C. to about 30° C.

Embodiment 21: The method according to Embodiment 18, wherein the method is performed using a reactor with a jacket than can be heated and cooled, and wherein a temperature difference between the contact temperature (T1) and a jacket temperature is maintained within about 10° C.

Embodiment 22: A method for producing a tin composition (P1) comprising a monoalkyl tin compound having formula (A1) and a purity of at least about 80 mol %, the method comprising contacting a raw material tin compound having formula (B1) and a reactant (M2) in an organic solvent and blending the raw material tin compound having formula (B1) and the reactant (M2) in the organic solvent for a blending time period t at a contact temperature T1, wherein the blending is performed at the contact temperature T1 for at least half of the time period t, wherein the contact temperature T1 is in a range of about 10° C. to about 70° C., and wherein:
at least 50% by weight of the raw material tin compound (B1) is blended with the reactant (M2), or the blade tip speed, calculated by the following formula as the agitation speed when at least 50% by weight of the raw material tin compound (B1) is blended with the reactant (M2), is 1.2 m/s or higher;
blade tip speed (m/s)=3.14×number of revolutions (rpm)×diameter of mixing blade (m)/60:

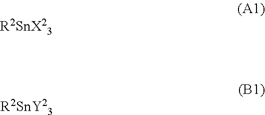

wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and wherein (M2) is a compound having formula MX², MX²₂, MX²₃, or HX² where M represents a metal atom of Group 1, 2, 12, or 13.

Embodiment 23: The method according to Embodiment 22, wherein the agitation speed during contact is at least about 100 rpm.

Embodiment 24: The method according to Embodiment 22, wherein the concentration of the raw tin compound (B1) in the organic solvent is 15 mass % or less.

Embodiment 25: The method according to Embodiment 22, wherein at least one of the raw tin compound (B1) and the reactant (M2) is dispersed as a solid without being dissolved in the organic solvent.

Embodiment 26: A method for producing a tin composition (P1) comprising a monoalkyl tin compound having formula (A1) and a purity of at least about 80 mol %, the method comprising contacting a raw material tin compound having formula (B1) and a reactant (M2) in an organic solvent and blending the raw material tin compound having formula (B1) and the reactant (M2) in the organic solvent for a blending time period t at a contact temperature T1, wherein the blending is performed at the contact temperature T1 for at least half of the time period t, and wherein the contact temperature T1 is in a range of about 10° C. to about 70° C., and wherein the organic solvent has a moisture content of 10 to 80 ppm:

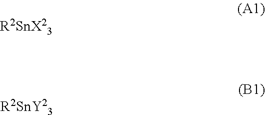

wherein R² is an organic group having about 1 to 30 carbon atoms, which may be substituted with at least one halogen, oxygen or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M2) is a compound having formula MX², MX²₂, MX²₃, or HX² where M represents a metal atom of Group 1, 2, 12, or 13.

Embodiment 27: The method for producing a tin composition according to Embodiment 26, wherein the method is performing in a reactor capable of decompression and under a N₂ atmosphere, the method further comprising performing a N₂ replacement operation by reducing a pressure in the reactor below 1 kPa and introducing N₂ two or more times to prevent entry of water from outside the system while maintaining the N₂ atmosphere.

Embodiment 28: The method according to Embodiment 13, wherein the raw tin compound (B1) is monoalkyltin chloride.

Embodiment 29: The method according to Embodiment 13, wherein M in the reactant (M1) is a group 1 metal atom.

Embodiment 30: The method according to Embodiment 13, further comprising preparing the reactant (M1) and bringing the reactant (M1) into contact with the raw material tin compound (B1) within about 3 to 48 hours after the preparation.

Embodiment 31: The method according to Embodiment 13, wherein a purity of the monoalkyltin compound (A1) in the tin composition (P1) is 90 mol % or more.

Embodiment 32: The method according to Embodiment 13 wherein a content of a dialkyltin compound (A2) in the tin composition (P1) is 3 mol % or less:

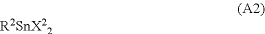

Embodiment 33: The method according to Embodiment 13, wherein in the monoalkyltin compound (A1), a difference in molecular weight between substituents R² and X² is about 30 or less.

Embodiment 34: The method according to Embodiment 18, wherein in the monoalkyltin compound (A11), a difference in molecular weight between substituents R^{2′″} and OR^{2″} is 30 or less.

Embodiment 35: The method according to Embodiment 13, wherein reactant (M11) is a secondary or tertiary alcohol.

Embodiment 36: The method according to Embodiment 13, wherein an amount of the raw material tin compound (B1) is about 10 mol or more.

Embodiment 37: The method according to Embodiment 13, wherein the method further comprises a filtering step after the blending step.

Embodiment 38: The method according to Embodiment 13, wherein the method is performed in a reactor having a volume of between about 100 mL and 50 kL.

Embodiment 39: A method for purifying the tin composition (P1) produced by the method according to Embodiment 13, the method comprising performing a simple distillation of the tin composition (P1) to produce a purified tin compound (P2) having a monoalkyltin compound (A1) with a purity of about 99 mol % or more.

Embodiment 40: A method for producing an organotin compound, comprising steps of:
mixing a crude product containing an organotin compound having formula (a1) with an additive (b1) to form a mixture (x1) containing the crude product and the additive (b1), and
recovering the organotin compound (a1) having a purity of 95 mol % or higher by distilling the mixture (x1) containing the crude product and the additive (b1):

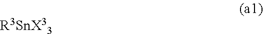

wherein in the formula (a1), R³ represents a hydrocarbon group having about 1 to 30 carbon atoms, which may each be substituted with a halogen atom, an oxygen atom, or a nitrogen atom,
each X³ is independently OR^{3′} or N^{3′}₂, wherein R^{3′} is a hydrocarbon group having about 1 to 30 carbon atoms, which may each be substituted with a halogen atom, an oxygen atom, or a nitrogen atom, the three R^{3′} may be the same or different from each other; and R³ and R^{3′} may be bonded to each other to form a cyclic structure;
the additive (b1) is a hydrocarbon compound containing about 2 to about 20 carbon atoms substituted with at least one nitrogen and/or oxygen atom and satisfies a condition (1a) and a condition (2):
condition (1a): when the number of nitrogen atoms in the hydrocarbon compound is m and the number of oxygen atoms is n, m is 0, 1, 2 or 3, n is 0, 1, 2 or 3, and m+n is 2 or 3;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Embodiment 41: The method according to Embodiment 40, wherein the additive (b1) has a nitrogen atom and m is 1, 2 or 3.

Embodiment 42: The method according to Embodiment 40, wherein the additive (b1) has an oxygen atom and n is 1, 2 or 3.

Embodiment 43: The method according to Embodiment 40, wherein m+n is 3.

Embodiment 44: The method according to Embodiment 40, wherein the hydrocarbon compound is an aliphatic hydrocarbon compound.

Embodiment 45: The method according to Embodiment 40, wherein the hydrocarbon compound is an aliphatic saturated hydrocarbon compound.

Embodiment 46: The method according to Embodiment 40, wherein mixture (x1) further contains an organotin compound having formula (a3), and wherein an amount of the additive (b1) in the mixture is about 0.5 to 10 times an amount of the organotin compound having formula (a3):

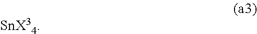

Embodiment 47: A method for producing an organotin compound, comprising:
mixing a crude product containing an organotin compound having formula (a1) with an additive (b2) to form a mixture (x2) containing the crude product and the additive (b2),
wherein the mixture (x2) further contains an organotin compound having formula (a3), and wherein an amount of the additive (b2) in the mixture is about 0.5 to 10 times an amount of the organotin compound having formula (a3):

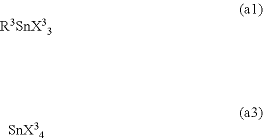

wherein R³ represents a hydrocarbon group having about 1 to 30 carbon atoms, which may each be substituted with a halogen atom, an oxygen atom, or a nitrogen atom, and
each X³ is independently OR^{3′} or NR^{3′}₂, wherein R^{3′} is a hydrocarbon group having about 1 to 30 carbon atoms, which may be substituted with a halogen atom, an oxygen atom, or a nitrogen atom, the three R^{3′} may be the same or different from each other; and R³ and R^{3′} may be bonded to each other to form a cyclic structure;
the additive (b2) is a hydrocarbon compound containing about 2 to about 20 carbon atoms substituted with at least one nitrogen and/or oxygen atom and satisfies a condition (1b) and a condition (2):
condition (1b): when the number of nitrogen atoms in the hydrocarbon compound is m and the number of oxygen atoms is n, m is 0, 1, 2, 3, 4, or 5, n is 0, 1, 2, 3, 4, or 5, and m+n is 2, 3 4, 5,6, 7, 8, 9, or 10;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Embodiment 48: The production method according to Embodiment 47, further comprising a step of recovering the organotin compound (a1) with a purity of 95 mol % or higher by distilling the mixture (x2) containing the crude product and the additive (b2).

Embodiment 49: A method for producing an organotin compound, comprising steps of:
mixing a crude product containing an organotin compound having formula (a1) with an additive (b3) to form a mixture (x3) containing the crude product and the additive (b3), and
recovering the organotin compound (a1) with a purity of 95 mol % or higher by distilling the mixture (x3) containing the crude product and the additive (b3);

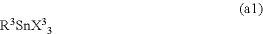

wherein in the formula (a1), R³ represents a hydrocarbon group having about 1 to 30 carbon atoms, which may be substituted with a halogen atom, an oxygen atom, or a nitrogen atom, and
each X³ is independently OR^{3′} or NR^{3′}₂, wherein R^{3′} is a hydrocarbon group having about 1 to 30 carbon atoms, which may be substituted with a halogen atom, an oxygen atom, or a nitrogen atom, the three R^{3′} may be the same or different from each other; and R³ and R^{3′} may be bonded to each other to form a cyclic structure; and
the additive (b3) is a polymer resin containing sulfur atoms.

Embodiment 50: A method for producing an organotin compound, comprising steps of:
mixing a crude product containing an organotin compound having formula (a1) with an additive (b2) and an organic solvent to form a mixture (x4) containing the crude product, the additive (b2), and the organic solvent, and
recovering the organotin compound (a1) with a purity of 95 mol % or higher by distilling the mixture (x4) containing the crude product, the additive (b2), and the organic solvent, wherein
a content of the organic solvent in the mixture (x4) is 100 parts by mass or more relative to 100 parts by mass of the additive (b2);

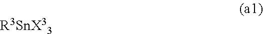

wherein R³ represents a hydrocarbon group having about 1 to 30 carbon atoms, which may be substituted with a halogen atom, an oxygen atom, or a nitrogen atom, and
each X³ is independently OR^{3′} or N^{3′}₂, wherein R^{3′} is a hydrocarbon group having about 1 to 30 carbon atoms, which may be substituted with a halogen atom, an oxygen atom, or a nitrogen atom, the three R^{2′} may be the same or different from each other; and R³ and R^{3′} may be bonded to each other to form a cyclic structure;
the additive (b2) is a hydrocarbon compound containing about 2 to about 20 carbon atoms substituted with at least one nitrogen and/or oxygen atom and satisfies a condition (1b) and a condition (2):
condition (1b): when the number of nitrogen atoms in the hydrocarbon compound is m and the number of oxygen atoms is n, m is 0, 1, 2, 3, 4, or 5, n is 0, 1, 2, 3, 4, or 5, and m+n is 2, 3 4, 5,6, 7, 8, 9, or 10;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Embodiment 51: The method according to Embodiment 40, wherein a difference in molecular weight between R³ and X³ in the organotin compound (a1) is 50 or less.

Embodiment 52: The method according to Embodiment 40, wherein the mixing of the crude product containing the organotin compound (a1) with the additive (b1) or (b2) and the distillation are carried out under a condition of protection from light.

[symbol] Embodiment 53: The method according to Embodiment 40, further comprising, after the distillation, filling the organotin compound (a1) into a storage container under an inert atmosphere.

Embodiment 54: A method for producing a tin composition (P1) comprising a monoalkyl tin compound having formula (A1) and a purity of at least about 95 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1 to produce a crude product, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T1:

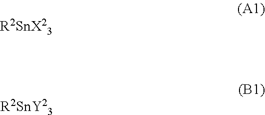

wherein R² is an organic group having about 1 to 30 carbon atoms, which may be substituted with at least one halogen, oxygen or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13;
the method further comprising:
mixing the crude product with an additive (b1) to form a mixture (y1) containing the crude product and the additive (b1), and
recovering the tin composition (P1) comprising the monoalkyl tin compound having formula (A1) and a purity of at least about 95 mol %, by distilling the mixture (y1) containing the crude product and the additive (b1):
wherein the additive (b1) is a hydrocarbon compound containing about 2 to about 20 carbon atoms substituted with at least one nitrogen and/or oxygen atom and satisfies a condition (1a) and a condition (2):
condition (1a): when the number of nitrogen atoms in the hydrocarbon compound is m and the number of oxygen atoms is n, m is 0, 1, 2 or 3, n is 0, 1, 2 or 3, and m+n is 2 or 3;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Embodiment 55. A method for synthesizing a monoalkyl tin triamide compound having formula (1) and a purity of at least about 95% by reacting a monoalkyl tin trihalide compound having formula (5) with a metal amide compound having formula (6) or (7) to form a crude product, wherein the reaction is performed in the presence of tin tetrahalide having formula (4):

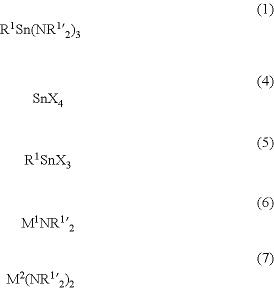

wherein R¹ and R^{1′} are each independently a primary alkyl group having about 1 to about 10 carbon atoms or a secondary alkyl group having about 3 to about 10 carbon atoms; M¹ is a monovalent metal, M² is a divalent metal, and each X is independently F, Cl, Br, or I;
the method further comprising:
mixing the crude product with an additive (b1) to form a mixture (z1) containing the crude product and the additive (b1), and
recovering the monoalkyl tin compound having formula (1) and a purity of at least about 95 mol % by distilling the mixture (z1) containing the crude product and the additive (b1):
wherein the additive (b1) is a hydrocarbon compound containing about 2 to about 20 carbon atoms substituted with at least one nitrogen and/or oxygen atom and satisfies a condition (1a) and a condition (2):
condition (1a): when the number of nitrogen atoms in the hydrocarbon compound is m and the number of oxygen atoms is n, m is 0, 1, 2 or 3, n is 0, 1, 2 or 3, and m+n is 2 or 3;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

Embodiment 56: A method of purifying a mixture containing a monoalkyl tin triamide compound having formula (1), no detectable amount of a dialkyl tin diamide compound having formula (2), and about 0.1 to about 5 mol % of a tetrakis(dialkylamino)tin compound having formula (8):

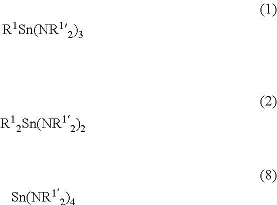

wherein R¹ and R^{1′} are each independently a primary alkyl group having about 1 to about 10 carbon atoms or a secondary alkyl group having about 3 to about 10 carbon atoms, the method comprising:
adding at least one weak acid, at least one weak base, at least one weak acid polymer, or at least one weak base polymer to the mixture containing compounds (1) and (8) at about 15° C. to about 30° C. to produce a reaction mixture, wherein an amount of the at least one weak acid, the at least one weak base, the at least one weak acid polymer, or the at least one weak base polymer in the reaction mixture is at least about 2 equivalents relative to the amount of compound (8); and
removing reaction byproducts to produce a mixture containing the monoalkyl tin triamide having formula (1), no detectable amount of the dialkyl tin diamide compound having formula (2), and no detectable amount of the tetrakis(dimethylamino)tin compound having formula (8).

Embodiment 57: A method of purifying a mixture containing a monoalkyl tin triamide compound having formula (1), less than 0.05 mol % of a dialkyl tin diamide compound having formula (2), and about 0.1 to about 5 mol % of a tetrakis(dialkylamino)tin compound having formula (8):

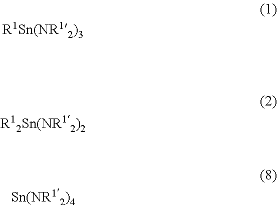

wherein R¹ and R^{1′} are each independently a primary alkyl group having about 1 to about 10 carbon atoms or a secondary alkyl group having about 3 to about 10 carbon atoms, the method comprising:
(a) adding at least one weak acid, at least one weak base, at least one weak acid polymer, or at least one weak base polymer to the mixture containing compounds (1) and (8) at about 15° C. to about 30° C. to produce a reaction mixture, wherein an amount of the at least one weak acid, the at least one weak base, the at least one weak acid polymer, or the at least one weak base polymer in the reaction mixture is at least about 2 equivalents relative to the amount of compound (8); and
(b) removing reaction byproducts to produce a mixture containing the monoalkyl tin triamide having formula (1), less than 0.05 mol % of the dialkyl tin diamide compound having formula (2), and less than 0.1 mol % of the tetrakis(dimethylamino)tin compound having formula (8).

Embodiment 58: The method according to Embodiment 56, wherein the at least one weak acid, at least one weak base, at least one weak acid polymer, or at least one weak base polymer comprises a resin functionalized with at least one of OH, COOH, NH₂, or SH.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawing:

FIG. 1 is a graph depicting the photodecomposition of ⁱPrSn(NMe₂)₃ over time.

### DETAILED DESCRIPTION OF THE INVENTION

Aspects of the disclosure relate to methods for producing and purifying organotin compounds, suppressing formation of dialkyl tin compounds and selectively removing tetrakis(dialkylamino) tin compounds.

Unless defined otherwise, all technical and scientific terms used herein have the same meaning as commonly understood to one of ordinary skill in the art to which this invention pertains. Otherwise, certain terms used herein have the meanings as set forth in the specification. All patents, published patent applications and publications cited herein are incorporated by reference as if set forth fully herein.

It must be noted that as used herein and in the appended claims, the singular forms “a,” “an,” and “the” include plural reference unless the context clearly dictates otherwise.

Unless otherwise stated, any numerical value is to be understood as being modified in all instances by the term “about.” Thus, a numerical value typically includes +10% of the recited value. For example, the recitation of a temperature such as “10° C.” includes 9° C. and 11° C. As used herein, the use of a numerical range expressly includes all possible subranges, all individual numerical values within that range, including integers within such ranges and fractions of the values unless the context clearly indicates otherwise. For example, a range of about 1 to about 30 carbon atoms includes, about 1, 2, 3, 4, 5, 6, 7, 8, 9, 10, 11, 12, 13, 14, 15, 16, 17, 18, 19, 20, 21, 22, 23, 24, 25, 26, 27, 28, 29, and about 30 carbon atoms.

### Methods for Synthesizing Monoalkyl Tin Compounds

In one embodiment, aspects of the disclosure relate to a method of synthesizing a monoalkyl tin triamide compound having formula (1) and containing no detectable amount of dialkyl tin diamide compound having formula (2):

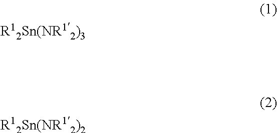

wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dialkylamide having a concentration in the solution of up to about 10 wt %;
(b) preparing a premix solution comprising tetrachlorotin and an alkyltrichloro tin compound R¹Cl₃ in a second solvent, wherein an amount of the tetrachlorotin in the premix solution is about 0.1 to about 5 mol % relative to the amount of the alkyl trichlorotin compound;
(c) adding the premix solution to the lithium dialkylamide at about −10° C. to about 10° C. to produce a reaction mixture, wherein the amount of lithium dialkylamide in the reaction mixture is at least about 3.09 equivalents relative to the amount of the alkyl trichlorotin compound;
(d) removing the LiCl salt product by filtration; and
(e) removing the first solvent and the second solvent under vacuum to produce a product containing the monoalkyl tin triamide having formula (1) and a non-detectable amount of the dialkyl tin diamide compound having formula (2).

In a second embodiment, aspects of the disclosure relate to a method of synthesizing a monoalkyl tin triamide compound having formula (1) and containing no detectable amount of a dialkyl tin diamide compound having formula (2):

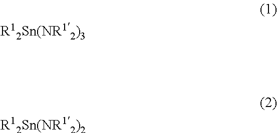

wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dialkylamide having a concentration in the solution of up to about 10 wt %;
(b) adding a solution of tetrachlorotin in a second solvent to the lithium dialkylamide at about −15° C. to about 0° C. to produce a reaction mixture containing about 0.3 to about 2 mol % tetrakis(dialkylamino)tin relative to an amount of the lithium dialkyl amide;
(c) adding a solution of an alkyl trichlorotin compound R¹Cl₃ in a third solvent to the reaction mixture at about −15° C. to about 10° C., wherein the amount of lithium dialkylamide in the reaction mixture is at least about 3.09 equivalents relative to the amount of the alkyl trichlorotin compound, and wherein the amount of tetrachlorotin in the reaction mixture is about 0.1 to about 5 mol % relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

In a third embodiment, aspects of the disclosure relate to a method of synthesizing a monoalkyl tin triamide compound having formula (1) and containing no detectable amount of a dialkyl tin diamide compound having formula (2):

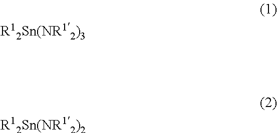

wherein R¹ and R^{1′} are each independently is a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dialkylamide having a concentration in the solution of up to about 10 wt %;
(b) adding a solution of tetrakis(dialkylamino)tin in a second solvent to the lithium dialkylamide at about −15° C. to about 0° C. to produce a reaction mixture; wherein the amount of tetrakis(dialkylamino)tin in the reaction mixture is about 0.3 to about 2 mol % relative to the amount of the lithium dialkylamide;
(c) adding a solution of an alkyl trichlorotin compound R¹Cl₃ in a third solvent to the reaction mixture at about −15° C. to about 0° C., wherein the amount of lithium dialkylamide in the reaction mixture is at least about 3.09 equivalents relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

In a fourth embodiment, aspects of the disclosure relate to a method of purifying a mixture containing a monoalkyl tin triamide compound having formula (1), no detectable amount of a dialkyl tin diamide compound having formula (2), and about 0.1 to about 5 mol % of a tetrakis(dialkylamino)tin compound having formula (8):

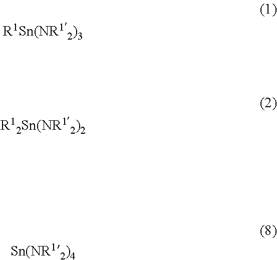

wherein R¹ and R^{1′} are each independently a primary alkyl group having about 1 to about 10 carbon atoms or a secondary alkyl group having about 3 to about 10 carbon atoms, the method comprising:
(a) adding at least one weak acid, at least one weak base, at least one weak acid polymer, or at least one weak base polymer to the mixture containing compounds (1) and (8) at about 15° C. to about 30° C. to produce a reaction mixture, wherein the amount of the at least one weak acid, the at least one weak base, the at least one weak acid polymer, or the at least one weak base polymer in the reaction mixture is at least about 2 equivalents relative to the amount of compound (8); and
(b) removing reaction byproducts to produce a mixture containing the monoalkyl tin triamide having formula (1), no detectable amount of the dialkyl tin diamide compound having formula (2), and no detectable amount of the tetrakis(dialkylamino)tin compound having formula (8).

Embodiments of the disclosure include:

[1]A method of synthesizing a monoalkyl tin triamide compound having formula (1) and containing no detectable amount of a dialkyl tin diamide compound having formula (2):

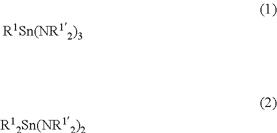

wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dialkylamide having a concentration in the solution of up to about 10 wt %;
(b) preparing a premix solution comprising tetrachlorotin and an alkyltrichloro tin compound R¹Cl₃ in a second solvent, wherein an amount of the tetrachlorotin in the premix solution is about 0.1 to about 5 mol % relative to the amount of the alkyl trichlorotin compound;
(c) adding the premix solution to the lithium dimethylamide at about −10° C. to about 10° C. to produce a reaction mixture, wherein the amount of lithium dimethylamide in the reaction mixture is at least about 3.09 equivalents relative to the amount of the alkyl trichlorotin compound;
(d) removing the LiCl salt product by filtration; and
(e) removing the first solvent and the second solvent under vacuum to produce a product containing the monoalkyl tin triamide having formula (1) and no detectable amount of the dialkyl tin diamide compound having formula (2).

[2]A method of synthesizing a monoalkyl tin triamide compound having formula (1) and containing no detectable amount of a dialkyl tin diamide compound having formula (2):

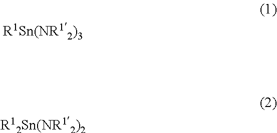

wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dimethylamide having a concentration in the solution of up to about 10 wt %;
(b) adding a solution of tetrachlorotin in a second solvent to the lithium dialkylamide at about −15° C. to about 0° C. to produce a reaction mixture containing about 0.3% to about 2 mol % tetrakis(dialkylamino)tin relative to an amount of the lithium dialkylamide,
(c) adding a solution of an alkyl trichlorotin compound R¹Cl₃ in a third solvent to the reaction mixture at about −15° C. to about 10° C., wherein the amount of lithium dimethylamide in the reaction mixture is at least about 3.09 equivalents relative to the amount of the alkyl trichlorotin compound and wherein the amount of tetrachlorotin in the reaction mixture is about 0.1 mol % to about 5 mol % relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

[3]A method of synthesizing a monoalkyl tin triamide compound having formula (1) and containing no detectable amount of a dialkyl tin diamide compound having formula (2):

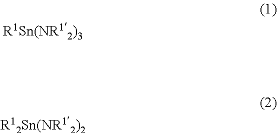

wherein R¹ and R^{1′} are each independently a primary alkyl group having about 1 to 10 carbon atoms or a secondary alkyl group having about 3 to 10 carbon atoms, the method comprising:
(a) lithiating a dialkylamine in a solution containing a first solvent to produce a lithium dimethylamide having a concentration in the solution of up to about 10 wt %;
(b) adding a solution of tetrakis(dialkylamino)tin in a second solvent to the lithium dimethylamide at about −15° C. to about 0° C. to produce a reaction mixture, wherein an amount of tetrakis(dialkylamino)tin in the reaction mixture is about 0.3 mol % to about 2 mol % relative to the amount of the lithium dialkylamide;
(c) adding a solution of an alkyl trichlorotin compound R¹Cl₃ in a third solvent to the reaction mixture at about −15° C. to about 0° C., wherein the amount of lithium dimethylamide in the reaction mixture is at least about 3.09 equivalents relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

[4]A method of purifying a mixture containing a monoalkyl tin triamide compound having formula (1), no detectable amount of a dialkyl tin diamide compound having formula (2), and about 0.1 to about 5 mol % of a tetrakis(dialkylamino)tin compound having formula (8):

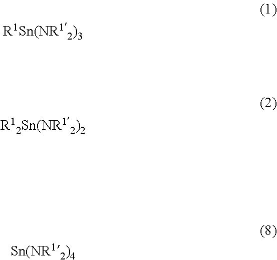

wherein R¹ and R^{1′} are each independently a primary alkyl group having about 1 to about 10 carbon atoms or a secondary alkyl group having about 3 to about 10 carbon atoms, the method comprising:
(a) adding at least one weak acid, at least one weak base, at least one weak acid polymer, or at least one weak base polymer to the mixture containing compounds (1) and (8) at about 15° C. to about 30° C. to produce a reaction mixture, wherein an amount of the at least one weak acid, the at least one weak base, the at least one weak acid polymer, or the at least one weak base polymer in the reaction mixture is at least about 2 equivalents relative to the amount of compound (8); and
(b) removing reaction byproducts to produce a mixture containing the monoalkyl tin triamide having formula (1), no detectable amount of the dialkyl tin diamide compound having formula (2), and no detectable amount of the tetrakis(dimethylamino)tin compound having formula (8).

[5] The method according to [1], wherein R is an isopropyl group and the compound having formula (1) has formula (3):

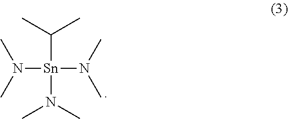

[6] The method according to [2], wherein R is an isopropyl group and the compound having formula (1) has formula (3):

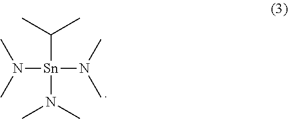

[7] The method according to [3], wherein R¹ is an isopropyl group and the compound having formula (1) has formula (3):

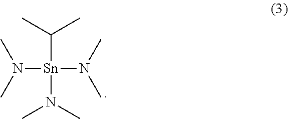

[8] The method according to [4], wherein R¹ is an isopropyl group and the compound having formula (1) has formula (3):

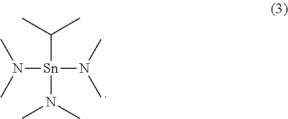

[9] The method according to [1], wherein the compound having formula (1) is colorless.

[10] The method according to [2], wherein the compound having formula (1) is colorless.

[11] The method according to [3], wherein the compound having formula (1) is colorless.

[12] The method according to [5], wherein the compound having formula (1) contains no detectable amount of substances having a chemical shift in a ¹¹⁹Sn NMR spectrum around −84 ppm.

[13] The method according to [6], wherein the compound having formula (1) contains no detectable amount of substances having a chemical shift in a ¹¹⁹Sn NMR spectrum around −84 ppm.

[14] The method according to [7], wherein the compound having formula (1) contains no detectable amount of substances having a chemical shift in a ¹¹⁹Sn NMR spectrum around −84 ppm.

[15] The method according to [4], wherein the at least one weak acid, at least one weak base, at least one weak acid polymer, or at least one weak base polymer comprises a resin functionalized with at least one of OH, COOH, NH₂, or SH.

Aspects of the disclosure relate to methods for synthesizing high purity alkyl tin compounds having formula (1) which are suitable for use in the microelectronic industry. These high purity compounds may contain less than 0.05 mol % of or may be substantially free of (contain no detectable amounts of) a dialkyl tin compound having formula (2), have desired color levels, and may be prepared without multi-stage distillation.

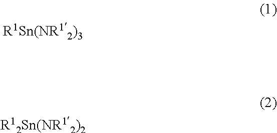

As described in more detail below, R¹ and R^{1′} are each independently a primary alkyl group having about 1 to about 10 carbon atoms or a secondary alkyl group having about 3 to about 10 carbon atoms.

For the purposes of this disclosure, the term “substantially free of” may be understood to be synonymous with containing “no detectable amount of” the recited compound, that is, the recited compound is not detectable by ¹¹⁹Sn NMR, which can have detection limits as low as 0.3 mol %, 0.1 mol %, 0.05 mol %, or 0.04 mol % (depending on the particular compound or impurity) when testing the sample using specific conditions without dilution in deuterated solvent, such as by using more than 2,000 scans. All numerical ranges expressed in this disclosure encompass all values within the range, including fractional and decimal amounts. Accordingly, it is within the scope of the disclosure to produce monoalkyl tin diamide compounds containing less than about 0.05 mol %, less than about 0.04 mol %, less than about 0.03 mol %, less than about 0.02 mol %, less than about 0.01 mol %, or non-detectable by ¹¹⁹Sn NMR, that is, the compounds having formula (2) are in some embodiments undetectable in a sample of the compound having formula (1).

¹¹⁹Sn NMR spectroscopy is ideally suited to the quantitative analysis of monoalkyl tin compounds due to its high sensitivity to small structural changes and large spectral range of 6500 ppm (see Davies et al., Eds.; Tin Chemistry: Fundamentals, Frontiers, and Applications; Wiley (2008)). This allows for easy identification and quantification of monoalkyl tin compounds and their impurities because ¹¹⁹Sn resonances are highly resolved. ¹¹⁹Sn NMR suffers from reduced sensitivity compared to other analytical methods such as GC, HPLC, or ¹H NMR. To improve sensitivity, monoalkyl tin compounds are analyzed without dilution, and a large number of spectral acquisitions (at least 2000, preferably more than 10,000 for unknown impurity detection) are acquired to measure the low levels of impurities described in this work. Using this approach, detection limits of 0.01 mol % dialkyl tin diamides and other Sn compounds such as compounds having formula (2) can be achieved. In the case of Sn(NMe₂)₄ having formula (8), the detection limit is 0.3 mol % because the peak is broad.

The ¹¹⁹Sn NMR data described herein were obtained using a method similar to the relative purity method described in J. Med. Chem. (57, 22, 9220-9231 (2014)). ¹¹⁹Sn NMR spectra were acquired using inverse-gated ¹H decoupling with a 400 pulse, one second relaxation delay, and sufficient scans to achieve the required sensitivity. Samples were prepared without dilution in deuterated solvent. Quantitation was performed by integrating all peaks in the spectrum and setting the total peak area to 100. Each peak in the spectrum represents a distinct tin compound and the area of each peak represents the concentration or purity of that compound in mol %.

According to one aspect of the disclosure, provided are methods for synthesizing monoalkyl tin triamide compounds represented by formula (1) and containing less than 0.05 mol % (and in some embodiments, no detectable amount) of a dialkyl tin compound having formula (2).

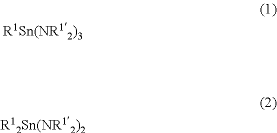

In formulas (1) and (2), R¹ is an alkyl group having about 1 to 30 carbon atoms which may be substituted with at least one halogen, oxygen or nitrogen atom, preferably about 1 to 10 carbon atoms, more preferably about 3 to about 5 carbon atoms, such as, without limitation, isobutyl, sec-butyl, cyclohexyl, cyclopentyl, cyclobutyl, cyclopropyl, isopentyl, sec-pentyl, etc., and the presently preferred isopropyl and cyclopentyl groups. R^{1′} is an alkyl group having 1 to 10 carbon atoms, preferably methyl or ethyl group. In a preferred embodiment, R¹ is an isopropyl group and the compound is (iPr)Sn(NMe₂)₃ [isopropyl tris(dimethylamino) tin], in which the dialkyl tin impurity is (iPr)₂Sn(NMe₂)

Alternatively, in formulas (1) and (2), R¹ and R^{1′} are each independently a primary alkyl group having about 1 to about 10 carbon atoms or a secondary alkyl group having about 3 to about 10 carbon atoms; preferred R¹ are methyl, ethyl, n-propyl, i-propyl, n-butyl, n-pentyl, etc. and preferred R^{1′} are methyl, ethyl groups. Preferred compounds having formula (1) are methyl tris(dimethylamino) tin, ethyl tris(dimethylamino) tin, and isopropyl tris(dimethylamino) tin.

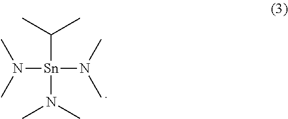

A first method for preparing a monoalkyl tin triamide compound having formula (1) and containing no detectable amount of a compound having formula (2) according to aspects of the disclosure involves the following steps, each of which is described in further detail below:
(a) lithiating a dialkylamine in a first solvent to produce a lithium dialkylamide having a concentration in the solution of up to about 10 wt %;
(b) preparing a premix solution comprising tetrachlorotin and an alkyltrichloro tin compound R¹Cl₃ in a second solvent, wherein an amount of the tetrachlorotin in the premix solution is about 0.1 to about 5 mol % relative to the amount of the alkyl trichlorotin compound;
(c) adding the premix solution to the lithium dialkylamide at about −10° C. to about 10° C. to produce a reaction mixture, wherein the amount of lithium dimethylamide in the reaction mixture is at least about 3.09 equivalents relative to the amount of the alkyl trichlorotin compound;
(d) removing the LiCl salt product by filtration; and
(e) removing the first solvent and the second solvent under vacuum to produce a product containing the monoalkyl tin triamide having formula (1) and no detectable amount of the dialkyl tin diamide compound having formula (2).

In preferred embodiments, there is no detectable amount of the dialkyl tin diamide compound having formula (2). This reaction is shown in the following Scheme A for the formation of RiSn(NMe₂)₃:

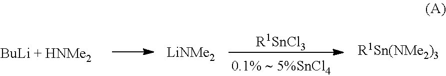

It is preferred if the method steps are performed in an amber or stainless-steel reactor to prevent light exposure, which, as explained below, has detrimental effects on the monoalkyl tin triamide compounds.

The first step in the method involves lithiating a dialkylamine (such as the preferred dimethylamine) in a solution of a hydrocarbon solvent (such as the presently preferred hexanes) or THF to produce a lithium dialkylamide, such as the preferred lithium dimethylamide; the lithiated dialkylamine is present in the solution in an amount of up to (but not greater than) 10 wt %. It has been found that this dilute concentration provides an effective slurry for solid and liquid reactions. The lithiation is preferably performed at a temperature of about −10° C. to about 10° C. The lithiation may be performed with n-BuLi or other common lithiating reagents commonly used in the art, such as t-BuLi or HexylLi. Such lithiating agents are commonly employed in a hexanes solution and additional hexanes may be added so that the lithium dialkylamide is present in the desired concentration range. Excess dialkylamine is required to ensure that the lithiating reagent is fully reacted. The reaction is performed under an inert atmosphere, such as nitrogen or argon, and the addition rate is controlled to limit the exothermic reaction. Following the completion of the addition, the reaction mixture is stirred for an additional three hours at about −10° C. to about 10° C.

The second method step involves preparing a premix solution comprising tetrachlorotin and an alkyl trichlorotin compound R¹SnCl₃ in a second solvent (such as a hydrocarbon solvent, including the presently preferred hexanes, or THF, and which may be the same as or different from the first solvent), in which the amount of tetrachlorotin in the premix solution is about 0.1 to 5 mol % (preferably about 1.5 to about 3 mol %) relative to the amount of the alkyl trichlorotin compound. Preferably, the total concentrations of the tetrachlorotin and the alkyl trichlorotin in the premix solution is about 25 to about 75 mol % in the solvent.

In the third step, the premix solution is added to the lithium dialkylamide which is maintained at about −10° C. to about 10° C. The premix solution is added such that the amount of lithium dialkylamide in the solution is at least about 3.09 equivalents relative to the amount of the alkyl trichlorotin compound. The premix solution is preferably added subsurface while controlling the flowrate to control the exothermic reaction. The third method step is preferably performed in an inert atmosphere, such as nitrogen or argon.

After completing the addition of premix solution containing tetrachlorotin and alkyl trichlorotin to the lithium dialkylamide, the reaction mixture is slowly warmed to room temperature and then stirred for an additional time period at room temperature, such as for about four hours. The reaction mixture is then filtered, such as through sparkler, to remove the LiCl byproduct. Other means of filtration which are known in the art may also be employed. The resulting salt is then rinsed, such as with anhydrous hexanes, and the hexanes and other solvents are removed under reduced pressure by means known in the art to produce the desired monoalkyl tin triamide compound having formula (1) and no detectable amount of the dialkyl tin diamide having formula (2).

A second method for synthesizing a monoalkyl tin triamide compound having formula (1) and containing no detectable amount of a dialkyl tin diamide compound having formula (2) involves:
(a) lithiating a dialkylamine in a solution containing a first solvent to produce a lithium dialkylamide having a concentration in the solution of up to about 10 wt %;
(b) adding a solution of tetrachlorotin in a second solvent to the lithium dialkylamide at about −15° C. to about 0° C. to produce a reaction mixture containing about 0.3 to about 2 mol % tetrakis(dialkylamino)tin relative to an amount of the lithium dialkyl amide;
(c) adding a solution of an alkyl trichlorotin compound R¹SnCl₃ in a third solvent to the reaction mixture at about −15° C. to about 10° C., wherein the amount of lithium dialkylamide in the reaction mixture is at least about 3.09 equivalents relative to the amount of the alkyl trichlorotin compound, and wherein the amount of tetrachlorotin in the reaction mixture is about 0.1 to about 5 mol % relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

This reaction is shown in the following Scheme B:

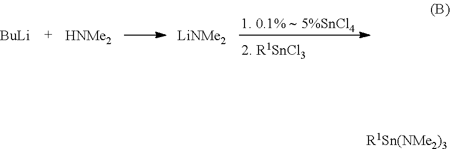

The first method step is as described previously. In the second step, a tetrachlorotin solution in a second solvent (such as a hydrocarbon solvent, such as the presently preferred hexanes, or THF, and which may be the same as or different from the first solvent) is added to the lithium dialkylamide solution which is maintained at about −30° C. to 5° C., preferably about −20° C. to 5° C., more preferably about −15° C. to about 0° C. to produce a reaction mixture. The tetrachlorotin solution is added such that the concentration of tetrakis(dialkylamino)tin in the reaction mixture is about 0.3 to about 2 mol % tetrakis(dialkylamino)tin relative to the amount of the lithium dialkyl amide. The tetrachlorotin solution is preferably added in a dropwise fashion to control the exothermic reaction. The second method step is preferably performed in an inert atmosphere, such as nitrogen or argon.

In the third method step, a solution of an alkyl trichlorotin compound R¹SnCl₃ in a second solvent (such as hydrocarbon solvent, including the presently preferred hexanes, or THF, and which may be the same as or different from the first and second solvents) is added to the reaction mixture at about −15° C. to about 10° C. The alkyl trichlorotin compound is added such that the amount of lithium dialkylamide in the reaction mixture is at least about 3.09 equivalents relative to the amount of the alkyl trichlorotin compound and the amount of tetrachlorotin in the reaction mixture is about 0.1 to about 5 mol % relative to the amount of the alkyl trichlorotin compound. The alkyl trichlorotin solution is preferably added subsurface while controlling the flow rate to control the exothermic reaction. The third method step is preferably performed in an inert atmosphere, such as nitrogen or argon.

After completing the addition of the tetrachloro tin and the alkyl trichlorotin compound to the reaction mixture, the reaction mixture is allowed to slowly warm to room temperature, such as over a period of about four hours, and then stirred for an additional time period at room temperature, such as for about four hours. The reaction mixture is then filtered, such as through sparkler, to remove the LiCl byproduct. Other means of filtration which are known in the art may also be employed. The resulting salt is then rinsed, such as with anhydrous hexanes, and the solvents are removed under reduced pressure by means known in the art to produce the desired monoalkyl tin triamide compound having formula (1) and no detectable amount of the dialkyl tin diamide having formula (2).

A third method for preparing a monoalkyl tin triamide compound having formula (1) and containing no detectable amount of a compound having formula (2) according to aspects of the disclosure involves the following steps, each of which is described in further detail below:
(a) lithiating a dialkylamine in a solution containing a first solvent to produce a lithium dialkylamide having a concentration in the solution of up to about 10 wt %;
(b) adding a solution of tetrakis(dialkylamino)tin in a second solvent to the lithium dialkylamide at about −15° C. to about 0° C. to produce a reaction mixture; wherein the amount of tetrakis(dialkylamino)tin in the reaction mixture is about 0.3 to about 2 mol % relative to the amount of the lithium dialkylamide;
(c) adding a solution of an alkyl trichlorotin compound R¹SnCl₃ in a third solvent to the reaction mixture at about −15° C. to about 0° C., wherein the amount of lithium dialkylamide in the reaction mixture is at least about 3.09 equivalents relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

This reaction is shown in the following Scheme C:

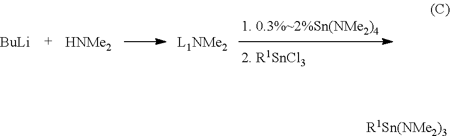

The first, third, fourth, and fifth steps of the method are as described previously. In the second step, a solution of tetrakis(dialkylamino)tin in a second solvent (as described previously) is added to the lithium dialkylamide solution at about −15° C. to about 0° C. to produce a reaction mixture in which the amount of tetrakis(dialkylamino)tin in the reaction mixture is about 0.3 to about 2 mol % relative to the amount of the lithium dialkylamide;

Preferably the concentration of tetrakis(dialkylamino)tin in the solution is about 25 to 75 mol %, more preferably about 50 mol % in the solvent. The tetrakis(dialkylamino)tin solution is preferably added in a dropwise fashion to control the exothermic reaction. The second method step is preferably performed in an inert atmosphere, such as nitrogen or argon. In the third step, the alkyl trichloro tin solution is added such that the amount of the lithium dialkylamide in the reaction mixture is at least about 3.09 equivalents relative to the amount of the alkyl trichlorotin compound. In all cases, the first, second, and third solvents may be the same or different and may be hydrocarbons (such as the presently preferred hexanes) or TIHF.

According to another aspect of the disclosure, a method for synthesizing a monoalkyl tin triamide compound having formula (1) involves reacting a monoalkyl tin trihalide compound having formula (5) with a metal amide compound having formula (6) or (7), wherein the reaction is performed in the presence of tin tetrahalide having formula (4):

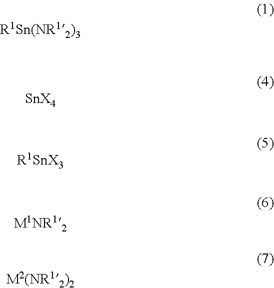

wherein R¹ and R^{1′} are each independently a primary alkyl group having about 1 to about 10 carbon atoms or a secondary alkyl group having about 3 to about 10 carbon atoms; M¹ is a monovalent metal, M² is a divalent metal, and each X is independently F, Cl, Br, or I. Preferably, M¹ is Li, Na, or K, and more preferably Li. Preferably, M² is Mg, Ca or Zn and more preferably Mg. A mixture of more than two species of metal amide can be used. X is preferably C1 or Br, and more preferably C1. The reaction conditions are similar to those described previously.

According to another aspect of the disclosure, a method of synthesizing a monoalkyl tin triamide compound having formula (1):

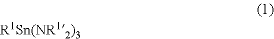

wherein R¹ and R^{1′} are each independently a primary alkyl group having about 1 to about 10 carbon atoms or a secondary alkyl group having about 3 to about 10 carbon atoms, comprises
(a) preparing a metal dialkylamide solution
(b) preparing a mixture comprising tin tetrahalide compound having formula (4) and monoalkyl tin trihalide compound having formula (5); and
(c) adding the mixture to the metal dialkylamide solution;

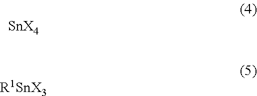

wherein each X is independently F, Cl, Br, or I. The reaction conditions are similar to those described previously.

According to another aspect of the disclosure, a method of purifying a mixture containing a monoalkyl tin triamide compound having formula (1), less than 0.05 mol % of a dialkyl tin diamide compound having formula (2), and about 0.1 to about 5 mol % of a tetrakis(dialkylamino)tin compound having formula (8):

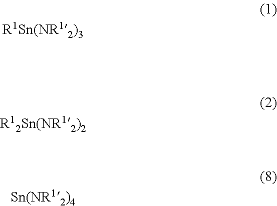

wherein R¹ and R^{1′} are each independently a primary alkyl group having about 1 to about 10 carbon atoms or a secondary alkyl group having about 3 to about 10 carbon atoms, comprises:
(a) adding at least one weak acid, at least one weak base, at least one weak acid polymer, or at least one weak base polymer to the mixture containing compounds (1) and (8) at about 15° C. to about 30° C. to produce a reaction mixture, wherein an amount of the at least one weak acid, the at least one weak base, the at least one weak acid polymer, or the at least one weak base polymer in the reaction mixture is at least about 2 equivalents relative to the amount of compound (8); and
(b) removing reaction byproducts to produce a mixture containing the monoalkyl tin triamide having formula (1), less than 0.05 mol % of the dialkyl tin diamide compound having formula (2), and less than 0.1 mol % of the tetrakis(dimethylamino)tin compound having formula (4). These method steps have been described previously.

The organometallic tin compounds having formula (1) may be used for the formation of high-resolution EUV lithography patterning precursors and are attractive due to their high purity and minimized concentrations of dialkyl impurities having formula (2), as well as additional impurities.

Isopropyl tin triamide produced by the methods according to the disclosure are colorless liquids with ¹¹⁹Sn NMR (neat) spectra showing peaks at 6-64.85 (99.8%) and 6-120 ppm (0.1 to 1.5%), agreeing with published and collected data for isopropyl tin triamide and tetrakisdimethylamino tin, respectfully. However, if desired, the product may be further distilled to remove any undesired organic impurities and/or byproducts, as well as to isolate any photo decomposed byproduct. In some embodiments, the isopropyl tin triamide compounds described herein have less than about 1 mol % (or less than about 0.5 mol %, or less than about 0.3 mol %, or even a non-detectable amount) of compounds having a chemical shift in the ¹¹⁹Sn NMR spectrum at around −84 ppm.

Two of the methods described herein are shown below in Schemes (D) and (E) for the specific compound having formula (3), isopropyl tris(dimethylamido) tin, using 1% SnCl₄ or 1% Sn(NMe₂)₄ as an example:

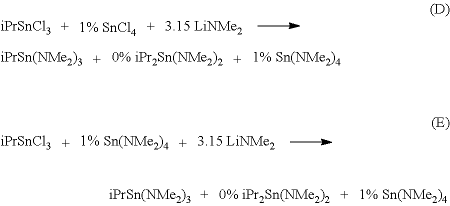

As explained above, it is known that disproportion scheme (II) occurs during and after the synthesis of monoalkyl tin triamides:

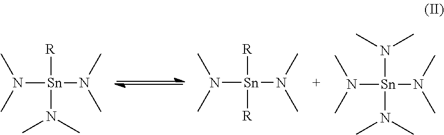

It has now been found that by adding about 0.1 to about 5% (preferably about 1.5% to about 3%) molar equivalents SnCl₄ to the reaction mixture, the equilibrium shown in scheme (II) is shifted to the left and the formation of diisopropyl tin diamide is suppressed, as shown below.

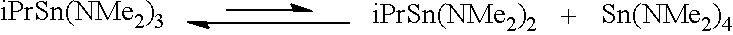

Finally, adding tetrachloro tin or tetrakis(dialkylamino) tin during the reaction can suppress the formation of the dialkyl tin compound at temperatures between −20° C. and 10° C., depending on the method. While the suppression methods produce tetrakis(dialkylamino)tin compounds as by-products, weak acids and weak bases selectively react with such compounds, as described in detail below. Using the methods described herein, iPrSn(NMe₂)₃ can be produced at very high purity (containing a non-detectable amount of dialkyl tin compounds and non-detectable amount of tetrakis(dimethylamino)tin) in a pilot scale.

### Light Sensitivity

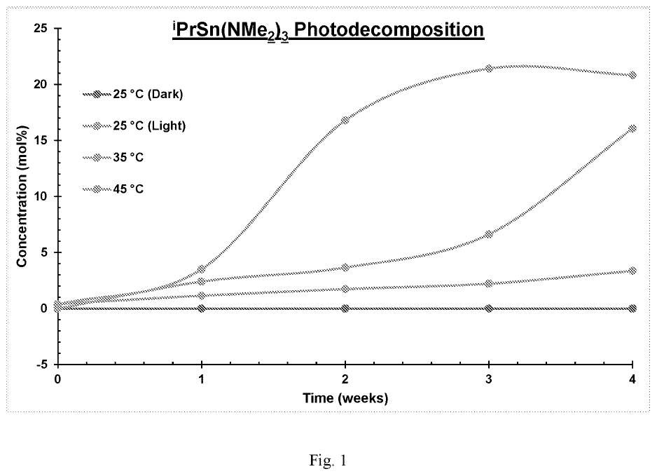

It has been found that monoalkyl tin triamide compounds are light sensitive, so that proper light protection is necessary during reaction and purification. Freshly prepared iPrSn(NMe₂)₃ is a colorless liquid. However, when an NMR sample of iPrSn(NMe₂)₃ is allowed to sit in the lab under normal room lighting, the sample turns yellow. This change in color is highlighted by the shelf-life data shown in FIG. 1. After exposure to light, there is a new ¹¹⁹Sn resonance at −84 ppm which indicates the formation of a light-induced decomposition by-product. The rate of photodecomposition increases with increasing temperature. Accordingly, maintaining the purified samples of iPrSn(NMe₂)₃ in the dark (without light exposure) minimizes the formation of undesirable light-induced decomposition byproducts and making it possible to provide (iPr)Sn(NMe₂)₃ in which a total content of substances having a chemical shift in the ¹¹⁹Sn NMR spectrum of around −84 ppm in is less than 1% by mass. Light control during the reaction steps to produce the monoalkyl tin triamide compounds is also important and may be accomplished by employing amber or stainless-steel reactors.

### Selective Treatment to Remove Tetrakis(Dialkylamino)Tin Compounds

Further aspects of the disclosure relate to a method of purifying a mixture containing a monoalkyl tin triamide compound having formula (1), no detectable amount of a dialkyl tin diamide compound having formula (2), and about 0.1 to about 5 mol % of a tetrakis(dialkylamino)tin compound having formula (8):

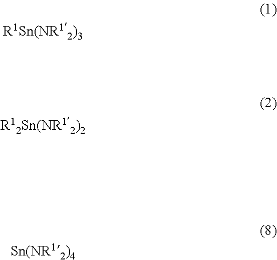

wherein R¹ and R^{1′} are each independently a primary alkyl group having about 1 to about 10 carbon atoms or a secondary alkyl group having about 3 to about 10 carbon atoms, the method comprising:
(a) adding at least one weak acid, at least one weak base, at least one weak acid polymer, or at least one weak base polymer to the mixture containing compounds (1) and (8) at about 15° C. to about 30° C. to produce a reaction mixture, wherein the amount of the at least one weak acid, the at least one weak base, the at least one weak acid polymer, or the at least one weak base polymer in the reaction mixture is at least about 2 equivalents relative to the amount of compound (8); and
(b) removing reaction byproducts to produce a mixture containing the monoalkyl tin triamide having formula (1), no detectable amount of the dialkyl tin diamide compound having formula (2), and no detectable amount of the tetrakis(dimethylamino)tin compound having formula (8).

It has been observed that samples of compounds having formula (1) may contain low concentrations (such as about 0.1 to about 5 mol %) of a tetrakis(dialkylamino)tin compound having formula (8), produced as a byproduct during the synthesis and/or distillation.

It is known (see, for example, Alywyn G. Davies (Organotin Chemistry Second Completely Revised and Updated Edition, Wiley-VCH, Germany, pp. 270 (2004)) that protic acids having a pKa less than about 25 cleave the Sn—N bond, and further that hydrolysis occurs very rapidly as well as with alcoholysis of aminotin compounds to produce alkoxides R¹ₙSn(OR^{1′})₄₋ₙ. However, it has been found that some weak acids selectively react with tetrakis(dialkylamino)tin compounds, and this selectively may be employed for purification, as shown in reaction (G) below.

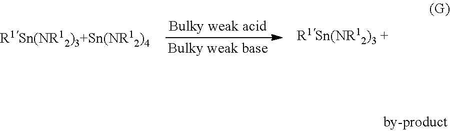

In the first step of the method, at least one weak acid, at least one weak base, at least one weak acid polymer, or at least one weak base polymer is added to the mixture containing compounds (1) and (8) at about 15° C. to about 30° C. (preferably at about room temperature) to produce a reaction mixture, wherein the amount of the at least one weak acid, weak base, weak acid polymer, or weak base polymer in the reaction mixture is at least about 2 equivalents relative to the amount of compound (8). Preferably the weak acid or weak base is a bulky weak acid or a bulky weak base. The term “bulky” is understood in the art to mean one which has a high molecular weight, high steric hindrance, and/or contains a relatively large group, such as a tetrabutyl group, cycloalkyl group, phenyl group, or a polymer. The weak acid or base or polymer may be added neat or in a solvent (such as, without limitation, hexanes, THF, or toluene), preferably with stirring and at a temperature of about 15° C. to about 30° C. Appropriate weak acids include, without limitation, tertiary alcohols, a phenol, a thiol, a 2,5-substituted phenol, a diol HO(CH₂)ₙOH (where n is about 2 to about 6), and appropriate weak bases include diolamines RₐN[(CH₂)n(OH)]₂ (where Rₐ is an alkyl group or H and n is about 1 to 6), and diamines RₐR_{b}N(CH₂)ₙNRₐR_{b} (Rₐ=alkyl or H, R_{b}=alkyl or H, n=about 2 to 6), and weak acid and weak base polymers such as polyethylene glycol, polyvinyl alcohol, or AmberSep GT75 (an alkyl thiol-functionalized chelating resin), as shown in reaction (H) below. Appropriate resins may be functionalized with at least one of OH, COOH, NH₂, or SH.

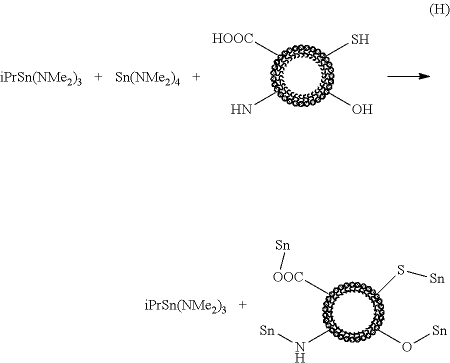

In the second step of the method, reaction byproducts are removed, such as by simple distillation, to produce high purity monoalkyl tin triamide having formula (1), no detectable amount of the dialkyl tin diamide compound having formula (2), and no detectable amount of the tetrakis(dialkylamino)tin compound having formula (8).

### Methods for Producing Monoalkyl Tin Compounds Having High Purity

To produce a monoalkyltin compound of a high purity with high productivity, it is necessary to significantly reduce specific impurities that are difficult to remove by distillation, and the currently reported reaction techniques were not satisfactory. Accordingly, aspects of the disclosure relate to a production method of a synthetic tin compound that can reduce impurities that are difficult to remove by distillation and efficiently produce a high-purity monoalkyltin compound by setting specific conditions for the production method.

According to the production method of a synthetic tin compound of the present disclosure, impurities that are difficult to remove by distillation can be reduced, and a high-purity monoalkyltin compound can be efficiently produced. Furthermore, the synthetic tin compound obtained by this production method makes it possible to obtain a higher-purity monoalkyltin compound by simple distillation.

The present disclosure will be described below based on various embodiments disclosed below, but is not limited to the embodiments described below.

In the present disclosure, when the expression “α-β” (α and β are arbitrary numbers) is used, unless otherwise specified, it includes the meaning of “no less than a but no more than β”, as well as the meaning of “preferably more than α” or “preferably less than β”.

Furthermore, when it is expressed as “α or more” (a is an arbitrary number) or “β or less” (β is an arbitrary number), it also includes the meaning of “preferably more than a” or “preferably less than β”.

Furthermore, in the present disclosure, “γ and/or δ (γ and δ are optional structures or components)” means three combinations, namely, γ only, δ only, and γ and 6.

In the specification, the upper limit or lower limit of a numerical range of stages may be arbitrarily combined with the upper limit or lower limit of another numerical range of stages. In addition, the upper limit or lower limit of a numerical range described in this specification may be replaced with a value shown in the examples.

The production method of a synthetic tin compound according to one embodiment of the present disclosure (hereinafter, may be referred to as “the production method”) and a purification method of a monoalkyltin compound according to one embodiment of the present disclosure (hereinafter, may be referred to as “the purification method”) will be described in detail below.

The production method is a method for producing a synthetic tin compound mainly composed of a monoalkyltin compound (A1) by reacting a tin compound, as a raw material, with a reactant under specific conditions. The synthetic tin compound obtained by the production method is a crude product that has not been purified and may be referred to as a “synthetic tin compound” for convenience. The synthetic tin compound purified by the purification method may be referred to as a “purified tin composition”.

The synthetic tin compound is a tin mixture that contains, as a main component, a monoalkyltin compound represented by the following general formula (A1) and that exists in a liquid state and contains at least other tin compounds.

Other tin compounds include, for example, by-products obtained in the process of synthesizing the tin compound and products generated from decomposition of the tin compound during storage.

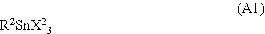

In the general formula (A1), R² is an organic group having 1-30 carbon atoms, X² is selected from OR^{2′}, NR²₂ and C≡CR^{2′}. R^{2′} may be the same or different and is an organic group having 1-10 carbon atoms which may be substituted with halogen. When there are multiple R^{2′} in the molecule, they may have different structures and may be bonded to each other to form a cyclic structure.

The main component means a component that has a great effect on the properties of the target substance, and the content of the main component is usually 50% by mass or more in the target substance excluding volatile components such as a solvent, preferably 55% by mass or more, more preferably 60% by mass or more, even more preferably 70% by mass or more, and particularly preferably 80% by mass. The content of the monoalkyltin compound represented by the following general formula (A1) in the synthetic tin compound is usually less than 95% by mass.

The monoalkyltin compound (A1) which is the target substance will now be described. Impurities other than the monoalkyltin compound (A1) will be described later.

### Monoalkyltin Compound (A1)

The monoalkyltin compound (A1), which is the target compound of the present disclosure, is defined as follows. It is a compound that has one organic group and three reactive substituents X² capable of having reactions such as hydrolysis that are bonded to tetravalent tin. Specifically, it is represented by the following general formula (A1).

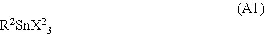

In the general formula (A1), R² is an organic group having 1-30 carbon atoms, X² is selected from OR^{2′}, NR²₂ and C≡CR^{2′}. R^{2′} may be the same or different and is an organic group having 1-10 carbon atoms which may be substituted with halogen. When there are multiple R^{2′} in the molecule, they may have different structures and may be bonded to each other to form a cyclic structure.

### Substituent R²

The substituent R² is an organic group having 1-30 carbon atoms, and the carbon atoms and/or hydrogen atoms in the organic group may be substituted with heteroatoms such as halogens, oxygen atoms, and nitrogen atoms. For the removal of the R² group during EUV exposure and the ease of vaporization of the generated R² group component, the upper limit of the number of carbon atoms in R² is 30 or less, preferably 20 or less, and more preferably 10 or less. From the viewpoint of the stability of the component to be removed, the lower limit thereof is 1 or more, preferably 2 or more, and more preferably 3 or more.

Furthermore, the R² group may be substituted with a heteroatom such as 0, N or a halogen. In some cases, containing a heteroatom results in higher decomposition with respect to the EUV light and improved resist performance such as sensitivity.

Specific preferred examples of the substituent R² include: an alkyl group such as a methyl group, an ethyl group, a propyl group, an isopropyl group, a butyl group, an isobutyl group, a sec-butyl group, a t-butyl group, a pentyl group, a hexyl group, a cyclopentyl group, and a cyclohexyl group; an aryl group such as a phenyl group, a tolyl group, a benzyl group, and a naphthyl group; an aromatic hydrocarbon group of an aralkyl group such as a phenethyl group, an α-methylbenzyl group, and a 2-phenyl-2-propyl group; an alkenyl group such as a vinyl group, a 1-propenyl group, an allyl group, and a 3-butenyl group; and an alkyl group substituted with a halogen atom such as a 2-fluoroethyl group and a 2-iodoethyl group.

In a further example of the structure, the compound may have the following structure. In the figure, R^{a} and R^{b} are organic groups having 1-10 carbon atoms which may be substituted with a heteroatom such as a halogen, oxygen atom, or nitrogen atom. The substituent A on the aromatic ring is a halogen atom or an organic substituent having 1-10 carbon atoms which may contain an O or N atom.

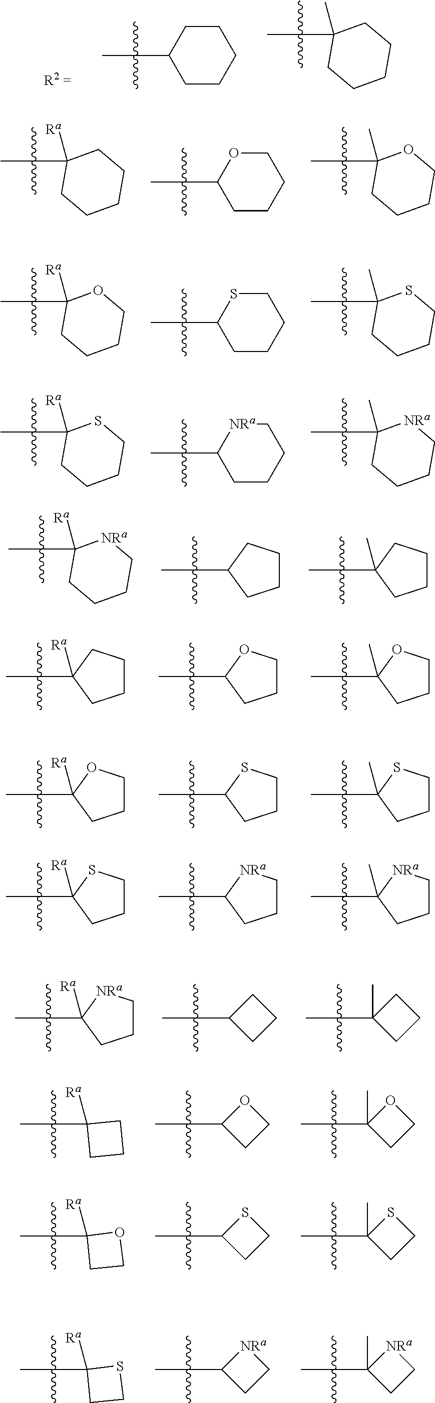

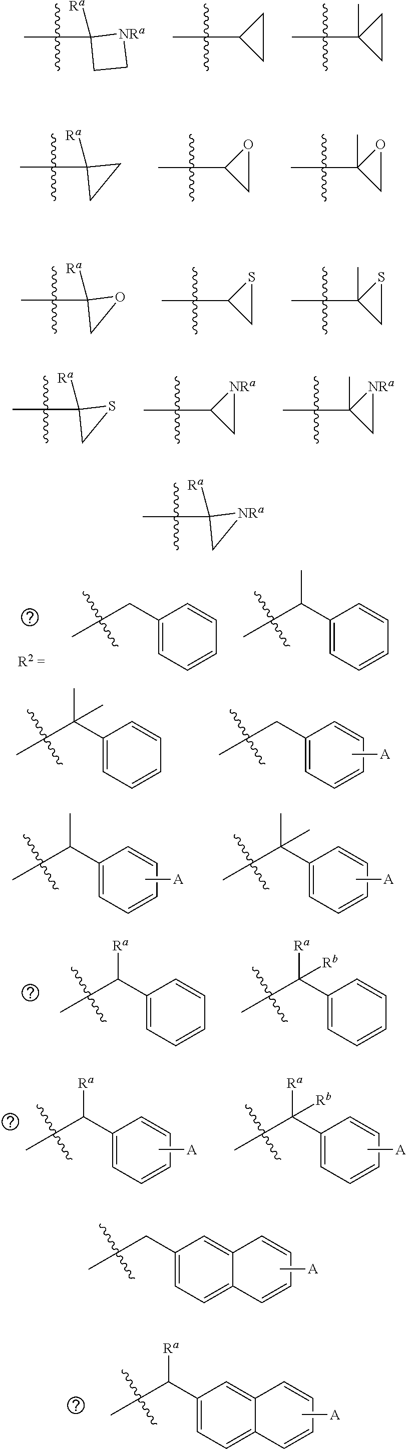

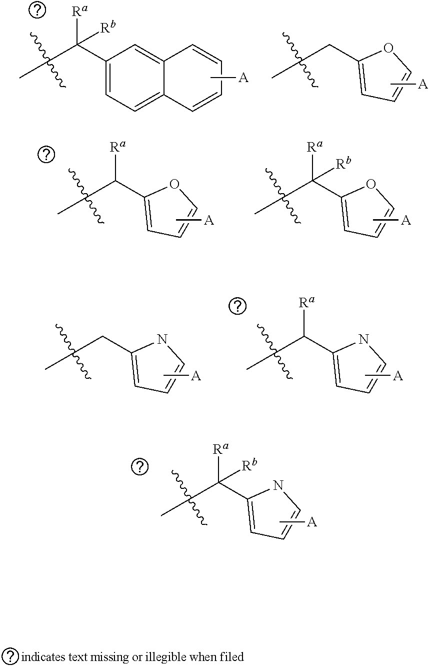

The substituent R² shown above is classified into a primary substituent R^{I}, secondary substituent R^{II}, and a tertiary substituent R^{III}, and it is typically an alkyl group or an aralkyl group. Preferred examples of each class are: primary substituent R^{I}: methyl group, ethyl group, n-propyl group, n-butyl group, isobutyl group, benzyl group, phenethyl group, etc.; secondary substituent R^{II}: isopropyl group, sec-butyl group, cyclopentyl group, cyclohexyl group, cycloheptyl group, α-methylbenzyl group, etc.; tertiary substituent R^{III}: t-butyl group, t-amyl group, 1-methyl-cyclopentyl group, 1-methyl-cyclohexyl group, 2-phenyl-2-propyl group, etc. Each of them may show different characteristics when used as a resist material. Hereinafter, the alkyl group will be used as a representative example for description. From the viewpoint of sensitivity (photoreactivity), the secondary alkyl group R^{II} and tertiary alkyl group R^{III}, which can be easily removed, are preferred for use in an EUV resist. From the viewpoint of hydrophobicity, the tertiary alkyl group R^{III} is most preferable for controlling solubility because it can increase hydrophobicity in the vicinity of a tin atom, but if the hydrophobicity is too high, the secondary alkyl group R^{II} may be preferable. From the viewpoint of thermal stability that affects distillation, etc., the primary alkyl group tends to be less prone to the disproportionation reaction, so purification may be made easy. On the other hand, the secondary and the tertiary alkyl groups are prone to the disproportionation reaction, and the secondary and tertiary alkyl group with a smaller carbon number (6 or less) are particularly unstable during distillation, and distillation with high purification efficiency is often difficult due to thermal decomposition, etc., so, in the reaction stage before the purification by distillation, it is more important to obtain a high-purity tin compound with a low content of by-products that have boiling points close to that of the target tin compound.

### Substituent X²

The structure of the substituent X² is not limited as long as it is a substituent that can have the reaction of, e.g., hydrolysis, but preferred specific examples thereof include OR^{2′} NR^{2′}₂, and C≡CR^{2′} in terms of high reactivity, and OR^{2′} and NR^{2′}₂ are more preferred in terms of hydrolysis reactivity. R^{2′} may be the same or different and is an organic group having 1-10 carbon atoms which may be substituted with halogen. When there are multiple R^{2′} in the molecule, they may have different structures from each other and may be bonded to each other to form a cyclic structure. Among them, from the perspective of a balance between high reactivity during hydrolysis and stability during synthesis, OR^{2′} is preferably an alkoxy group and NR^{2′}₂ is preferably an alkylamino group. Specific examples of the substituent R^{2′} include a methyl group, an ethyl group, a propyl group, an isopropyl group, a butyl group, an isobutyl group, a sec-butyl group, a t-butyl group, a t-amyl group, a 2-methyl-pentyl group, a trifluoroethyl group, and a trifluoromethyl group. Examples of NR^{2′}₂ include a 1-pyrrolidinyl group in which two substituents on the nitrogen are bonded to form a five-membered ring.

As the preferred substituent X², from the viewpoint of a low boiling point and good stability, an alkyl group not containing a heteroatom or an alkyl group containing fluorine is a preferred substituent R^{2′}. From the viewpoint of a low boiling point, a smaller number of carbon atoms is preferred, and from the viewpoint of thermal stability and stability against moisture, a larger number of carbon atoms is preferred. Specific examples of the substituent X² having an excellent balance of these properties include OR^{2′}: t-butoxy group, t-amyloxy group, 2-methyl-pentyloxy group, trifluoroethoxy group, trifluoromethoxy group; NR^{2′}₂: dimethylamino group, diethylamino group, methylethylamino group, pyrrolidyl group, etc. Among these, from the viewpoint of reactivity in hydrolysis when used as a resist material, a dimethylamino group and a diethylamino group are most preferred, and from the viewpoint of a balance between stability and reactivity, a t-butoxy group, t-amyloxy group, and 2-methyl-pentyloxy group are most preferred.

In addition, the organic group contained in the substituent R² and the substituent X² in the molecule may be bonded to each other to form a cyclic structure. In that case, for example, the compound may have the structure shown below.

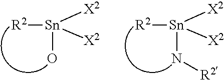

### Structure of the Monoalkyltin Compound (A1)

The monoalkyltin compound (A1) (hereinafter, sometimes referred to as “tin compound (A1)”) is not particularly limited in the structure or physical properties as long as they are within the above-mentioned ranges. However, when used as an EUV resist material, it may be preferable that the compound has the following physical properties.

### Boiling Point

The boiling point of the tin compound (A1) at 1 torr when in use is preferably 300° C. or lower, more preferably 250° C. or lower, even more preferably 200° C. or lower, and particularly preferably 150° C. or lower. The lower limit of the boiling point at 1 torr is usually 0° C. or higher, preferably 10° C. or higher, more preferably 20° C. or higher. A lower boiling point allows distillation at a lower temperature, which is preferable from the viewpoint of ease of deposition when used as a resist material. However, if the boiling point is too low, when used as an EUV resist, processes involving deposition and reactions at higher temperatures are difficult, and the thermal stability of the formed film may not be satisfactory, which may cause problems such as volatilization and scattering of components and outgassing.

### Molecular Weight

The molecular weight of the tin compound (A1) is preferably 500 or lower, more preferably 400 or lower, and even more preferably 350 or lower. The lower limit is preferably 150 or more, more preferably 180 or higher, and even more preferably 200 or higher. If the molecular weight is too high, the boiling point will be too high, and when used as an EUV resist, deposition or the like may be difficult. If the molecular weight is too low, the boiling point will be too low, and processes involving deposition or reactions at higher temperatures will be difficult, or the thermal stability of the formed film may be unsatisfactory, causing problems such as volatilization or scattering of components or outgassing.

Molecular Weight Difference Between Substituent R² and Substituent X²

There is no particular restriction on the molecular weight difference between the substituent R² and the substituent X², but it is preferably 50 or less, more preferably 30 or less, even more preferably 20 or less, particularly preferably 10 or less, and especially preferably 6 or less. The lower limit is 0. By reducing the molecular weight difference between R² and X², the mass differences of various outgases generated when used as a resist may be reduced, and the condition setting in the EUV process may be easier. In addition, to control the EUV sensitivity and boiling point of the tin compound, the molecular weight difference may be adjusted by changing the substituents.

On the other hand, as described later, the smaller the difference in the molecular weight between R² and X², the smaller the differences in the molecular weight between the target tin compound (A1) and impurities, which may make purification more difficult.

### Impurities

Tin Compounds that are Impurities

The tin compounds that are impurities other than the tin compound (A1) are not particularly limited, but representative examples of tin compounds as impurities include the following tin compounds (A2) and (A3). The tin compounds (A2) and (A3) are difficult to separate because they have structures and boiling points close to those of the tin compound (A1) and are difficult to separate by distillation, and they are generated by decomposition of (A1) during reactions, heating, etc.

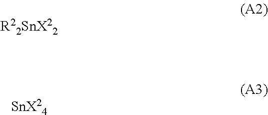

In particular, when the boiling points of the tin compound (A1) and the tin compound (A2) or (A3) are close to each other as shown below, separation by distillation is often difficult, and it is important to suppress the two compounds as impurities during reactions and post-treatment. In the case, where the tin compounds (A2) and (A3), impurities that have boiling points close to that of the target tin compound, are contained, it is preferable to suppress the content of the tin compounds (A2) and (A3) after the reaction, and the amount of the tin compounds (A2) and (A3) contained in the synthetic tin compound (crude product) after the reaction is preferably 3 mol % or less, more preferably 2 mol % or less, even more preferably 1 mol % or less, particularly preferably 0.5 mol % or less, especially preferably 0.3 mol % or less, and even more preferably 0.1 mol % or less, 0.05 mol % or less, and 0.03 mol % or less. The lower limit is 0 mol %.

### Boiling Points of Impurities

The boiling point referred to here may be a value compared at the same pressure, particularly at the pressure when the distillation is carried out, the pressure being not limited to normal pressure. When the difference in boiling point is close, it means that the difference in boiling point between tin compounds (A1) and (A2) is usually 50° C. or less, preferably 30° C. or less, more preferably 10° C. or less, and even more preferably 5° C. or less. The lower limit is 0° C.

In addition, when the molecular weights of R² and X² are close to each other, the difference in boiling point is close or the interaction between molecules is great, so separation is often difficult. When the difference in molecular weight between R² and X² is close to each other, the difference is usually 30 or less, preferably 20 or less, more preferably 10 or less, and even more preferably 5 or less. The lower limit is 0.

As an example, the difference in molecular weight between iPrSn(NMe₂)₃(A1-1) and iPr₂Sn(NMe₂)₂(A2-1) is small (294 g/mol and 293 g/mol, respectively). The difference is only 1 g/mol, and in addition, the polarity of the isopropyl group and the dimethylamino group are very similar, so the difference in boiling point between the tin compounds (A1-1) and (A2-1) is extremely small. When the boiling points of these compounds were measured, the difference in boiling point between the two compounds was within 2° C. at the pressure range of 0.7-10 torr. In other words, to obtain a high-purity tin compound (A1-1), distillation with a high separation ability is required.

The monoalkyltin compound (A1), which is the target substance, and its raw material monoalkyltin compound (hereinafter sometimes referred to as the “raw tin compound”) (B1) have the problem of being decomposed by side reactions during the reaction and the subsequent post-treatment process. For example, there may be a disproportionation reaction such as Kocheshkov reaction of the monoalkyltin compound (A1) as shown in the following formula, and this reaction may be accelerated or inhibited depending on various reaction conditions. In addition, the decomposition reaction may occur due to exposure to light, or the decomposition reaction may be accelerated by light and heat. In addition, the presence of a tiny amount of air, moisture, etc., may promote the decomposition.

### Decomposition of the Tin Compound

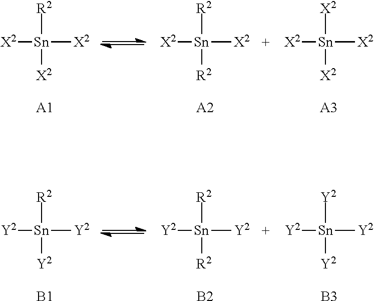

### Other Impurities

In addition, when the monoalkyltin compound (A1) is R²Sn(NR²₂)₃, the synthetic tin compound may contain the following tin compound A4 as an impurity.

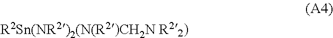

The tin compound (A4) is generated by decomposition of the monoalkyltin compound (A1), and the generation may be accelerated by heat, light, or a combination of these factors. For example, when the monoalkyltin compound (A1) is iPrSn(NMe₂)₃(A1-1), the tin compound A4 of iPrSn(NMe₂)₂(NMeCH₂NMe₂) (A4-1) represented by the following formula (A4-1) may be generated. It has the following ¹¹⁹Sn-NMR spectrum and ¹H-NMR chemical shifts and can be identified and quantified.

¹¹⁹Sn-NMR (223.8 MHz; C₆D₆): δ −82 ppm.

¹H-NMR (600 MHz; C₆D₆): δ 3.37 (s, 2H, CH₂), 2.89 (s, 3H, Sn—NMe), 2.86 (s, 12H, Sn—(NMe₂)₂), 2.15 (s, 6H, NMe₂), 1.68 (m, 1H, iPr), 1.33 (s, 6H, iPr).

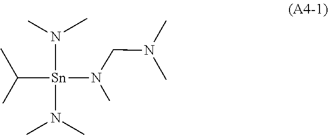 [SMILES: C[CH](C)[Sn]([N](C)C)([N](C)C)[N](C)CN(C)C]

It may further contain a divalent tin compound, SnX²₂ (A8). When the tin compound (A1) is R²Sn(NR^{2′}₂)₃, the divalent tin compound may be, for example, the following tin compound (A8-1).

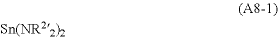

From the viewpoint of obtaining a high-purity resist material, the content of the tin compound A8 by tin atoms in the synthetic tin compound is preferably 1.0 mol % or less, more preferably 0.5 mol % or less, further preferably 0.1 mol % or less, particularly preferably 0.01 mol % or less. The lower limit is 0 mol %.

Further, given the raw material used and the production method, R²₃SnX² and R²₄Sn, which are compounds containing many alkyl groups, may also be present as impurities.

### Production Method of the Synthetic Tin Composition (P1)

Next, a production method for obtaining the monoalkyltin compound A1, which is the target compound of the present invention, will be described.

The production method of this embodiment includes a method wherein a raw material tin compound (B1) is made to react with a reactant ((M1) or (M2)) in an organic solvent (S1) under specific conditions to synthesize the synthetic tin composition (P1) for the purpose of obtaining the monoalkyltin compound A1.

The material components used in the production method will be described below. Raw material tin compound (B1)

The raw material monoalkyltin compound (B1) is represented by the following formula:

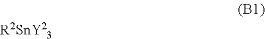

In the general formula (B1), R² is an organic group having 1-30 carbon atoms, Y² is selected from a halogen atom, OR^{2′}, and NR^{2′}₂. R^{2′} may be the same or different and is an organic group having 1-10 carbon atoms which may be substituted with halogen. When there are multiple R^{2′} in the molecule, they may have different structures and may be bonded to each other to form a cyclic structure.

The structure of the substituent Y² in the reaction formula is not limited as long as it is a substituent that reacts with the reactant (M1) and is substituted, but some specific preferred examples are a substituent selected from a halogen atom, OR^{2′}, and NR^{2′}₂, wherein a halogen atom is highly reactive, so it is preferred. Among them, a C1 atom is preferred because it will deliver a good balance between stability and reactivity, is easy to purify by distillation, etc., and it is easy to prepare a raw material tin compound (B1) with a higher purity, and of them, a monoalkyltin trichloride is the most preferred.

The purity of the raw material tin compound R²SnY²₃ can be increased by purification, and it is preferable to use high-purity R²SnY²₃ as a raw material because it reduces the amount of remaining impurities and increases the amount of high-purity tin compound A1. Specifically, its content by tin atoms is usually 95 mol % or more, preferably 97 mol % or more, more preferably 99 mol % or more, even more preferably 99.5 mol %, and particularly preferably 99.9 mol % or more. The upper limit is 100 mol %.

On the other hand, impurities tin compounds and moisture may contribute to stabilization by, for example, preventing crystallization of the target substance, or may influence the reaction for synthesizing the tin compound A1. Therefore, it may be preferable that the content of impurities tin compounds is 0.1 mol % or more, more preferably 0.2 mol % or more, and even more preferably 0.3 mol % or more.

Specifically, the contents of R²₂SnY²₂, R²₃SnY², and R²₄Sn by tin atoms are each preferably 3 mol % or less, more preferably 2 mol % or less, even more preferably 1 mol % or less, and particularly preferably 0.1 mol % or less. On the other hand, they may contribute to stabilization, such as preventing crystallization of the target substance, and therefore the contents of R²₂SnY²₂, R²₃SnY², and R²₄Sn each may be preferably 0.01 mol % or more, and more preferably 0.1 mol % or more.

### Reactant (M1)

The reactant (M1) is capable of undergoing a substitution reaction with the substituent Y of the raw material monoalkyltin compound B1 (R²SnY²₃) to produce the target substance or the monoalkyltin compound (A1) (R²SnX²₃). Preferred structures of the reactant (M1) include MX², MX²₂, MX²₃, and the like, and when M1 is MX², for example, the following theoretical reaction formula is obtained.

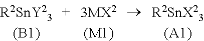

In the reaction formula, M of the reactant (M1) represents a metal atom of group 1, group 2, group 12, or group 13. When M of the reactant (M1) is a group 1 metal, the structure may be represented as MX², when it is a group 2 or group 12 metal, the structure may be represented as MX²₂, and when it is a group 13 metal, the structure may be represented as MX²₃ wherein the multiple X² in the molecule may be different. X² is as described in the above. Specifically, when X² is OR^{2′}, it may be, for example, LiOR^{2′}, NaOR^{2′}, KOR^{2′}, MgOR^{2′}₂, ZnOR^{2′}₂, and the like, of which LiOR^{2′}, NaOR^{2′}, and KOR^{2′} are preferred from the viewpoint of high reactivity. When X² is NR^{2′}₂, it may be, for example, LiNR^{2′}₂, NaNR^{2′}₂, KNR^{2′}₂, Mg(NR^{2′}₂)₂, Zn(NR^{2′}₂)₂, and the like, of which LiNR^{2′}₂, NaNR^{2′}₂, and KNR^{2′}₂ are preferred from the viewpoint of high reactivity, and Mg(NR^{2′}₂)₂ and Zn(NR^{2′}₂)₂ are preferred from the viewpoint of stability, and of them, LiNR^{2′}₂(lithium amides: lithium dimethylamide, lithium diethylamide, and the like) is most preferred from the viewpoint of ease of preparation of a high-purity reagent.

### Reactant (M2)

The reactant (M2) represents a compound selected from the reactant (M1) or a compound represented by the chemical formula HX². H is a hydrogen atom, and X² is the same as that contained in the tin compound A1. Examples of compounds corresponding to HX² include HOR^{2′} (methanol, ethanol, t-butanol, t-amyl alcohol, 4-methyl-2-pentanol, etc.) and HNR′₂ (dimethylamine, diethylamine, morpholine, etc.), and the like. From the viewpoint of reactivity, M2 is preferably a compound selected from M1 because it has high reactivity. From the viewpoint of preventing contamination by a metal after the reaction, compounds corresponding to HX², i.e., HOR^{2′} (methanol, ethanol, t-butanol, t-amyl alcohol, 4-methyl-2-pentanol, etc.) and HNR^{2′}₂(dimethylamine, diethylamine, morpholine, etc.) are preferred, and particularly when Y² in the raw material tin compound B1 (R²SnY²₃) is the highly reactive NR^{2′}₂, using a compound corresponding to HX² may obtain a high-purity product without contamination by a metal. The reactant (M11) described below is a compound selected from the HOR^{2″} structure, and examples of such compounds include those corresponding to HOR^{2′} in the reactant (M2). Preferably, the HX² in the reactant (M2) or the reactant (M11) is a secondary or tertiary alcohol because the monoalkyltin compound obtained is highly stable.

### Amount of the Reactants (M1) and (M2)

The lower limit, by molar equivalents relative to the raw material tin compound (B1), is preferably 3.00 eq or more, more preferably 3.03 eq or more, and most preferably 3.06 eq or more.

The upper limit is preferably 10.00 eq or less, more preferably 8.00 eq or less, and further preferably 7.00 eq or less. In some cases, a plurality of reactants (M1) and (M2) may be used in combination, and in such a case, it is preferable that the total molar equivalents of the reactants are within said range.

### Preparation Method of the Reactant (M1)

Regarding the temperature used in the process of preparing the reactant (M1), the lower limit of the temperature is preferably about −78° C. or higher, more preferably about −40° C. or higher, even more preferably about −20° C. or higher, particularly preferably about −10° C. or higher, and especially preferably about −5° C. or higher. The upper limit of the temperature is preferably about 40° C. or lower, more preferably about 20° C. or lower, and even more preferably 15° C. or lower. In particular, when the reactant (M1) is a lithium amide, it is necessary to prepare it from an amine and an alkyl lithium, and if the temperature is too high, the amine tends to volatilize or decomposition of the alkyl amide tends to be accelerated. Also, if the temperature is too low, the solubility of the dimethyl amide in the solvent tends to decrease, or the viscosity tends to increase, making stirring difficult.

The reaction time after the dropwise addition during preparation of the reactant (M1) is preferably 0.5 hours (hereinafter, the “time” may be referred to as “h”) or more as the lower limit, more preferably 1 h or more, and even more preferably 2 h or more. The upper limit is preferably 48 h or less, more preferably 30 h or less, and even more preferably 20 h or less. If the reaction time is too short, the reactant (M1) of sufficient purity may not be produced, or in the case of a slurry, the reactant (M1) may be produced inhomogeneously due to insufficient mixing. If the reaction time is too long, the reactant (M1) may decompose, resulting in the generation of by-products or a decrease in the number of equivalents.

In addition, it is preferable to continue stirring the reactant (M1) after it is prepared and to use the reactant (M1) from the reaction within 3 to 48 hours after it is prepared, from the viewpoints of maintaining the purity of the reactant (M1) and controlling the water content in the reactant (M1).

### Preparation Method of the Reactant (M2)

The reactant (M2) represents a compound selected from the reactant (M1) or a compound represented by the chemical formula HX². The preparation method of the reactant (M1) is as described above, and will be illustrated with the compound represented by the chemical formula HX². A commercially available compound of the chemical formula HX² may be used as is, but preferably a compound that has been purified by distillation, adsorption, column, etc., is used to avoid contamination by impurities, moisture, and metals. Alternatively, products that have been purified to the semiconductor grade (EL grade) or to the dehydration grade may be commercially available. The specific purity is preferably 95% by mass or more, more preferably 98% by mass or more, even more preferably 99% by mass or more, particularly preferably 99.9% by mass or more, and especially preferably 99.99% by mass or more. The upper limit is 100% by mass.

The specific water content is as shown by the organic solvent (S1) below. The specific amount of each metal element contaminant is preferably 100 ppm or less by mass, more preferably 10 ppm or less by mass, even more preferably 1 ppm or less by mass, particularly preferably 100 ppb or less by mass, and especially preferably 10 ppb or less by mass. The lower limit is 0 ppb by mass.

### Organic Solvent (S1)

In this production method, a raw material tin compound (B1), a reactant ((M1) or (M2)), and an organic solvent (S1) are used. The organic solvent (S1) is a compound different from the reactant (M2) and the reactant (M11) described below. The organic solvent (S1) is not particularly limited, but examples thereof include hydrocarbons (hexane, cyclohexane, heptane, decane, decalin, etc.), aromatics (benzene, toluene, xylene, anisole, etc.), ethers (THF (tetrahydrofuran), diethyl ether, TBME (t-butyl methyl ether), dibutyl ether, 3-methyl THF, THP (tetrahydropyran), 3-methyl THP, etc.), ketones (acetone, MEK (methyl ethyl ketone), MIBK (methyl isobutyl ketone), etc.), amides (DMF (NN dimethylformamide), DMAC (NN dimethylacetamide), etc.), esters (ethyl acetate, butyl acetate, etc.), and alcohols (methanol, ethanol, isopropanol, butanol, 4-methyl-2-pentanol, etc.), and solvents of aromatics, hydrocarbons, and ethers that do not easily react with the reactant are preferred. These solvents can be used alone or two or more of them can be used in combination. Preferably, the solvent itself does not contribute metal contaminants.

Particularly preferred are hydrocarbons and aromatics, which have low solubility in inorganic salts and allow easy removal of by-products such as inorganic salts by filtration, centrifugation, etc., after the reaction. Of them, toluene and hexane are currently the most preferred solvents because the products can be easily removed under a vacuum at a low temperature after the reaction. On the other hand, ethers are preferred solvents for smooth reaction because of their high solubility in organometallic reactants such as lithium dimethylamide. Specifically, by combining multiple solvents such as hydrocarbons, aromatics, and ethers, the advantages of these solvents may be combined. In addition, when HOR^{2″} (methanol, ethanol, t-butanol, 4-methyl-2-pentanol, etc.) is used as the reactant (M2), when HNR^{2′}₂ (dimethylamine, diethylamine, morpholine, etc.) is used, or when HOR^{2′} (methanol, ethanol, t-butanol, 4-methyl-2-pentanol, etc.) is used as the reactant (M11), the reactant (M2) or the reactant (M11) may play the role of a solvent. When the reactant (M2) or reactant (M11) serves as a solvent, the use of an organic solvent (S1) is optional.

### Water in the Solvent

In this embodiment, the moisture contained in the reaction solution may affect the reaction, and it is necessary to control it. If the reaction is performed in an inert atmosphere, the moisture represents the moisture brought in from the raw materials used, and the moisture as an impurity contained in the organic solvent (S1) that is used in a large amount often affects the reaction. The upper limit of the moisture content in the organic solvent (S1) used is preferably 500 ppm or less by mass, more preferably 300 ppm or less by mass, even more preferably 100 ppm or less by mass, and particularly preferably 80 ppm or less by mass. If the moisture is too much, the reactant (M1) may decompose and produce impurities as by-products. On the other hand, the lower limit is preferably 1 ppm or more by mass, more preferably 5 ppm or more by mass, even more preferably 7 ppm or more by mass, and particularly preferably 10 ppm or more by mass. By containing a certain amount of moisture, it is possible to adjust the solubility of the raw material tin compound (B1) and the reactant ((M1) or (M2)) in the organic solvent. In particular, in the case of a slurry reaction wherein the reactant (M1) or (M2) is insoluble in a solvent, it is possible to suppress by-products by having it react with the surface of the reactant (M1) or (M2) or by adjusting its solubility and activating it. In addition, the purity of the monoalkyltin compound (A1) obtained may be improved by the effect of reacting a specific amount of water selectively contained with the impurities mixed in the monoalkyltin compound (A1) and decomposing them. In particular, impurity with higher hydrolyzability and impurity with a large number of hydrolyzable substituents X² (e.g., impurities(A3) and A4 shown below) tend to be easily decomposed.

### Amount of Solvent Used: Substrate Concentration

The amount of solvent relative to the amount of substrate can be expressed as the substrate concentration. The substrate concentration represents the ratio (mass %) of the mass (g) of the raw tin compound (B1) used to the total mass (g) of the raw tin compound (B1) and all the organic solvents (S1) used. The upper limit of the substrate concentration is preferably 30% or less by mass, more preferably 20% or less by mass, and even more preferably 15% or less by mass. In particular, in the case of a slurry reaction using a solvent (e.g., hexane, toluene, etc.) that does not dissolve a solid reactant (M1) such as lithium amide, a lower concentration may be preferable in order to improve stirrability. In that case, the concentration is preferably 10% or less by mass, more preferably 8% or less by mass.

### Reaction Conditions for the Synthesis

In synthesizing the synthetic tin composition (P1) mainly composed of the tin compound A1, it is possible to synthesize the synthetic tin composition (P1) containing the tin compound (A1) of a high purity while preventing the generation of impurities by controlling the reaction conditions. Specifically, it is necessary to control the equipment and conditions involved in the reaction as described below.

### Reaction Method

In the production method of the monoalkyltin compound (A1) of the present disclosure, as shown in the reaction formula below, the raw material tin compound (B1), reactant (M1) or (M2), and optionally, a tin compound represented by SnY²₄, are allowed to contact and react with each other in an organic solvent (S1) under stirring to synthesize the synthetic tin composition (P1) mainly composed of the monoalkyltin compound (A1).

The reaction conditions in this case include, for example, the following:

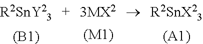

Reaction conditions: methods of adding the materials, temperature, stirring method, inert gas atmosphere

For example, the pressure may be adjusted to 1 kPa or less, and the N₂ replacement may be performed by introducing N₂ at least twice to maintain the N₂ atmosphere to prevent moisture from entering the system from the outside.
Raw material tin compound (B1): tin compound (B1): purity and impurities contained
Reactant (M1): equivalents relative to B1, purity
Organic solvent (S1): amount of the solvent, amount of moisture, and purity, relative to those of B1
Equipment conditions: material of the reactor, cooling and heating equipment, and condenser equipment

### Methods of Adding the Materials

In the production method of the present disclosure, a starting tin compound (B1) is made to contact a reactant (M1) or (M2) in an organic solvent (S1) under stirring, preferably by, for example, the following two methods.

(i) A method of adding the raw material tin compound (B1) to the reactor in which the reactant (M1) or (M2) and the organic solvent (S1) are being stirred (the raw material tin compound (B1) may be diluted with a separate solvent); (ii) A method of adding the reactant (M1) or (M2) to the reactor in which the raw material tin compound (B1) and the organic solvent (S1) are being stirred (the reactant (M1) may be diluted with a separate solvent);

In these two methods, when a step of preparing the reactant (M1) in the reactor is required, the method (i) is preferred because it allows all the steps from the preparation of the reactant (M1) to the production step of the production method of the present disclosure to be consistently carried out in a single reactor. On the other hand, when it is desirable to adjust the rate of adding the reactant (M1), the method (ii) may be preferred.

In either of the methods (i) and (ii), the liquid in the reactor may be a homogeneous mixture such as a completely dissolved solution, or may be in a state in which some solids are dispersed, i.e., a slurry. When at least one of the raw material tin compound (B1) and the reactant (M2) is dispersed as a solid in the organic solvent (S1) during mixing, preferably the reactant is kept at a high concentration.

### Contact Temperature T1

In the reaction for producing the tin compound (A1) as described above, to obtain the tin compound (A1) of a higher purity after the reaction, preferably the temperature is controlled at the temperature at which the raw tin compound (B1) and the reactant (M1) or (M2) make contact (hereinafter sometimes referred to as the contact temperature (T1)). Specifically, at least 50% by mass of the raw tin compound (B1) is mixed with the reactant (M1) or (M2) at the contact temperature T1, or at least 50% by mass of the reactant (M1) or (M2) is mixed with the raw tin compound (B1) at the contact temperature T1, and the contact temperature T1 is controlled within a desired range. Here, the contact temperature T1 refers to the temperature measured for 50% or more of the mixing time. The contact method is not particularly limited, but for example, the reactant (M1) or (M2) may be dropped into the raw tin compound (B1) and the organic solvent in the reactor with stirring, or the raw tin compound (B1) may be dropped into the raw reactant (M1) or (M2) and the organic solvent in the reactor with stirring. In either case, the temperature of the liquid in the reactor at the time of dropping corresponds to the contact temperature (T1). If the reaction rate of the reaction is high and the reaction is completed within 1 h, the contact temperature (T1) has a great effect on the reaction result.

The upper limit of the contact temperature (T1) is preferably 70° C. or lower, more preferably 60° C. or lower, even more preferably 50° C. or lower, and particularly preferably 40° C. or lower. The lower limit is preferably 7° C. or higher, more preferably 10° C. or higher, even more preferably 15° C. or higher, and particularly preferably 20° C. or higher.

The contact temperature (T1) may fluctuate during the material adding step due to reaction heat, cooling by the jacket, etc., but the temperature measured for 50% or more of the mixing time is included in this temperature range.

If the contact temperature (T1) is higher than the upper limit, the organic solvent may volatilize, or the raw tin compound (B1) and the reactant (M1) or (M2) may decompose. As a result, the impurities in the obtained synthetic tin composition (P1) tend to increase, and the purity of the tin compound (A1) tends to decrease. If the contact temperature (T1) is lower than the lower limit, the reaction rate tends to decrease, and the impurities tend to increase.

In the present disclosure, during the amination reaction to synthesize the monoalkyltin compound (A1) (monoalkyltin triamide), disproportionation reactions such as the Kocheshkov reaction shown in the scheme of the decomposition of the tin compound also occurs, and even at low temperatures, for example, from about −78° C. to 10° C., the disproportionation reaction cannot be prevented. Instead, low temperatures have been found to slow down the substitution reaction, which increases the risk of disproportionation. Furthermore, light and heat accelerate the disproportionation, forming up to 15 mol % of dialkyltin amide as measured by ¹¹⁹Sn-NMR.

While performing the amination reaction to form monoalkyl tin triamides, the Kocheshkov-like comproportionation and disproportionation shown in scheme (I) above also occurs, and even low temperature, such as from about −78° C. to 10° C., does not prevent the comproportionation and disproportionation reactions from occurring. Instead, the low temperature has been found to slow the amination reaction, which increases the risk of comproportionation and disproportionation. Further, light or heat can accelerate the comproportionation and disproportionation and form up to 15 mol % dialkyl tin amides as determined by ¹¹⁹Sn NMR. According to the method reported by Lorberth, the amination reaction is performed as a solid slurry in hexanes and is a liquid reaction.

Considering the Kocheshkov-like comproportionation and disproportionation during the substitution reaction between alkyl trichloro tin and lithium dimethyl amide, there is a competitive reaction between amination and the and disproportionation reaction shown in scheme (F), and the reaction rates K₁ and K₂ can be affected by reaction temperature. These results agree with the theory that lowering the reaction temperature also lowers K₁, which causes higher amounts of dialkyl bis(dialkylamino)tin to form.

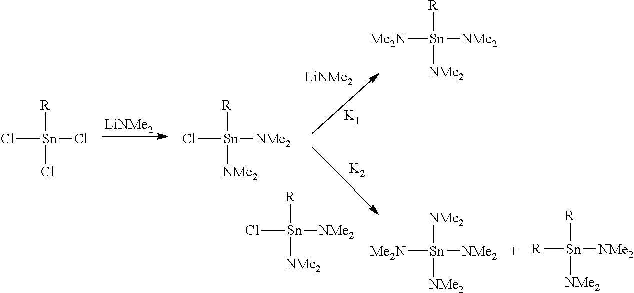

The methods described herein solve known problems with suppressing dialkyltin compound formation in several ways. First, it has been found, as described herein, that to prevent comproportionation from occurring during the reaction, the lithium dialkylamide must be prepared properly. Second, the concentration of reactants is diluted, such as by employing lithium dialkylamide in a hexane slurry at a concentration of not more than about 10 wt %. Third, comproportionation may be reduced to as low as about 0.05% to about 0.09 mol % by performing the reaction at around 22° C. to 30° C., rather than at a lower temperature when the alkyl trichlorotin is added without presenting tetrachlorotin. Table I below provides data to demonstrate the effect of addition temperature on dialkyl formation.

TABLE I
Effect of addition temperature on
formation of dialkyl tin compound

| iPrSnCl₃ addition temperature | 22° C. to 30° C. | −10° C. to 10° C. |
|---|---|---|
| Diisopropylbis(dimethylamino)tin | ~0.05%-0.09% | ~0.2%-0.5% |
| Isopropyltris(dimethylamino)tin | ~99.91%-99.96% | ~99.5%-99.8% |

In the competition between the amidation and disproportionation of the intermediate R²SnX²₂Y², when the amidation reaction rate K¹ is significantly faster than the disproportionation reaction rate K², then almost no dialkyl compound R²₂SnX²₂ is produced. As a result of the amidation reaction being sufficiently fast, it is preferable that the formation ratio(A1/A2) of monoalkyltin compound (A1) and dialkyltin compound (A2) is 600 or more. The contact temperature (T1) is preferably no lower than the temperature at which the reaction that generates the monoalkyltin compound becomes significantly more advantageous than the disproportionation reaction, and is preferably no lower than the temperature at which the formation ratio (A1/A2) of the monoalkyltin compound (A1) and the dialkyltin compound (A2) becomes 600 or higher. The contact temperature (T1) is preferably lower than the lowest decomposition temperature among the decomposition temperatures of the raw material tin compound (B1), the reactant (M1) or (M2), and the monoalkyltin compound (A1). The reaction rate means a value that can be calculated from the production ratio of the product of each reaction.

### Temperature Range of the Contact Temperatures (T1) and Temperature Difference Between the Contact Temperature and the Jacket Temperature

In the reaction of the present disclosure, the temperature may change during the contact due to reaction heat, the temperatures of the raw materials to be added, the jacket temperature, etc. To control the contact temperature (T1) and suppress side reactions, preferably the temperature fluctuation range of the contact temperatures (T1) during the above mixing period is narrow. Specifically, the upper limit of the temperature fluctuation range is preferably 30° C. or lower, more preferably 20° C. or lower, even more preferably 15° C. or lower, and particularly preferably 10° C. or lower. On the other hand, if the temperature fluctuation range is too narrow, the contact time may need to be long, and various raw materials may decompose or the productivity may be lowered. In that case, the lower limit of the temperature fluctuation range is preferably 1° C. or higher, more preferably 3° C. or higher, and even more preferably 5° C. or higher.

The temperature difference between the contact temperature (T1) and the jacket temperature is preferably kept within 10° C., more preferably within 8° C., and further preferably within 5° C. The lower limit is 0° C.

To control the contact temperature to the desired level, effective ways include, for example, slowing down the dropwise adding rate, increasing the stirring speed, increasing the cooling capacity of the reactor, and using a cooling condenser.

### Reactor

The reactor is not particularly limited, but is preferably a reactor capable of controlling the contact temperature (T1) to be within an appropriate range. Specifically, preferably the reactor has a temperature control device (jacket device) capable of cooling and heating, a stirring device, and a dropwise adding device.

The material of the reactor (inner surface of the still, stirring blades) is not particularly limited, but is preferably Teflon (registered trademark), glass, SUS, and the like. Of them, glass and Teflon (registered trademark) are preferred from the viewpoint of preventing metal contamination, and SUS is preferred from the viewpoint of strength and thermal conductivity (temperature control by a jacket).

The capacity of the reactor can be set arbitrarily within a range appropriate for the required amount of reaction liquid, but to perform efficient dropwise adding and stirring operations that satisfy the above-mentioned contact temperature, the lower limit of the capacity is preferably 100 mL or more, more preferably 300 mL or more, even more preferably 1 L or more, and particularly preferably 10 L or more. The upper limit of the capacity is preferably 50 kL or less, more preferably 10 kL or less, even more preferably 5 kL or less, and particularly preferably 2 kL or less.

### Cooling Condenser

In the reaction of the present disclosure, the contact temperature is controlled by cooling the reactor itself, but by providing a cooling condenser at the top of the reactor, the reaction may be controlled more efficiently. In particular, when the raw materials are volatile at the contact temperature, the cooling condenser is important, and it may contribute to the cooling capacity of the reactor by suppressing the volatilization of the raw materials and the solvent, maintaining the reaction material amount in an appropriate range, or by refluxing the raw materials and the solvent. To have a satisfactory cooling function, the temperature of the cooling condenser is preferably 30° C. or lower, more preferably 20° C. or lower, and even more preferably 10° C. or lower. On the other hand, since there is a concern that the volatilized components may solidify and cause blockages when the temperature is too low, it is preferably −20° C. or higher, more preferably −15° C. or higher, and even more preferably −10° C. or higher.

### Stirring Speed

During the production process, to produce the monoalkyltin compound of a high purity at high productivity, it is necessary to highly reduce impurities that are difficult to remove by purification methods such as distillation. In conventional small-scale synthesis examples, a general stirring method was not a problem, but there was room for improvement in large-scale synthesis in, for example, industrial production process. As one embodiment of the present disclosure, when the reaction is carried out under specific stirring conditions, even in the case of a large-scale synthesis, it is possible to efficiently suppress the generation of impurities to produce the monoalkyltin compound of a high purity. In the case of a large-scale synthesis, for example, the amount of the raw material tin compound ((B1) or (B 11)) is usually 10 mol or more.

The stirring speed is important because it can determine the purity of the product obtained with the production method of the present disclosure. In particular, when the reactant (M1) or (M2) is a solid and insoluble in the solvent, it may be necessary to control the stirring conditions to achieve sufficient mixing to have a slurry reaction. For example, a solution of lithium amide in hexane or toluene is a heavy slurry, so preferably the mixture is stirred at a high speed (high rotation speed, and blade tip speed) for sufficient mixing. On the other hand, if the stirring speed is too high, it may cause problems in the motor due to the heavy slurry or the shear stress may become too large, causing the particle size of the slurry to become small and further worsening the stirrability.

In addition, in the reaction of the present disclosure, when the raw tin compound (B1) and the reactant (M1) or (M2) make contact (when at least 50% by mass of the raw tin compound (B1) is mixed with the reactant (M1) or (M2) or when at least 50% by mass of the reactant (M1) or (M2) is mixed with the raw tin compound (B1)), temperature control is important, and enhancing of stirring is preferred as it reduces temperature differences throughout the reactor and facilitates the removal of heat generated by the reaction heat, so that the reaction can be carried out in a better temperature range. The stirring speed is preferably 20 rpm or more in terms of rotation speed (rpm, number of rotations per minute), more preferably 40 rpm or more, even more preferably 60 rpm or more, and most preferably 100 rpm or more. On the other hand, the stirring speed is preferably lower than 500 rpm, more preferably lower than 400 rpm, even more preferably lower than 300 rpm, and particularly preferably lower than about 250 rpm.

In the stirring speeds, to provide efficient stirring for the above-mentioned slurry reaction, it is important that the blade tip speed (m/s), which is proportional to the shear stress, is high. The blade tip speed (m/s) is calculated by the following formula (a).

$$Blade tip speed ( m / s ) = π \times d \times N / 60 \qquad ( a )$$

In the above formula (a), π is the ratio of the circumference of a circle to its diameter (approximately 3.14), d is the diameter of the stirrer (stirring blade) (m) (here, the diameter of the blade is defined as twice the distance from the center of rotation to the farthest point of the blade in the horizontal direction (the tip of the blade), and N is the rotation speed (rpm, number of rotations per minute).

The lower limit of the blade tip speed (m/s) is preferably 1.2 or higher, more preferably 1.5 or higher, even more preferably 1.7 or higher, and particularly preferably 2.0 or higher. The upper limit is preferably 100 or lower, more preferably 10 or lower, and even more preferably 4.5 or lower. If it is below the lower limit, the stirring is insufficient and the reaction system tends to become inhomogeneous. If it is above the upper limit, the shear stress is too large, the particle size of the slurry becomes small, and the stirrability tends to deteriorate.

In addition, to achieve good mixing of the entire reaction system, it is important to select an appropriate shape and size of the stirring blade. Examples of the shape of the stirring blade include a paddle, tilted paddle, propeller, disk turbine, anchor, twin star, ribbon, three-blade-sweeping-back, log bone, full zone, and Maxblend, etc. Of them, a paddle, tilted paddle, twin star, and three-blade-sweeping-back are preferred, and twin star is particularly preferred as it can deliver very good stirring during dripwise adding, regardless of whether the liquid amount is large or small. In addition, the stirring capacity may be improved by installing multiple stirring blades. The size of the stirring blade is determined by the ratio (d/D) of the stirring blade diameter (d) to the inner diameter (D) of the reactor. The preferred d/D varies depending on the shape of the stirring blade, but it is usually in the range of 0.2 to 0.95. For example, for a paddle, tilted paddle, three-blade-sweeping-back, twin star, etc., it is preferably 0.3-0.8, and more preferably 0.4-0.7, while for anchor, it is preferably 0.8 or more, and more preferably 0.9 or more. Here, the diameter of the blade is defined as twice the distance from the center of rotation to the point of the blade farthest from the center in the horizontal direction (the tip of the blade). The stirring blade is preferably made of SUS coated with Teflon (registered trademark). As the stirring device, the stirring blade shown above is preferred but a stirrer can also be used depending on the scale, and in that case, a stirrer that is sufficiently large for the amount of the reaction liquid is preferred.

### Filtration

Preferably, the raw material tin compound ((B1) or (B11)) is made to contact the reactant ((M1), (M11), or (M2)) in the stirred organic solvent (S1) to cause a reaction, and then filtration is performed. When this step is carried out, it will be easy to perform the distillation, so it is preferred.

### Synthetic Tin Composition (P1)

The synthetic tin composition (P1) refers to a compound containing monoalkyltin (A1) as a main component which is synthesized by the reaction of the production method of the present disclosure and represents the state before separation and purification by distillation is performed. Unless purification by distillation is performed, a concentration operation for removing the solvent and a filtration operation for removing insoluble matters may be performed after the reaction.

### Purity of the Monoalkyltin Compound A1

The purity (content) of the monoalkyltin compound (A1) in the synthetic tin composition (P1) by tin atoms is preferably 80 mol % or higher, more preferably 85 mol % or higher, even more preferably 90 mol % or higher, and particularly preferably 95 mol % or higher, but the upper limit is usually lower than 98 mol %.

On the other hand, the components other than the tin compound (A1) in the synthetic tin composition (P1) are impurities, and examples thereof include metal impurities such as the above-mentioned tin compounds (A2),(A3), and (A4). The content of impurities is the content obtained by subtracting the amount of the tin compound (A1) from the total amount of the synthetic tin composition (P1). In particular, the content of impurities having molecular weights and boiling points (boiling point difference of 10° C. or less) similar to that of the target compound, relative to the synthetic tin composition (P1), is preferably 2 mol % or lower, more preferably 1 mol % or lower, even more preferably 0.5 mol % or lower, and particularly preferably 0.3 mol % or lower. The lower the better, but it is usually 0.01 mol % or higher. Examples of compounds having similar boiling points include the dialkyl tin compound R²₂SnX²₂ (A2) and the like.

Here, the above-mentioned purity expressed by mol % based on the weight of tin atoms is the ratio of the number of tin atoms of the target compound to the number of tin atoms of all the compounds having tin atoms (including unidentified compounds). In practice, it is calculated by using the sum of the integral values of all the peaks observed by ¹¹⁹Sn-NMR as the denominator and the integral value of the peak of the target compound as the numerator.

According to this calculation method, only compounds having tin atoms are included in the calculation. For example, even if after the synthetic tin composition (P1) is produced by the method for producing the monoalkyltin compound A1, additives or solvents are added according to various applications, the tin compound containing the monoalkyltin compound (A1) and other tin compounds that are impurities is the tin composition P1 obtained by the production method of the present disclosure.

According to the method of analysis by ¹¹⁹Sn-NMR, to improve the sensitivity, the analysis is performed without diluting the organotin compounds, and the results can be obtained by using the conditions of a large number of integrations (1,000 integrations or more, preferably 10,000 integrations or more), sufficient relaxation time (1 second or more), and reverse gate decoupling. As a result, by using these methods, the detection limit for the impurities tin compounds (A2), (A3), and (A4) can reach 0.01 mol %. In addition, if the sensitivity is still insufficient for the measurement of peaks, the detection sensitivity can be further increased by using a high-sensitivity NMR (for example, a cryoprobe is used with a 600 MHz NMR), and detection of 0.001 mol % is also possible.

### Content of Impurities in the Synthetic Tin Composition (P1)

The impurities, tin compounds (A2), (A3), and A4, in the obtained synthetic tin composition (P1) are described below:

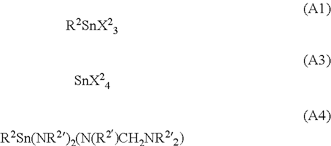

The amount of the tin compound (A2) as an impurity in the synthetic tin composition (P1) is preferably 3 mol % or less, more preferably 2 mol % or less, even more preferably 1 mol % or less, particularly preferably 0.5 mol % or less, 0.3 mol % or less, still more preferably 0.1 mol % or less, especially more preferably 0.05 mol % or less, and most preferably 0.01 mol % or less. The lower limit is 0 mol %.

If the content of the tin compound (A2) is too high, it will cause poor crosslinking and lower toughness when used in EUV lithography resists. Furthermore, tin compound (A2) can cause outgassing when the photoresist is exposed to extreme UV radiation, leading to degradation of very expensive multi-layer coated optics in extreme situations.

The content of the tin compound (A3) as an impurity in the synthetic tin composition (P1) is preferably 3 mol % or lower, more preferably 2 mol % or lower, even more preferably 1 mol % or lower, particularly preferably 0.5 mol % or lower, especially preferably 0.3 mol % or lower, still more preferably 0.1 mol % or lower, and most preferably 0.01 mol % or lower. The lower limit is 0 mol %.

If the content of the tin compound (A3) is too high, the crosslinking ability tends to increase too much when hydrolysis or other processes are performed to use it as a resist material, resulting in gelation or generation of inhomogeneous aggregates. This tends to result in reduced adhesion and increased roughness.

The content of the tin compound (A4) as an impurity in the synthetic tin composition (P1) is preferably 3 mol % or lower, more preferably 2 mol % or lower, even more preferably 1 mol % or lower, particularly preferably 0.5 mol % or lower, especially preferably 0.3 mol % or lower, still more preferably 0.1 mol % or lower, and most preferably 0.01 mol % or lower. The lower limit is 0 mol %.

If the content of the tin compound (A4) is too high, the resist material tends to have poor crystallinity or may have inhomogeneous aggregates generated due to different hydrolysis reactivity during hydrolysis. This tends to result in reduced adhesion and increased roughness.

Other impurities may include polyalkyl compounds such as R²₃SnX² and R²₄Sn, divalent tin compounds such as SnX²₂, and impurities of tin oxides having an R²SnO structure produced by hydrolysis or other reactions. The content of each of these impurities in the synthetic tin composition (P1) is preferably 2 mol % or lower, more preferably 1 mol % or lower, even more preferably 0.5 mol % or lower, and particularly preferably 0.3 mol % or lower, especially preferably 0.1 mol % or lower, and most preferably 0.01 mol % or lower.

### Production Method of the Synthetic Tin Compound (P11)

In addition, another synthetic tin compound (P11), a compound different from the synthetic tin composition (P1), can be produced based on the production method of the synthetic tin composition (P1).

Specifically, a synthetic tin compound (P11) mainly composed of the monoalkyltin compound (All) can be produced by reacting a raw material tin compound (B11) with a reactant (M11) under the following conditions. Here, the purity of the monoalkyltin compound (A11) in the synthetic tin compound (P11) is 80 mol % or more.

The monoalkyltin compound (A11), the raw material tin compound (B11), and the reactant (M11) are each a compound represented by the following formula:

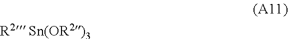

In the general formula (A11), R^{2″″} is an organic group having 3-30 carbon atoms. R^{2″} may be the same or different and is an organic group having 2-10 carbon atoms which may be substituted with halogen. When there are multiple R^{2″} in the molecule, their structures may be different from each other or they may be bonded to each other to form a cyclic structure.

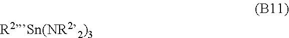

In the general formula (B11), R^{2″″} is an organic group having 3-30 carbon atoms. R^{2′} may be the same or different and is an organic group having 2-10 carbon atoms which may be substituted with halogen. When there are multiple R^{2′} in the molecule, they may have different structures and may be bonded to each other to form a cyclic structure.

### Reactant (M11)

The reactant (M11) is a compound selected from the group consisting of the structure HOR^{2″}. In the structure, R^{2″} is the same as that in (A11).

### Condition 1′

The starting tin compound (B11) and the reactant (M11) are made to contact and react with each other in a stirred organic solvent (S1).

### Condition 2′

At least 50% by mass of the raw material tin compound (B 11) is mixed with the reactant (M11) at the contact temperature T1, or at least 50% by mass of the reactant (M11) is mixed with the raw material tin compound (B11) at the contact temperature T1, the contact temperature T1 being 10 to 70° C. The contact temperature T1 refers to a temperature measured for at least 50% of the time of mixing.

The synthetic tin compound (P11) can also be synthesized by conducting the reaction under the following <Condition 3′> instead of the above <Condition 2′>.

### Condition 3′

At least 50% by mass of the raw material tin compound (B 11) is mixed with the reactant (M11) at the contact temperature T1, or at least 50% by mass of the reactant (M11) is mixed with the raw material tin compound (B 11) at the contact temperature T1, the contact temperature T1 at or higher than the temperature at which the rate of the target production reaction is 600 times or more higher than the rate of the disproportionation reaction and lower than the temperature at which decomposition of the raw material tin compound (B11) by the reactant (M11) takes place. The contact temperature T1 refers to a temperature measured for at least 50% of the time of mixing.

The production method of the synthetic tin compound (P11) may be applied to production of the synthetic tin composition (P1). Specifically, preferably the monoalkyltin compound (A11) has the same structure as that of the monoalkyltin compound (A1) except that the substituent X² is OR^{2″}. Some preferred examples of the substituent OR^{2″} include t-butoxy, t-amyloxy, 2-methyl-pentyloxy, trifluoroethoxy, trifluoromethoxy, and the like. In view of a balance between stability and reactivity, t-butoxy, t-amyloxy, and 2-methyl-pentyloxy are most preferred, and in view of a boiling point suitable for distillation, t-butoxy and t-amyloxy are most preferred. Preferably, the raw material tin compound (B11) has the same structure as that of the raw material tin compound (B1) except that the substituent Y² is NR^{2′}₂. Some preferred examples of the substituent NR^{2′}₂ include dimethylamino, diethylamino, methylethylamino, pyrrolidyl, and the like.

From the viewpoint of a balance between stability and reactivity, a dimethylamino group and a diethylamino group are preferred, and from the viewpoint of the reactivity of the reactant (M11) in this case, a dimethylamino group is particularly preferred.

The reactant (M11) corresponds to a compound selected from the structures of HOR^{2″} contained in the reactant (M2), and the preferred range for the reactant (M2) can be applied to it. Specific preferred structures of the reactant (M11) include methanol, ethanol, t-butanol, t-amyl alcohol, 4-methyl-2-pentanol, and the like. Of them, t-butanol and t-amyl alcohol are preferred because they are bulky tertiary alcohols and can suppress side reactions, and because the monoalkyltin compound (A11) obtained is highly stable and has a high purity. In addition, it is even more preferable to react the raw material tin compound (B 11) having a dimethylamino group or a diethylamino group with a tertiary alcohol (t-butanol, t-amyl alcohol) as a reactant (M11) to synthesize a stable monoalkyltin compound (A11) having a t-butoxy group or a t-amyloxy group thanks to the synergistic effect of the combination of the raw material, reactant, and product. In this case, the effect of the production method of the present disclosure (conditions 1 to 3 above) is greater, and a highly pure synthetic tin compound (P11) can be obtained at the end of the reaction, or a synthetic tin compound (P11) containing less impurities of other metals can be obtained.

On the other hand, other components than the monoalkyltin compound A11 that are present in the synthetic tin compound (P11) are impurities. The content of impurities is the content obtained by subtracting the tin compound A11 from the synthetic tin compound (P11). In particular, the content of impurities having molecular weights and boiling points (boiling point difference of 10° C. or less) similar to that of the target compound, relative to the synthetic tin compound (P11), is preferably 2 mol % or lower, more preferably 1 mol % or lower, even more preferably 0.5 mol % or lower, and particularly preferably 0.3 mol % or lower. The lower the better, but the content is usually 0.01 mol % or more. Examples of compounds having similar boiling points include dialkyl tin compounds R^{2″″}₂Sn(OR^{2″})₂ (A21) and the like.

Molecular Weight Difference Between the Substituent R^{2″″} and Substituent OR^{2″} of the Monoalkyltin Compound (A11)

There is no particular restriction on the molecular weight difference between the substituent R^{2″″} and the substituent OR^{2″}, but it is preferably 50 or less, more preferably 30 or less, even more preferably 20 or less, particularly preferably 10 or less, and especially preferably 6 or less. The lower limit is 0.

By reducing the molecular weight difference between R^{2″″} and OR², the mass difference of various outgases generated when the tin compound is used as a resist tends to be reduced, and the condition setting in the EUV process tends to be easier. In addition, to control the EUV sensitivity and boiling point of the tin compound, the molecular weight difference may be adjusted by changing the substituents.

On the other hand, as described later, the smaller the difference in molecular weight between R^{2′″} and OR², the smaller the difference in molecular weight between the target tin compound (A11) and impurities, which may make purification more difficult.

### Purification Method of the Synthetic Tin Compound ((P1) or (P11))

In this embodiment, the synthetic tin compound ((P1) or (P11)) may be purified by distillation.

The synthetic tin compound ((P1) or (P11)) is distilled and purified, and the resulting product is called “purified tin composition (P2).”

The higher the ratio of the tin compound ((A1) or (A11)) in the purified tin composition (P2), the more improved the performance of the resist, so the purity of the tin compound ((A1) or (A11)) is preferably 96 mol % or higher, more preferably 97 mol % or higher, even more preferably 98 mol % or higher, particularly preferably 99% mol % or higher, especially preferably 99.2 mol % or higher, still more preferably 99.5 mol % or higher, especially more preferably 99.8 mol % or higher, and most preferably 99.9 mol % or higher.

On the other hand, if the purity of the triaminotin compound is too high, a disproportionation reaction of the substituent R² of the monoalkyltin compound (A1) (or the substituent R^{2″″} of A11) may cause decomposition or instability of the compound during storage or use. In such cases, the purity is preferably 100.9 mol % or lower, and more preferably 99.9 mol % or lower.

To be used as a resist material, preferably, the inorganic impurities in the purified tin composition (P2) are low. Specifically, it is preferable that inorganic impurity of each element is 10 mol ppm or less, more preferably 1 mol ppm or less, even more preferably 0.1 mol ppm or less, and particularly preferably 0.01 mol ppm or less. The lower limit is usually 0 mol ppm.

If the purified tin composition (P2) does not have the required quality, other purification treatments (filtration or column purification, adding an adsorbent or a reactant, etc.) may be carried out before or after the distillation.

### Distillation Method

The distillation of the synthetic tin compound (P1 or P11) in the production method of the present disclosure is not particularly limited but the distillation is intended to remove impurities having boiling points close to that of the tin compound (A1 or A11) while preventing decomposition of the tin compound to obtain the tin compound of a high purity. For this purpose, it is necessary to optimize the equipment and conditions involved in the distillation, and specific items to be considered include the following.

### Distillation Equipment and Conditions

Quality of the crude product (the synthetic tin compound) before the distillation: reaction conditions, post-treatment conditions, purity of the crude product (the synthetic tin compound), amount of metals contained, and amount of solvent contained
Distillation still (material, shape, capacity, heat transfer area, stirring blade, and stirring speed)
Distillation column (height, diameter, theoretical number of stages, shape and material of packing, separation performance, surface area, length, and time of stay in the column)
Distillation conditions: reflux ratio (cooling temperature and extraction time), extraction speed, cooking amount, temperature (external temperature, internal temperature), time (heating time, distillation time), degree of vacuum (degree of vacuum, and pressure loss)
Other equipment and conditions: fractional distillation method of the distillate, method and location for extracting the distillate, light shielding conditions, inert atmosphere, filling method, number of distillations, continuous distillation or batch distillation

### Distillation Equipment

The distillation equipment used in the purification method of the present disclosure is not limited as long as it is capable of purifying the tin compound by distillation and may include equipment having a heating device (distillation still, etc.), distillation purification equipment (simple distillation equipment, distillation column, cooling reflux device, fractional distillation equipment, etc.), and pressure reducing equipment (vacuum pump, etc.). It may also be preferable to separate the distillation fraction into a plurality of fractions. By separating into fractions (Fr), it is possible to analyze the purity of each fraction, and the tin compound of a higher purity may be obtained in a specific fraction.

### Simple Distillation

In the purification method of the present disclosure, purification by distillation may be performed in a simple distillation without fractional distillation. Simple distillation is preferable because it can be performed under high vacuum conditions with simple equipment and can obtain a fraction in a high yield with a quick operation. In particular, since the heating time during distillation is short, it is suitable for separating tin compounds that decompose during distillation. However, since the separation efficiency is low, it is difficult to separate impurities that have close boiling points or similar structures, and it is desired that the crude product before distillation has a high purity. In addition, a distillation column having a theoretical number of stages may be used to increase the separation efficiency, but in that case, the theoretical number of stages is preferably 5 or less. The lower limit is 1 stage or more.

### Distillation Still

The material (interior of the still and stirring blade) is not particularly limited, but it is preferably Teflon (registered trademark), glass, SUS, and the like. Among them, glass is preferred from the viewpoint of preventing metal contamination, and SUS is preferable from the viewpoint of strength and thermal conductivity.

The shape and capacity of the still can be set arbitrarily according to the desired distillation amount, but for efficient distillation, it is preferably 100 mL or more, more preferably 1 L or more. Depending on these, the surface area of the heat transfer part may change. The upper limit is usually 50 kL or less.

### Mixing Blade

Examples of the shape of the stirring blade include a paddle, anchor, twin star, ribbon, three-blade-sweeping-back, log bone, full zone, Maxblend, and the like. Of theme, a paddle, twin star, and three-blade-sweeping-back are preferred because they can stir with good strength whether the amount of liquid is large or small.

In addition, the stirring capacity may be improved by installing multiple stirring blades. When using a stirrer, it is preferable to use one that is large enough for the amount of reaction liquid.

### Stirring Speed (Rotation Speed)

The preferred stirring speed varies depending on the size and shape of the stirring blade but is preferably 50 rpm or more in terms of rotation speed (rpm, number of rotations per minute), more preferably 100 rpm or more, and further more preferably 150 rpm or more. If the stirring speed (rotation speed) is high, a thinner film can be dispersed in the distiller, so the distillation can be accelerated and the distillation time can be shortened. In addition, the diffusion will be increased in a solution that is heated, so the temperature fluctuation during distillation can be reduced and decomposition that takes place in the higher temperature part close to the jacket temperature can be prevented. Specifically, by increasing the stirring, it is possible to achieve distillation in a shorter time or at a lower temperature, and it is possible to obtain the tin compound (A1) of a high purity.

### Distillation Column

When the boiling point of the organotin compound (A1) is particularly close to the boiling points of the impurities and separation is difficult, preferably there are 5 stages or more, and more preferably 10 stages or more. On the other hand, if the theoretical number of stages is too large, remember that the distillation takes time, and as a result, decomposition of the organotin compound (A1) may be promoted, and the distillation rate may decrease, resulting in decreased productivity. The lower limit is 1 stage or more.

It shall also be considered that the larger the theoretical number of stages of the distillation column, the larger the distillation equipment, and therefore the likely higher equipment cost.

From the viewpoint of equipment cost, preferably the theoretical number of stages is on the small side within the range that satisfies the required distillation capacity.

The packing and structure in the distillation column are not particularly limited, but to increase the theoretical number of stages and reduce the pressure loss, a structure packed with structured packing is preferred. The packing material is preferably glass or SUS. The HETP (m/stage) of the packing under distillation conditions is preferably 1.0 or lower, more preferably 0.8 or lower, even more preferably 0.5 or lower, and particularly preferably 0.3 or lower. The lower limit is 0. A low HETP can reduce the pressure loss, reduce the height of the distillation column to shorten the distillation time, achieve distillation at a lower temperature, and allow the tin compound (A1) of a high purity to be obtained.

### Distillation Conditions

The conditions for distillation are described below. Regarding the conditions for distillation, individual equipment and suitable conditions may be combined to obtain the organotin compound (A1) with a higher purity. Furthermore, by combining specific distillation equipment and distillation conditions, a synergistic effect may be obtained, resulting in higher purification efficiency and higher productivity.

### Reflux Ratio

Although the distillation may be performed without controlling the reflux ratio, proper control of the reflux ratio can improve separation efficiency and shorten the distillation time. The method for controlling the reflux ratio is not particularly limited, and it can be controlling the time for opening/closing the extracting port, controlling the reflux/distillate flow rate, etc. Here, for example, “reflux ratio 10” means that the extracting amount and the reflux amount are controlled at a ratio of 1:10. The lower limit of the reflux ratio is preferably 0.1 or greater, more preferably 1 or greater, and even more preferably 3 or greater. If the reflux ratio is below the lower limit, the distillation efficiency is not good and substances with similar boiling points are mixed into the target fraction, and the purification effect may not be obtained. The upper limit of the reflux ratio is preferably 200 or lower, more preferably 150 or lower, and even more preferably 100 or lower. If the reflux ratio is above the upper limit, the distillation time needs to be extended, which will accelerate the decomposition of the tin compound or the distillation rate will decrease, leading to poor productivity.

### Distillation Time

The distillation time is not limited by the scale or equipment of the distillation but it is preferably short within a range in which appropriate productivity can be ensured, and is usually 200 h or less, more preferably 100 h or less, and even more preferably 50 h or less. The lower limit of the distillation time is preferably 1 h or more, and more preferably 10 h or more. The distillation time refers to the time during which the target conditions are reached and the distillation is performed. The heating time is also preferably short within a range in which appropriate productivity can be ensured and is usually 200 h or less, preferably 100 h or less, and more preferably 50 h or less.

### Distillation Temperature

The distillation temperature used in the purification method refers to the internal temperature during distillation, that is, the temperature of the solution in the distiller. The distillation temperature depends on the boiling point of the target product and other distillation conditions, but the lower limit is preferably 20° C. or higher, more preferably 30° C. or higher, and even more preferably 50° C. or higher. The upper limit is preferably 200° C. or lower, more preferably 180° C. or lower, and even more preferably 150° C. or lower. If the distillation temperature is too high, the decomposition of the tin compound (A1) tends to be accelerated, or the distilled amount may be too large, causing flooding in the distillation column and failure to obtain satisfactory separation. If the distillation temperature is too low, the amount of distillation will be too small, so the distillation will take a long time, which will accelerate the decomposition, and reduce the separation performance of the distillation column.

In addition to the distillation temperature (internal temperature), temperatures at various locations, such as the jacket temperature (heat medium temperature) and the column top temperature of the distillation column may also affect the decomposition rate of the organotin compound (A1).

### Cooling Condenser Temperature

In some non-limiting examples, the cooling temperature by the cooling condenser at the top of the distillation column is preferably not higher than the boiling point of the organotin compound (A1), and more preferably 10 to 70° C. lower than the boiling point of the organotin compound (A1).

In some non-limiting examples, the temperature difference between the cooling temperature of the condenser and the boiling point of the organotin compound (A1) is preferably within 50° C., more preferably within 30° C., and even more preferably within 10° C. If too much cooling may cause the tin compound to precipitate in the distillation column, or the still may be cooled as well, requiring a higher jacket temperature.

### Pressure During Distillation (Degree of Vacuum)

The distillation in the purification method is basically carried out under reduced pressure conditions because the boiling point of the tin compound (A1) at normal pressure is high. The pressure at this time is preferably as low as possible so that the distillation can be carried out at as low a temperature as possible without causing decomposition of the tin compound A1. Specifically, the pressure is preferably 100 torr or lower, more preferably 50 torr or lower, even more preferably 20 torr or lower, particularly preferably 15 torr or lower, particularly preferably 10 torr or lower, and particularly preferably 5 torr or lower. On the other hand, under conditions requiring particularly high separation ability or conditions for an increased scale, and depending on the performance of the vacuum pump and the pressure loss of the distillation column, the pressure is preferably 0.01 torr or higher, more preferably 0.1 torr or higher, and further preferably 1 torr or higher.

### Total Reflux Conditions

The state, in which all the cocks are closed and all the distillate is refluxed without any distillation extraction, is called “total reflux”. Before starting the distillation, heating may be done under total reflux conditions before various distillation conditions are stabilized. The total reflux time is preferably 20 h or less, more preferably 10 h or less, further preferably 8 h or less, and particularly preferably 5 h or less. If the total reflux time is too long, decomposition tends to be accelerated. On the other hand, as the scale of distillation increases, the time required to fill the distillation column with the liquid and reach the appropriate distillation conditions increases, so if the time is too short, the efficiency of separation by distillation may be lowered. In that case, the lower limit of total reflux time is preferably 1 h or more, and more preferably 3 h or more.

### Distillation Rate

The distillation rate in this purification method is a rate based on the distillation ratio expressed by:

$$Distillation ratio [ \% ] = Extracted mass [ g ] / fed mass [ g ] \times 100$$

$$Distillation rate [ \% / h ] = Extracting ratio [ \% ] / extracting time [ h ]$$

The extracting time refers to the time during which distillation is taking place and does not include the time when the distillate amount is zero or the holding time under total reflux conditions. The distillation rate can be calculated from the total distillate amount during the distillation and the distillation time, but it can also be calculated from the distillation time and distillate amount of each fraction.

The distillation rate (%/h) is preferably 1 or higher, more preferably 2 or higher, even more preferably 3 or higher, particularly preferably 4 or higher, and especially preferably 5 or higher. If the distillation rate is too low, the distillation time will be long, decomposition will occur during distillation, and the purity of the obtained fraction tends to decrease. Also, from the viewpoint of distillation productivity, a high distillation rate is preferred. On the other hand, if the distillation rate is too high, the solution will accumulate too much in the distillation column, causing flapping and making the separation difficult.

### Mode of Distillation

In the purification method of the present disclosure, the distillation mode and the configuration of the device are not particularly limited. For example, both batch distillation and continuous distillation are applicable distillation modes. However, batch distillation is preferred from the viewpoint of recovering high-purity fractions, and continuous distillation may be preferred from the viewpoint of yield. In addition, for efficient purification, distillation may be performed multiple times or multiple distillation equipment may be combined. In addition, the feeding position of the distillate or the extracting position of the distillate may be changed.

### Other Distillation Conditions

Since the tin compound (A1) is unstable when exposed to water and air, preferably the distillation operation and the fraction filling operation are performed under an inert atmosphere. Specifically, when recovering a fraction, preferably it is collected into a connected container under an inert gas atmosphere. Further, preferably it is transferred to another container under an inert gas atmosphere. Similarly, it is also preferable to carry out sampling and analysis under an inert gas atmosphere.

The tin compound (A1) may be unstable when exposed to light. To shield from light, an SUS device may be used for all parts, such as the still, distillation column, and fractions, or a light-shielded glass device (e.g., amber glass or glass device shielded from the surroundings) may be used. In addition, the light shielding method is not particularly limited, and any technique known in the art can be used, such as enclosing the equipment in a light-shielding cover such as cloth, foil, or film, using a light-shielding coating, conducting distillation in a dark room, etc.

The synthetic tin composition (P1) obtained by the production method of the present disclosure and/or the purified tin composition (P2) obtained by this purification method of the present disclosure can maintain high purity for a long period of time, so they can be kept in a container and are particularly suitable for storage and/or transportation.

The synthetic tin composition (P1) and/or the purified tin composition (P2) can be stored for a short time or a long time, such as from about 3 days to about 1 year, under conditions of substantially no exposure to light and temperatures of no higher than about 30° C. For example, it can be stored for a period from about 1 week to about 10 months, from about 2 weeks to about 6 weeks, and for any period desired.

The storage temperature of the synthetic tin composition (P1) and/or the purified tin composition (P2) is preferably about 30° C. or lower, more preferably about 25° C. or lower, and even more preferably about 20° C. or lower. The lower limit of the storage temperature is preferably not lower than about −10° C.

By “substantially no exposure to light” it means that the purified tin composition is protected from light as much as possible by, for example, storing it in an amber or stainless-steel container. In this embodiment, the synthetic tin composition (P1) and/or the purified tin composition (P2) is substantially not decomposed after a storage period from about 3 days to about 1 year, as described above.

### Application of the Tin Compound A1: Resist Material

The synthetic tin composition (P1) obtained by the present production method and/or the purified tin composition (P2) obtained by the present purification method (hereinafter, they may be referred to as the “synthetic/purified tin composition”) contain the tin compound (A1) of a high purity, so they are useful as materials for EUV resists, etc. Its use as a resist material is described below.

### Solution

The synthetic/purified tin composition of the present disclosure may further contain a solvent as necessary. To facilitate application/deposition of the synthetic/purified tin composition of the present disclosure as a resist material, it is preferable to dilute it with a solvent before use. The solvent is not particularly limited but is preferably, for example, an organic solvent such as an alcohol, ether, ketone, amide, or ester, and more preferably an alcohol solvent. These solvents can be used alone or two or more of them can be used in combination.

The alcohol-based solvent may be, for example, an aliphatic or alicyclic alcohol, and it may be a monoalcohol or a polyhydric alcohol, and a combined polyhydric alcohol and ether solvent, and the like can also be used. The number of carbon atoms of the solvent is not particularly limited and may be, for example, 2-18.

Preferably, the solvent itself does not contribute to metal contaminants.

The amount of the solvent used relative to the synthetic/purified tin composition is preferably 0.01-30 parts by mass, more preferably 1-20 parts by mass, and especially preferably 1-10 parts by mass.

Tin Compounds after Hydrolysis

The synthetic tin composition and the purified tin composition may be used as a resist material after undergoing a reaction such as hydrolysis. The method of using it as a resist material may be, for example, the method disclosed in the Japanese Patent Publication No. 2021-21953. The tin compound contains a group that can be hydrolyzed by water or other suitable reagent under appropriate conditions to form an alkyltin-oxo-hydroxo patterning composition that can be represented by the formula R²SnO_{(3/2-x/2)}(OH)ₓ(wherein 0<x≤3). The hydrolysis and condensation reactions that can change the compound into the composition by the hydrolyzable group (X²) are shown in the following reactions.

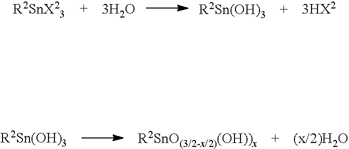

The tin compound represented by the formula R²SnO_{(3/2-X/2)}(OH)_{X}, obtained by hydrolysis of the tin compound (A1) (or a composition containing the tin compound A1) as a raw material, is referred to as the “tin hydrolyzate (P3)” below. The tin hydrolyzate (P3) can be used as an EUV resist material.

The method for hydrolyzing the tin compound (A1) (or a composition containing the tin compound A1) to obtain the tin hydrolyzate (P3), may be, for example, a method of reacting water vapor, etc., with the vapor generated by volatilizing the tin compound (A1) (or a composition containing the tin compound A1) under heating or reduced pressure, or with a substrate on which the tin composition has been deposited. In this method, a thin film containing the tin hydrolyzate (P3) can be formed on a thin film substrate.

In addition, there is a method in which the tin compound (A1) (or a composition containing the tin compound A1) is made to react with water or the like while in a solution or solid state to carry out hydrolysis, thereby obtaining a tin hydrolyzate (P3).

The tin hydrolyzate (P3) can then be dissolved in an organic solvent or the like for use as a coating solution.

This solution can be applied to a substrate by any coating or printing technique to form a thin film (coating film) containing the tin hydrolysate (P3) the substrate.

The film obtained by any of the above methods may be dried, heated, etc., to stabilize or partially condense it prior to exposure to light. Generally, the film is thin, e.g., having an average thickness of no more than 10 microns, although very thin submicron films, e.g., a thickness of about 100 nanometers (nm) or less, even 50 nm or less, and especially 30 nm or less, may be desired for patterning very small features. The resulting film may be referred to as a “resist” since portions of the composition are resistant to development/etching after they have undergone a treatment by exposure to light.

The thin film can be exposed in a selected pattern or the negative portions of the pattern of the film can be exposed to suitable radiation, e.g., extreme ultraviolet, electron beam, or ultraviolet to form a latent image with developer-resistant regions and developer-soluble regions. After exposure to suitable radiation and prior to development, the thin film can be made to react by heating or another method to differentiate the latent image from non-irradiated regions. The latent image is brought into contact with a developer so that a physical image is formed to obtain a patterned thin film. The patterned thin film can be further heated to stabilize the remaining film on the surface after the patterning. The patterned thin film can be used as a physical mask to perform further processing, e.g., etching the substrate and/or depositing additional materials according to the pattern. After using the patterned resist as desired, the remaining patterned thin film can be removed at an appropriate point of time in processing, but the patterned thin film can also be incorporated into the final structure.

Additional Methods of Producing Organotin Compounds with High Purity

Further aspects of the disclosure relate to a production method of an organotin compound with improved purity of the monoalkyltin compound. The use of additives with more selective reactivity with or adsorption to impurities that cause problems in distillation purification and the conditions for the use has been considered, and resulted in the improved methods described herein.

These aspects of the present disclosure include the following features.

[1]A production method of an organotin compound, comprising
mixing a crude product containing an organotin compound (a1) represented by the following formula (a1) with the following additive (b1), and
recovering said organotin compound (a1) having a purity of 95 mol % or more by distillation of the mixture (x1) containing said crude product and said additive (b1).

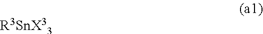

In the formula (a1), R³ is a hydrocarbon group having 1-30 carbon atoms, which may be substituted with a halogen atom, an oxygen atom, or a nitrogen atom, each X³ is independently OR^{3′} or NR^{3′}₂, R^{3′} is a hydrocarbon group having from 1 to 30 carbon atoms, which may be substituted with a halogen atom, an oxygen atom, or a nitrogen atom, the three R³'s may be the same or different from each other, and R³ and R^{3′} may be bonded together to form a cyclic structure.

### Additive (b1):

A hydrocarbon compound having 2 to 20 carbon atoms, which has either a nitrogen atom or an oxygen atom or both and satisfies the following condition (1a) and condition (2):

Condition (1a): When the number of nitrogen atoms in said hydrocarbon compound is m and the number of oxygen atoms is n, m is 0, 1, 2, or 3, n is 0, 1, 2, or 3, and m+n is 2 or 3.

Condition (2): In the hydrocarbon compound, when the number of nitrogen atoms among the m nitrogen atoms that are bonded to a hydrogen atom is x and the number of oxygen atoms the among n oxygen atoms that are bonded to a hydrogen atom is y, x+y is 1 or more.

[2] The production method according to [1], wherein said additive (bi) has a nitrogen atom and m is 1, 2 or 3._{•}

[3] The production method according to [1] or [2], wherein said additive (b1) has an oxygen atom and n is 1, 2 or 3.

[4] The production method according to any one of [1] to [3], where m+n is 3.

[5] The production method according to any one of [1] to [5], wherein the hydrocarbon compound is an aliphatic hydrocarbon compound.

[6] The production method according to any one of [1] to [5], wherein the hydrocarbon compound is an aliphatic saturated hydrocarbon compound.

[7] The production method according to any one of [1] to [6], wherein the content of said additive (b1) in said mixture (x1) is 50-1000 mol % when the content of the organotin compound (a3) represented by the following formula (a3) is 100 mol %.

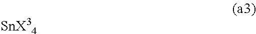

In the formula (a3), each X³ is independently OR^{3′} or NR^{3′}₂ and the two R³'s may be the same or different from each other.

[8] The production method according to any one of [1] to [7], wherein the purity of said additive (b1) is 98% or higher.

[9] The production method according to any one of [1] to [8], further comprising filtering said mixture (x1) prior to said distillation.

[10]A method production of an organotin compound, comprising
mixing a crude product containing an organotin compound (a1) represented by the following formula (a1) and the following additive (b2), wherein the content of said additive (b2) in said mixture (x2) is 150-1000 mol % when the content of the organotin compound (a3) represented by the following formula (a3) is 100 mol %.

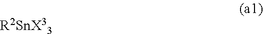

In the formula (a1), R³ is a hydrocarbon group having 1-30 carbon atoms, which may be substituted with a halogen atom, an oxygen atom, or a nitrogen atom, each X³ is independently OR^{3′} or NR^{3′}₂, R^{3′} is a hydrocarbon group having 1-30 carbon atoms, which may be substituted with a halogen atom, an oxygen atom, or a nitrogen atom, the three R³'s may be the same or different, and R³ and R^{3′} may be bonded to each other to form a cyclic structure.

### Additive (b2):

A hydrocarbon compound having 2-20 carbon atoms, which has either a nitrogen atom or an oxygen atom or both, and satisfies the following conditions (1b) and (2):

Condition (1b): When the number of nitrogen atoms in the hydrocarbon compound is m and the number of oxygen atoms is n, m is 0, 1, 2, 3, 4 or 5; n is 0, 1, 2, 3, 4 or 5; and m+n is 2, 3, 4, 5, 6, 7, 8, 9 or 10.

Condition (2): In the hydrocarbon compound, when the number of nitrogen atoms among the m nitrogen atoms that are bonded to a hydrogen atom is x and the number of oxygen atoms among the n oxygen atoms that are bonded to a hydrogen atom is y, x+y is 1 or more.

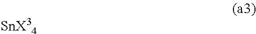

In the formula (a3), each X³ is independently OR^{3′} or NR^{3′}₂, R^{3′} is a hydrocarbon group having 1-30 carbon atoms, which may be substituted with a halogen atom, an oxygen atom, or a nitrogen atom, and the three R³'s may be the same or different from each other.

[11]A production method of an organotin compound, comprising
mixing a crude product containing an organotin compound (a1) represented by the following formula (a1) with the following additive (b2), and
recovering said organotin compound (a1) with a purity of 95 mol % or more by distillation of the mixture (x2) containing said crude product and said additive (b2) wherein
the content of said additive (b2) in said mixture (x2) is 150-1000 mol % when the content of the organotin compound (a3) represented by the following formula (a3) is 100 mol %.

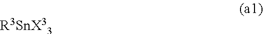

In the formula (a1), R³ is a hydrocarbon group having 1-30 carbon atoms, which may be substituted with a halogen atom, an oxygen atom, or a nitrogen atom, each X³ is ndependently OR^{3′} or NR^{3′}₂, R^{3′} is a hydrocarbon group having 1-30 carbon atoms, which may be substituted with a halogen atom, an oxygen atom, or a nitrogen atom, the three R³'s may be the same or different, and R³ and R^{3′} may be bonded to each other to form a cyclic structure.

### Additive (b2):

A hydrocarbon compound having 2-20 carbon atoms, which has either a nitrogen atom or an oxygen atom or both and satisfies the following conditions (1b) and (2):

Condition (1b): When the number of nitrogen atoms in said hydrocarbon compound is m and the number of oxygen atoms is n, m is 0, 1, 2, 3, 4 or 5, n is 0, 1, 2, 3, 4 or 5, and m+n is 2, 3, 4, 5, 6, 7, 8, 9, or 10.

Condition (2): In the hydrocarbon compound, when the number of nitrogen atoms the among m nitrogen atoms that are bonded to a hydrogen atom is x and the number of oxygen atoms among the n oxygen atoms that are bonded to a hydrogen atom is y, x+y is 1 or more.

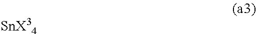

In the formula (a3), each X³ is independently OR^{3′} or NR^{3′}₂, R^{3′} is a hydrocarbon group having 1-30 carbon atoms, which may be substituted with a halogen atom, an oxygen atom, or a nitrogen atom, the three R³'s may be the same or different from each other.

[12] The production method according to [10] or [11], wherein the content of said additive (b2) is 200 to 500 mol % when the content of said organotin compound (a3) is 100 mol %.

[13]m is 0, 1, 2, or 3, n is 0, 1, 2, or 3, m+n is 2 or 3, and x+y is 1 or more, and the method of production is described in [10] to [12].

[14] The production method according to any of [10] to [13], wherein said additive (b2) has a nitrogen atom and m is 1, 2, or 3.

[15] The production method according to any of [10] to [14], wherein said additive (b2) has an oxygen atom and n is 1, 2, or 3.

[16] The production method described in any of [10] to [15], where m+n is 3.

[17] The production method according to any one of [10] to [16], wherein the hydrocarbon compound is an aliphatic hydrocarbon compound.

[18] The production method according to any one of [10] to [17], wherein the hydrocarbon compound is an aliphatic saturated hydrocarbon compound.

[19] The production method according to any one of [10] to [18], wherein the purity of the additive (b2) is 98% or more.

[20] The production method according to any one of [10] to [19] further comprises filtering the mixture (x2) before the distillation.

[21]A production method of an organotin compound, comprising
mixing a crude product containing an organotin compound (a1) represented by the following formula (a1) with the following additive (b3), and
recovering the organotin compound (a1) having a purity of 95 mol % or more by distillation of the mixture (x3) containing the crude product and the additive (b3).

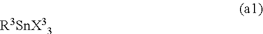

In the formula (a1), R³ is a hydrocarbon group having 1-30 carbon atoms, which may be substituted with a halogen atom, an oxygen atom, or a nitrogen atom, each X³ is independently OR^{3′} or NR^{3′}₂, R^{3′} is a hydrocarbon group having 1-30 carbon atoms, which may be substituted with a halogen atom, an oxygen atom, or a nitrogen atom, the three R³'s may be the same or different, and R³ and R^{3′} may be bonded to each other to form a cyclic structure.

Additive (b3): a polymer resin containing sulfur atoms.

[22] The production method according to [21], wherein the purity of the additive (b3) is 98% or higher.

[23] The production method according to [21] or [22], further comprises filtering the mixture (x3) before the distillation.

[24]A production method of an organotin compound, comprising: mixing a crude product containing an organotin compound (a1) represented by the following formula (a1), an additive (b2), and an organic solvent and recovering the organotin compound (a1) having a purity of 95 mol % or higher by distilling a mixture (x4) containing the crude product, the additive (b2), and the organic solvent, wherein the content of the organic solvent in the mixture (x4) is 100 parts by mass or more when the content of the additive (b2) is taken as 100 parts by mass.

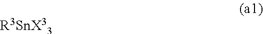

In the formula (a1), R³ is a hydrocarbon group having 1-30 carbon atoms, which may be substituted with a halogen atom, an oxygen atom, or a nitrogen atom, each X³ is independently OR^{3′} or NR^{3′}₂, R^{3′} is a hydrocarbon group having 1-30 carbon atoms, which may be substituted with a halogen atom, an oxygen atom, or a nitrogen atom, the three R³'s may be the same or different, and R³ and R^{3′} may be bonded to each other to form a cyclic structure.

### Additive (b2):

A hydrocarbon compound having 2-20 carbon atoms, containing either or both of a nitrogen atom and an oxygen atom, and satisfying the following condition (1b) and condition (2).

Condition (1b): When the number of nitrogen atoms in the hydrocarbon compound is m and the number of oxygen atoms is n, m is 0, 1, 2, 3, 4 or 5; n is 0, 1, 2, 3, 4 or 5; and m+n is 2, 3, 4, 5, 6, 7, 8, 9 or 10.

Condition (2): In the hydrocarbon compound, when the number of nitrogen atoms among the m nitrogen atoms that are bonded to a hydrogen atom is defined as x and the number of oxygen atoms among the n oxygen atoms that are bonded to a hydrogen atom is defined as y, x+y is 1 or more.

[25] The production method according to [24] wherein the solubility of said organotin compound (a1) in said organic solvent at 20° C. is 10% or more by mass, and the solubility of said additive (b2) in said organic solvent at 20° C. is 10% or more by mass.

[26] The production method according to [24] or [25], wherein at least 50% by mass of the organic solvent is an ether-based solvent.

[27] The production method according to any one of [24] to [26], wherein the water content of the organic solvent is 100 ppm or less by weight.

[28] The production method according to any one of [24] to [27], wherein the mixture (x4) is prepared by stirring to mix a premix of the organic solvent and the additive (b2) with the crude product.

[29] The production method according to any one of [24] to [28], wherein m is 0, 1, 2 or 3, n is 0, 1, 2 or 3, and m+n is 2 or 3, and

x+y is 1 or more.

[30] The production method is according to any one of [24] to [29], wherein the additive (b2) has a nitrogen atom and m is 1, 2, or 3.

[31] The production method according to any one of [24] to [30], wherein the additive (b2) has an oxygen atom and n is 1, 2, or 3.

[32] The production method according to any one of [24] to [31], wherein m+n is 3.

[33] The production method according to any one of [24] to [32], wherein the hydrocarbon compound is an aliphatic hydrocarbon compound.

[34] The production method according to any one of [24] to [33], wherein the hydrocarbon compound is an aliphatic saturated hydrocarbon compound.

[35] The production method according to any one of [24] to [34], wherein the purity of the additive (b2) is 98% or more.

[36] The production method according to any one of [24] to [35], further comprises filtering the mixture (x4) before the distillation.

[37] The production method according to any one of [1] to [36], wherein the distillation time is 1 to 20 hours.

[38] The production method according to any one of [1] to [37], wherein the molecular weight difference between R³ and X³ in the organotin compound (a1) is 50 or less.

[39] The production method according to any one of [1] to [23], wherein an organic solvent may be used during the distillation and the water content of the organic solvent is 100 ppm or less by weight.

[40] The production method according to any one of [1] to [39], wherein the crude product containing the organotin compound (a1) is mixed with the additive (bi) or (b2) and then held for 1 hour or longer.

[41] The production method according to any one of [1] to [40], wherein the stirring speed when mixing the crude product containing the organotin compound (a1) with the additive (b1) or (b2) is 50 rpm or higher.

[42] The production method according to any one of [1] to [41], wherein the crude product containing the organotin compound (a1) is mixed with the additive (bi) or (b2) and the distillation is carried out under light-shielded conditions.

[43] The production method according to any one of [1] to [42], further comprises filling the organotin compound (a1) into a storage container under an inert atmosphere after said distillation.

[44] The production method according to any one of [1] to [43], wherein the content of the organotin compound (a2) represented by the following formula (a2) after said distillation is 3 mol % or less in terms of tin atom weight.

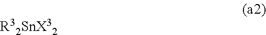

In formula (a2), R³ is a hydrocarbon group having 1-30 carbon atoms, which may be substituted with a halogen atom, an oxygen atom, or a nitrogen atom, each X³ is independently OR^{3′} or NR^{3′}₂, and the two R³'s may be the same or different.

[45] The production method according to any one of [1] to [44], wherein the content of the organotin compound (a3) represented by the following formula (a3) after said distillation is 3 mol % or less in terms of tin atom weight.

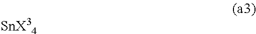

In the formula (a3), each X³ is independently OR^{3′} or NR^{3′}₂, R^{3′} is a hydrocarbon group having 1-30 carbon atoms, which may be substituted with a halogen atom, an oxygen atom, or a nitrogen atom, the three R³'s may be the same or different from each other.

[46] The production method according to any one of [1] to [45], wherein the content of the organotin compound (a4) represented by the following formula (a4) after said distillation is 3 mol % or less in terms of tin atom weight.

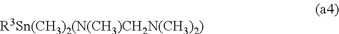

### Definition of Terms

The disclosure of “Y to Z” (Y and Z are any numbers) includes, unless otherwise specified, the meaning of “Y or more but no more than Z”, as well as the meaning of “preferably greater than Y” and “preferably smaller than Z”.

The disclosure of “Y or more” (Y is any number) includes the meaning of “Y or more” as well as “preferably greater than Y”. Similarly, the disclosure of “Z or less” (Z is any number) includes the meaning of “Z or less” as well as “preferably less than Z”.

“y and/or z (y and z are arbitrary structures or components)” means “y only”, “z only”, or “y and z”.

An “organotin compound” means a compound having at least a tin atom, a carbon atom, a hydrogen atom, and a C—H bond in its molecule.

A composition containing an unpurified monoalkyltin compound may be referred to as a “crude product.”

A tin compound purified by the production method of an organotin compound may be referred to as a “purified tin compound.”

### Contents of Disclosure

Hereinafter, some non-limiting examples of embodiments related to the production method of an organotin compound will be described. The present disclosure is not limited to the embodiments described below.

In some non-limiting examples, the production method of an organotin compound comprises:
(a) mixing a crude product containing an organotin compound (a1) represented by the following formula (a1) with an additive (b1) described below, and
(b) recovering the organotin compound (a1) having a purity of 95 mol % or more by filtering, adsorbing, decantation, distilling and possibly other processing of a mixture (x1) containing the crude product and the additive (b1).

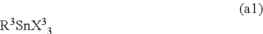

In the formula (a1), R³ is a hydrocarbon group having 1-30 carbon atoms, which may be substituted with a halogen atom, an oxygen atom, or a nitrogen atom, each X³ is independently OR^{3′} or NR^{3′}₂, R^{3′} is a hydrocarbon group having 1-30 carbon atoms, which may be substituted with a halogen atom, an oxygen atom, or a nitrogen atom, the three R³'s may be the same or different, and R³ and R^{3′} may be bonded to each other to form a cyclic structure.

Additive (b1) is a hydrocarbon compound having 2-20 carbon atoms, containing either or both of a nitrogen atom and an oxygen atom, and satisfying the following condition (1a) and condition (2):

Condition (1a): When the number of nitrogen atoms in the hydrocarbon compound is m and the number of oxygen atoms is n, m is 0, 1, 2 or 3, n is 0, 1, 2 or 3, and m+n is 2 or 3.

Condition (2): In the hydrocarbon compound, when the number of nitrogen atoms among the m nitrogen atoms to which a hydrogen atom is bonded is x and the number of oxygen atoms among the n oxygen atoms to which a hydrogen atom is bonded is y, x+y is 1 or more.

In some other non-limiting examples, a production method of an organotin compound comprises:
(a) mixing a crude product containing the organotin compound (a1) represented by the formula (a1) with the additive (b2) described below, and
(b) recovering the organotin compound (a1) having a purity of 95 mol % or more by filtering, adsorbing, decantation, distilling, and possibly other processing of a mixture (x2) containing the crude product and the additive (b2). In some of the non-limiting examples, the content of the additive (b2) in the mixture (x2) is 150 to 1000 mol % when the content of the organotin compound (a3) represented by the formula (a3) below is taken as 100 mol %.

Additive (b2) is a hydrocarbon compound having 2-20 carbon atoms, containing either or both of a nitrogen atom and an oxygen atom, and satisfying the following conditions (1b) and (2).

Condition (1b): When the number of nitrogen atoms in the hydrocarbon compound is m and the number of oxygen atoms is n, m is 0, 1, 2, 3, 4 or 5; n is 0, 1, 2, 3, 4 or 5; and m+n is 2, 3, 4, 5, 6, 7, 8, 9 or 10.

Condition (2): In the hydrocarbon compound, when the number of nitrogen atoms among the m nitrogen atoms that are bonded to a hydrogen atom is defined as x and the number of oxygen atoms among the n oxygen atoms that are bonded to a hydrogen atom is defined as y, x+y is 1 or more.

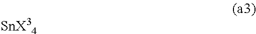

In the formula (a3), each X³ is independently OR^{3′} or NR^{3′}₂, wherein R^{3′} is a hydrocarbon group having 1-30 carbon atoms, which may be substituted with a halogen atom, an oxygen atom, or a nitrogen atom, and the four R³'s may be the same or different from each other.

In still other non-limiting examples, the production method of an organotin compound comprises:
(a) mixing a crude product containing the organotin compound (a1) represented by the formula (a1) with the additive (b3) described below, and
(b) recovering the organotin compound (a1) having a purity of 95 mol % or more by filtering, adsorbing, decanting, distilling, and possibly other processing of a mixture (x3) containing the crude product and the additive (b3). In some of the non-limiting examples, the additive (b3) is a weakly acidic polymer or a weakly basic polymer. Specifically, it is a polymer resin having a carboxyl group, an amino group, a hydroxyl group, or a sulfur atom.

In still other non-limiting examples, a production method of an organotin compound comprises:
(a) mixing a crude product containing the organotin compound (a1) represented by the formula (a1), the additive (b2), and an organic solvent, and
(b) recovering the organotin compound (a1) having a purity of 95 mol % or more by filtering, adsorbing, decanting, distilling, and possibly other processing of a mixture (x4) containing the crude product, the additive (b2), and the organic solvent. In some non-limiting examples, the content of the organic solvent in the mixture (x4) is 100 parts by mass or more relative to 100 parts by mass of the additive (b2).

### Crude Product

The crude product is a composition used for the purification of the organotin compound (a1) represented by the above formula (a1) in the production method of the organotin compound. The crude product contains the organotin compound (a1) as a main component.

The main component here is a component that has a great effect on the properties of the target substance. The content of the main component, excluding non-reactive solid components and volatile components of the solvent, is usually 50% by mass or more of the target substance, preferably 55% by mass or more, more preferably 60% by mass or more, even more preferably 70% by mass or more, and particularly preferably 80% by mass. The content of the organotin compound (a1) in the crude product is usually less than 95% by mass.

In addition to the aforementioned organotin compound (a1), the crude product further contains other organotin compounds as impurities. The other organotin compounds include, for example, impurities contained in the raw material of the organotin compound, byproducts in the synthesis process, and decomposition products generated in the storage process.

In some non-limiting examples, a high-purity organotin compound (a1) having a purity of 95 mol % or more can be purified and recovered by distillation of a crude product containing the organotin compound (a1) as a main component.

### Organotin Compound (a1)

The organotin compound (a1), which is the target compound of the purification of the embodiment, has one organic group bonded to tetravalent tin and three reactive substituents bonded to tetravalent tin that are capable of hydrolysis reactions. The organotin compound (a1) is specifically represented by the above formula (a1).

In the formula (a1), R³ is a hydrocarbon group having 1-30 carbon atoms, which may be substituted with a halogen atom, an oxygen atom, or a nitrogen atom. Considering the efficiency of R³ desorption during EUV exposure and the efficiency of vaporization of components generated by the desorption of R³, the upper limit of the number of carbon atoms in R³ is 30 or less, preferably 20 or less, and more preferably 10 or less. Considering the stability of the components generated by the elimination of R³, the lower limit of the number of carbon atoms in R³ is 1 or more, preferably 2 or more, and more preferably 3 or more.

The hydrocarbon group of R³ may be linear, branched, or cyclic. The hydrocarbon group of R³ may be a saturated hydrocarbon group or an unsaturated hydrocarbon group. The hydrocarbon group of R³ may be an aliphatic hydrocarbon group or an aromatic hydrocarbon group.

Examples of the halogen atom in the hydrocarbon group of R³ that may be substituted include a chlorine atom, a fluorine atom, a bromine atom, and an iodine atom. R³ having a heteroatom as a substituent has a higher decomposition capacity with respect to EUV light, and therefore the resistivity, such as sensitivity, may be improved.

Some non-limiting examples of R³ include alkyl groups such as methyl, ethyl, propyl, isopropyl, butyl, isobutyl, sec-butyl, t-butyl, pentyl, hexyl, cyclopentyl, cyclohexyl, and 1-methylcyclopentyl; aryl groups such as phenyl, tolyl, and naphthyl; aralkyl groups such as benzyl, phenethyl, α-methylbenzyl, and 2-phenyl-2-propyl; alkenyl groups such as vinyl, 1-propenyl, allyl, 2-butenyl, 3-butenyl, and 1-cyclopentenyl; alkynyl groups such as ethynyl and 2-propynyl; and alkyl groups substituted with a halogen atom such as 2-fluoroethyl and 2-iodoethyl.

Some non-limiting examples of R³ include the following compounds. In the following chemical formula, Rₐ and R_{b} are organic groups having 1-10 carbon atoms, wherein the carbon atom may be substituted with a heteroatom such as a halogen, an oxygen atom, or a nitrogen atom. The substituent A on the aromatic ring is an organic substituent having a halogen atom, an oxygen atom, or a nitrogen atom having 1 to 10 carbon atoms.

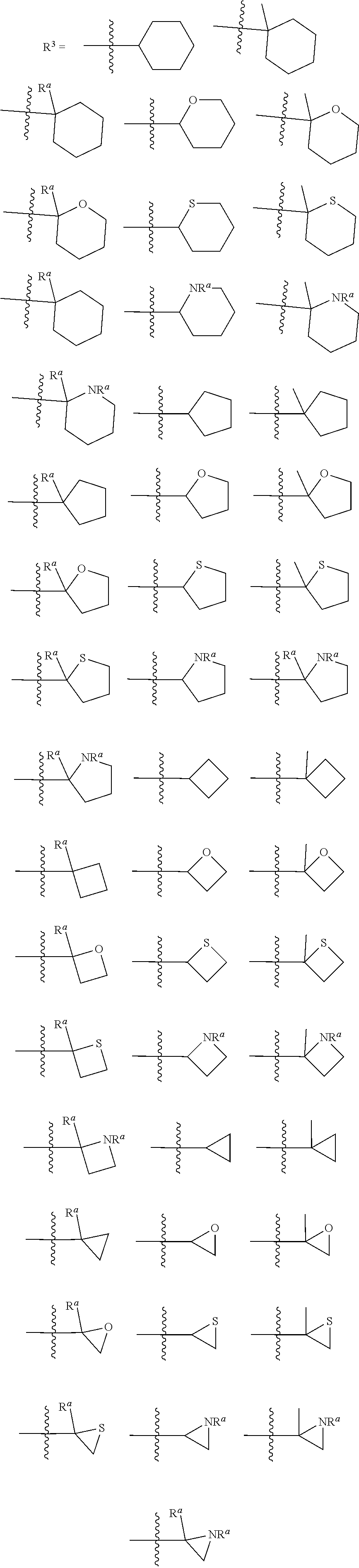

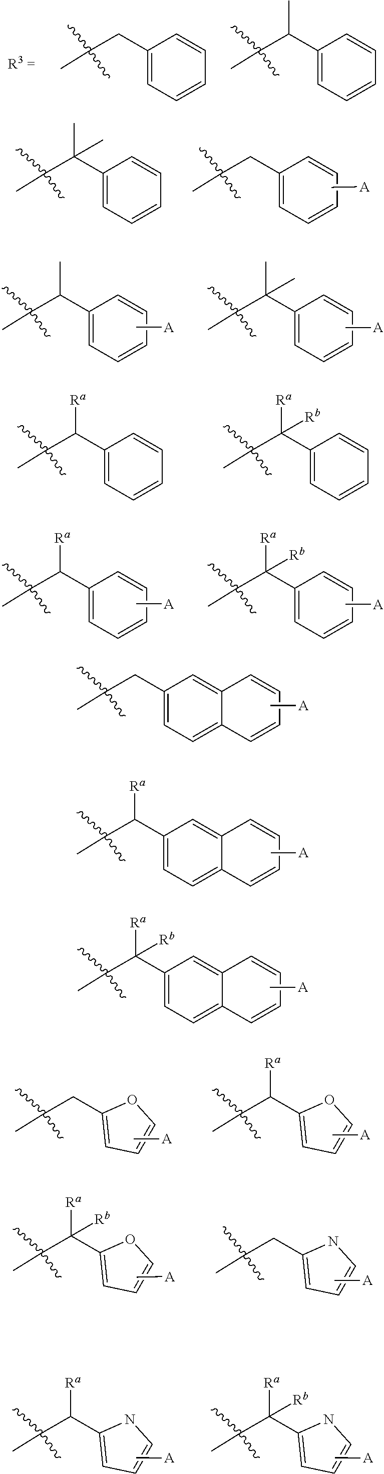

R³ is classified into a primary substituent R^{3I}, a secondary substituent R^{3II}, or a tertiary substituent R^{3III}, and is typically an alkyl group or an aralkyl group. Preferred examples of each class are as follows:

Suitable examples of the primary substituent R^{3I}: a methyl group, an ethyl group, an n-propyl group, an n-butyl group, an isobutyl group, a benzyl group, a phenethyl group, and the like.

Suitable examples of the secondary substituent R^{3II} are: an isopropyl group, a sec-butyl group, a cyclopentyl group, a cyclohexyl group, a cycloheptyl group, an α-methylbenzyl group, and the like.

Suitable examples of the tertiary substituent R^{3II} are t-butyl, t-amyl, 1-methyl-cyclopentyl, 1-methyl-cyclohexyl, and 2-phenyl-2-propyl groups.

The primary substituent R^{3I}, the secondary substituent R^{3I1}, and the tertiary substituent R^{3I11} may each exhibit different properties when used as a resist material. In the following, alkyl groups will be explained as representative examples. From the viewpoint of sensitivity (photoreactivity), when used in a preferred EUV resist, the secondary alkyl group R² and the tertiary alkyl group R^{3III}, which are easily eliminated, are preferred.

From the viewpoint of hydrophobicity, the tertiary alkyl group R^{3III} is preferred from the viewpoint of controlling solubility because it can increase hydrophobicity most in the vicinity of the tin atom; however, when the hydrophobicity is too high, the secondary alkyl group R^{3II} may be preferred.

From the viewpoint of thermal stability that affects distillation, primary alkyl groups are less likely to undergo disproportionation reactions and may be easily purified. On the other hand, secondary and tertiary alkyl groups are more likely to undergo disproportionation reactions. In particular, secondary and tertiary alkyl groups with a small number of carbon atoms (e.g., 6 or fewer carbon atoms) are often unstable during distillation and difficult to purify.

In the formula (a1), each X³ is independently OR^{3′} or NR^{3′}₂. In principle, there is no limitation on the structure of X³ as long as it is a substituent that can undergo hydrolysis, but typical examples thereof include —OR^{3′} and —NR^{3′}₂ because of their high reactivity. R^{3′} is a hydrocarbon group having 1-30 carbon atoms, which may be substituted with a halogen atom, an oxygen atom or a nitrogen atom.

In the formula (a1), the three R³'s may be the same or different from each other.

Some non-limiting examples of OR^{3′} include an alkoxy group and a carboxyl group. Some non-limiting examples of NR^{3′}₂ include a dialkylamino group and an amide group. Among them, an alkoxy group and a dialkylamino group are preferred because of their high reactivity by hydrolysis.

Some non-limiting examples of R^{3′} include, for example, methyl, ethyl, propyl, isopropyl, butyl, isobutyl, sec-butyl, t-butyl, t-amyl, 2-methyl-pentyl, trifluoroethyl, and trifluoromethyl. NR^{3′}₂ also includes 1-pyrrolidinyl, in which two substituents on the nitrogen are bonded to form a five-membered ring.

As R^{3′} of X³, alkyl groups without heteroatoms and alkyl groups with fluorine are preferred from the viewpoint of low boiling point and stability, respectively. From the viewpoint of low boiling point, a smaller number of carbons is preferred. From the viewpoint of thermal stability and stability against moisture, a higher carbon number is preferred. Considering the balance of these properties, preferred examples of OR^{3′} and NR^{3′}₂ are as follows.

Suitable examples of OR^{3′}: t-butoxy group, t-amyloxy group, 2-methyl-pentyloxy group, trifluoroethoxy group, trifluoromethoxy group, etc.

Suitable examples of NR^{3′}₂: dimethylamino group, diethylamino group, methylethylamino group, pyrrolidyl group, etc.

Among these suitable examples, dimethylamino and diethylamino groups are preferred from the viewpoint of the reactivity of hydrolysis when used as resist materials. The t-butoxy group, t-amyloxy group, and 2-methyl-pentyloxy group are preferred from the viewpoint of balance between stability and reactivity.

In the formula (a1), R³ and R^{3′} may be bonded to each other to form a cyclic structure. This means that R³ bonded to tetravalent tin in the organotin compound (a1) and R^{3′} in X³ may be bonded to each other to form a cyclic structure. For example, the following compounds are listed below.

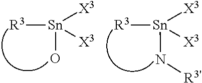

The boiling point of the organotin compound (a1) at 1 torr is preferably below 300° C., more preferably below 250° C., even more preferably below 200° C., and especially below 150° C. The boiling point of the organotin compound (a1) at 1 torr is usually 0° C. or higher, preferably 10° C., and more preferably 20° C. or higher.

The low boiling point of the organotin compound (a1) allows distillation at low temperatures. In addition, deposition is easy when used as a resist material. However, if the boiling point is too low, processes involving high-temperature deposition or reactions tend to be difficult when used as an EUV resist. In addition, volatilization and dispersion of decomposition components and outgassing can be problems as a result of the lack of thermal stability of the formed film.

The molecular weight of the organotin compound (a1) is preferably 500 or less, more preferably 400 or less, and even more preferably 350 or less. The molecular weight of the organotin compound (a1) is preferably 150 or more, more preferably 180 or more, and even more preferably 200 or more.

If the molecular weight of the organotin compound (a1) is too high, the boiling point becomes too high, and thus deposition tends to be difficult when used as an EUV resist. If the molecular weight is too low, the boiling point becomes too low, and thus deposition at high temperatures or processes involving reactions tend to become difficult. In addition, the thermal stability of the formed film is insufficient, and thus volatilization or scattering of decomposition components or outgassing may become a problem.

The molecular weight difference between R³ and X³ of the organotin compound (a1) is not particularly limited, but in some non-limiting examples, it is preferably 50 or less, more preferably 30 or less, even more preferably 20 or less, particularly preferably 10 or less, and especially preferably 6 or less. In some non-limiting examples, the molecular weight difference between R³ and X³ of the organotin compound (a1) is usually 0 or more, and preferably 1 or more.

By reducing the difference in molecular weight between R³ and X³ in the organotin compound (a1), the difference in mass of various outgases generated when used as a resist is reduced, which may facilitate the setting of conditions in the EUV process. The molecular weight of substituent R³ or X³ may be understood to mean the sum of the atomic weights of the atoms constituting R³ or X³. To control the EUV sensitivity and boiling point of the organotin compound, the molecular weight difference between R³ and X³ of the organotin compound (a1) may be adjusted. The molecular weight difference between R³ and X³ in the organotin compound (a1) can be adjusted by changing the substituents.

On the other hand, as described below, the smaller the difference in molecular weight between R³ and X³, the smaller the difference in molecular weight between the target organotin compound (a1) and impurities. In commercial and practical industrial production, it is preferable to pay attention to this point.

### Other Organotin Compounds and Impurities

Other organotin compounds and impurities other than the organotin compound (a1) are not limited. Organotin compounds with intramolecular Sn—C bonds have low Sn—C bond energy and may be easily decomposed by heat or light. Organotin compounds with intramolecular hydrolyzable groups are easily hydrolyzed and converted to compounds with Sn—O—Sn bonds, such as stannoxanes.

Organotin compounds with hydrocarbon groups and hydrolyzable groups in the molecule, that is, organotin compounds with Sn—C bonds and hydrolyzable groups in the molecule, may cause disproportionation reactions as represented by the following formula. However, R³ in the following formula represents a hydrocarbon group, and X³ represents a hydrolyzable group.

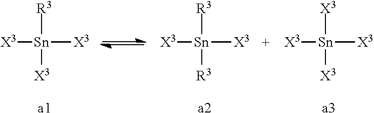

### Organotin Compound (a2) and Organotin Compound (a3)

Representative and non-limiting examples of impurities include, for example, the organotin compound (a2) represented by the following formula (a2) and the organotin compound (a3) represented by the following formula (a3).

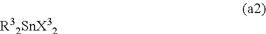

In the formula (a2), R³ is a hydrocarbon group having 1-30 carbon atoms, which may be substituted with a halogen atom, an oxygen atom, or a nitrogen atom, and each X³ is independently OR^{3′} or NR^{3′}₂, and the two R³'s may be the same or different from each other.

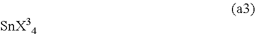

In the formula (a3), each X³ is independently OR^{3′} or NR^{3′}₂. R^{3′} is a hydrocarbon group having 1-30 carbon atoms, which may be substituted with a halogen atom, an oxygen atom, or a nitrogen atom, and the four R³'s may be the same or different from each other.

Details and preferred examples of R³, X³, and R^{3′} in the organotin compound (a2) and organotin compound (a3) are the same as those already described.

As shown in the above formula, the organotin compound (a2) and the organotin compound (a3) are generated by decomposition of the organotin compound (a1) during the production reaction or heating of the organotin compound (a1). These organotin compounds (a2) and (a3) are particularly similar in structure and boiling point to the organotin compound (a1), and therefore separation of them by distillation is difficult.

In the distillation of organotin compounds, in addition to their physical properties such as their boiling point, decomposition due to side reactions during heating and the decomposition rate are also important. For example, the disproportionation reaction shown in the above formula also occurs during distillation in the purification process. Acceleration of the decomposition reaction due to light and heat may also be taken into consideration. In addition, acceleration of decomposition due to the presence of trace amounts of air and moisture may also be expected.

Considering various factors related to decomposition, even if distillation separation based on the boiling point difference is possible in conventional distillation methods, impurities newly generated by the decomposition of organotin compounds in a distillation still or distillation column during distillation may be mixed into the distillation fraction.

As already mentioned, separation by distillation is often difficult, especially when the boiling points of the organotin compound (a1) and the organotin compound (a2) or organotin compound (a3) are close. When that boiling point difference is close, it means that the boiling point difference is 50° C. or less, 30° C. or less, 10° C. or less, or 5° C. or less. The boiling point referred to here may be a value compared under the same pressure, particularly at the pressure when the distillation is carried out, which is not limited to normal pressure.

If the molecular weights of R³ and X³ of the organotin compound (a1) are excessively close, separation can be even more difficult because the difference in boiling points is excessively small, and the intermolecular interaction is excessively large. The case where the molecular weights of R³ and X³ of the organotin compound (a1) are excessively small refers to the case where the difference in molecular weight is less than 20, less than 10, or less than 5.

As an example, in the case of iPrSn(NMe₂)₃, iPr₂Sn(NMe₂)₂, and Sn(NMe₂)₄, their molecular weights are 294 g/mol, 293 g/mol, and 295 g/mol, respectively, so that the molecular weight difference is very small, only 1 g/mol. In addition, the polarity of the isopropyl group (-iPr) and the dimethylamino group (—NMe₂) is very similar. Furthermore, the difference in boiling points between iPrSn (NMe₂)₃ and iPr₂Sn(NMe₂)₂ is also extremely small. In fact, when the boiling point difference of these compounds is measured, it is within 5° C. in the pressure range of 0.7 to 10 torr. In such a case, a method with higher separation capability than conventional techniques is required to obtain high-purity iPrSn(NMe₂)₃ by distillation.

Depending on the method for producing the crude product, organotin compounds such as trialkyltin compounds (R³₃SnX³) and tetraalkyltin compounds (R³₄Sn) may be present as impurities, and separation by distillation may be required.

### Organotin Compound (a4)

When the crude product contains R³Sn(NR^{3′}₂)₃ as the organotin compound (a1), the organotin compound (a4) represented by the following formula (a4) may be mixed into the crude product as an impurity.

If R^{3′} is a methyl group,

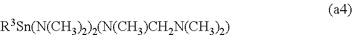

The mechanism by which the above compound is produced is unclear; however, structurally, it is presumed that the compound is formed by the insertion of a nitrogen radical (·NR^{3′}₂) generated upon elimination of one of the three dimethylamino groups in compound (a1) into the C—H bond next to the nitrogen atom of another nearby compound (a1).

When R^{3′} is a primary alkyl group with 2 or more carbons, such as an ethyl group (where R^{3′} is CH₂R¹¹), compound (a1) is represented by R³Sn[N(CH₂R¹¹)₂]₃, and compound (a4) is represented by R³Sn[N(CH₂R¹¹)₂]₂N(CH₂(R¹¹)CHR¹N(CH₂R¹¹)₂. Furthermore, when R^{3′} is a secondary alkyl group such as an isopropyl group (where R^{3′} is CHR²²R³³), that is, when compound (a1) is represented by R³Sn[N(CHR²²R³³)₂]₃, compound (a4) is represented by R³Sn[N(CHR²R³)₂]₂N(CHR²R³)CR²R³N(CHR²R³)₂.

In the formula (a4), R³ is a hydrocarbon group having 1-30 carbon atoms that may be substituted with a halogen atom, an oxygen atom, or a nitrogen atom, and R^{3′} is a hydrocarbon group having 1-30 carbon atoms that may be substituted with a halogen atom, an oxygen atom, or a nitrogen atom.

The organotin compound (a4) is generated by the decomposition of RSn(NR′2)₃. The generation of the organotin compound (a4) may be promoted by heat, light, or a combination of these factors.

When the crude product contains iPrSn(NMe₂)₃ as the organotin compound (a1), iPrSn(NMe₂)₂(NMeCH₂NMe₂) may be formed as the impurity organotin compound (a4) as a secondary product. The iPrSn(NMe₂)₂(NMeCH₂NMe₂) chemical structural formula is shown below.

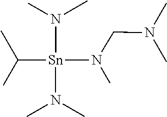 [SMILES: C[CH](C)[Sn]([N](C)C)([N](C)C)[N](C)CN(C)C]

iPrSn(NMe₂)₂(NMeCH₂NMe₂) can be identified and quantified from the ¹¹⁹Sn-NMR spectrum and ¹H-NMR chemical shifts shown below. ¹¹⁹Sn-NMR (223.8 MHz, C6D6): δ −82 ppm. 1H-NMR (600 MHz, C6D6): δ 3.37 (s, 2H, CH₂), 2.89 (s, 3H, Sn—NMe), 2.86 (s, 12H, Sn—(NMe₂)₂), 2.15 (s, 6H, NMe₂), 1.68 (m, 1H, iPr), 1.33 (s, 6H, iPr).

### Organotin Compound (a5)

In some non-limiting examples, the presence of a divalent tin compound is also assumed. For example, an organotin compound (a5) represented by the following formula (a5) may be present as an impurity in the crude product.

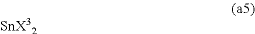

In the formula (a5), each X³ is independently OR^{3′} or NR^{3′}₂. R^{3′} is a hydrocarbon group having 1-30 carbon atoms, which may be substituted with a halogen atom, an oxygen atom, or a nitrogen atom, and the two R³'s may be the same or different.

If the crude product contains R³Sn(NR^{3′}₂)₃ as the organotin compound (a1), Sn(NR^{3′}₂)₂ may be formed as an impurity organotin compound (a5) as a secondary product.

In order to obtain a high-purity resist material, the content of the organotin compound (a5) is preferably 1.0 mol % or less, in terms of the weight of tin atoms, when the total tin content in the crude product is taken as 100 mol %, more preferably 0.5 mol % or less, even more preferably 0.1 mol % or less, and particularly preferably 0.01 mol % or less.

(Composition of the crude product) The content of the organotin compound (a1) in the crude product is preferably 70 mol % or more, more preferably 80 mol % or more, even more preferably 85 mol % or more, and particularly preferably 90 mol % in terms of the weight of tin atoms, when the total tin content of the crude product is taken as 100 mol %. The content of the organotin compound (a1) is its purity, so the higher the better, but it is usually less than 95 mol %.

Components in the crude product other than the organotin compound (a1) are impurities, the details of which have already been explained (tin compound (a2), tin compound (a3), tin compound (a4), etc.). The content of impurities is determined by subtracting the content of the organotin compound (a1) from the content of the crude product.

The total content of impurities having similar molecular weights and boiling points (boiling point difference of 10° C. or less) is preferably 10 mol % or less, more preferably 5 mol % or less, and even more preferably 3 mol % or less, calculated as the tin atomic weight, when the total tin content of the crude product is taken as 100 mol %. The lower the total content of impurities having similar molecular weights and boiling points, the better, but it can usually be 1 mol % or more.

Impurities may accelerate the decomposition reaction of the organotin compound (a1), so the fewer the impurities, the better. If the quality is not sufficient before the distillation, pretreatment (filtration or purification by a column, addition of an adsorbent or a reactant, etc.) or simple distillation may be carried out in advance to improve the quality.

### Production Method of the Crude Product

The method of producing the crude product is not particularly limited and may be any conventionally known method. Methods (1), (2), and (3) described below are non-limiting examples of methods for preparing the crude products (crude tin compounds) containing organotin compounds (a1) as a major component.

### Method (1)

In method (1), a monoalkyltin compound (R³SnY³₃) is used as a raw material. As shown in the synthesis scheme below, R³SnY³₃ reacts with the reactant MX³ to synthesize RSnX³₃.

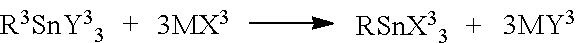

In the above synthesis scheme, Y³ is a substituent that is substituted by reacting with the reactant MX³, and Y³ is not the same as X³. R³ and X³ are the same as those for the organotin compound (a1). M of MX³ is a metal of Group 1, Group 2, Group 12, or Group 13, or hydrogen.

According to method (1), it is possible to increase the purity of R³SnX³₃ by purifying the raw material R³SnY³₃ and therefore it is a preferred method. Moreover, R³ has already been introduced as a substituent in R³SnY³₃. Therefore, it is possible to reduce impurities such as organotin compounds (a2), organotin compounds (a3), and organotin compounds (a4). In other words, it is possible to reduce in advance the impurities that are difficult to separate in the distillation of the crude product.

The structure of Y³, a substituent of the raw material, is not limited as long as it is a substituent that reacts with the reactant MX³. Suitable examples include halogen, OR^{3′}, and NR^{3′}₂. R^{3′} is the same as already described for the organotin compound (a1).

Among these, halogens are preferred from the viewpoint of high reactivity. Among halogens, C1 has a good balance between stability and reactivity. In order to obtain an organotin compound (a1) with higher purity, C1 is preferred.

If M of MX³ is a group 1 metal or hydrogen atom, MX³ may be written as is, but if M of MX³ is a group 2 or 12 metal, MX³ is “MX³₂”. Similarly, if the metal is a group 13 metal, MX³ is “MX³₃”. When multiple X³'s are present, the multiple X³'s in the molecule may be identical or different from each other.

When X³ is OR^{3′}, examples include HOR^{3′}, LiOR^{3′}, NaOR^{3′}, KOR^{3′}, MgOR^{3′}₂, and ZnOR^{3′}₂. When considering high reactivity, LiOR^{3′}, NaOR^{3′}, and KOR^{3′} are preferred. When considering the absence of metal contamination, HOR^{3′} is preferred.

When X³ is NR^{3′}₂, HNR^{3′}₂, LiNR^{3′}₂, NaNR^{3′}₂, KNR^{3′}₂, Mg(NR^{3′}₂)₂, and Zn(NR^{3′}₂)₂ are exemplified. When considering high reactivity, LiNR^{3′}₂, NaNR^{3′}₂, and KNR^{3′}₂ are preferred. From the viewpoint of stability, Mg(NR^{3′}₂)₂ and Zn(NR^{3′}₂)₂ are preferred. When considering that metal is not contaminated, HOR^{3′} is preferred. In order to obtain an organotin compound (a1) with higher purity, LiNR^{3′}₂ is particularly preferred.

The higher the purity of R³SnY³₃, the better: the purity of R³SnY³₃ is usually 95 mol % or higher in terms of the tin atom weight, preferably 97 mol % or higher, more preferably 99.5 mol % or 99.9 mol % or higher.

When the raw material contains R³₂SnY³₂, R³₃SnY³, R³₄Sn, and SnY³₄ as impurities, the ratio of each of them is preferably 3 mol % or less, more preferably 2 mol %, particularly preferably 1 mol % or less, and even more preferably 0.1 mol % or less, in terms of the tin atom weight. On the other hand, these impurities may prevent the crystallization of the target organotin compound (a1). Considering that the presence of impurities can contribute to the stabilization of the organotin compound (a1), in this example, the ratio of impurities may be 0.01 mol % or more, or may be 0.1 mol % or more.

### Method (2)

In method (2), a tin compound (SnX³₄) is used as a raw material. As shown in the synthesis scheme below, SnX³₄ reacts with the reactant R³M or R³MZ³ to synthesize R³SnX³₃.

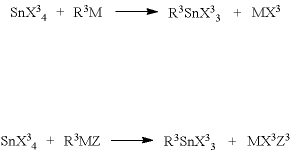

In the above synthetic scheme, Z³ is a halogen atom, or R³. Multiple Z's in a molecule can be different; X³, R³, and M of R³M and R³MZ³ are the same as those already described.

When X³ is OR^{3′}, examples include R³OH, R³Li, R³Na, R³K, R³MgZ³, R³ZnZ³, R³₂Zn, etc. From the viewpoint of high reactivity, R³Li is preferred. R³MgZ³ and R³ZnZ³ are preferred because they have high reaction selectivity for monoalkylation and can prevent decomposition of the target product due to their low basicity. Among them, R³MgZ³ is particularly preferred. R³OH is preferred when considering that the metal does not contaminate the product.

### Method (3)

In method (3), a tin compound (SnX³₂) is used as a raw material. The method (3) includes the following steps: a and p.
Step α: A step of producing MSnX³₃ from SnX³₂ and MX³.
Step β: A step of reacting MSnX³₃ with MZ³.

In method (3), X³, M, and Z³ are the same as those already described. When X³ is OR^{3′}, examples include LiOR^{3′}, NaOR^{3′}, KOR^{3′}, MgOR^{3′}₂, and ZnOR^{3′}₂. From the viewpoint of high reactivity, LiOR^{3′}, NaOR^{3′}, and KOR^{3′} are preferred. When X³ is NR^{3′}₂, LiNR^{3′}₂, NaNR^{3′}₂, KNR^{3′}₂, Mg(NR^{3′}₂)₂, and Zn(NR^{3′}₂)₂ are exemplified. From the viewpoint of high reactivity, LiNR^{3′}₂, NaNR^{3′}₂, and KNR^{3′}₂ are preferred. In order to obtain the organotin compound (a1) with a higher purity, LiNR^{3′}₂ is particularly preferred.

### Purification of the Crude Product

A crude product comprising mainly of organotin compounds (a1) may react with water and air. In the purification of the crude product, it is important to select reagents, equipment, and methods according to the structure and properties of the organotin compound (a1) and the structure and properties of the impurities to be removed.

In conventional commercial and practical industrial production, the following separation and purification procedures are carried out to remove impurities of organotin compounds.
Separation and purification by extraction and liquid separation operations.
Separation and purification by columns and filters.
Separation and purification by crystallization, crystallization, and washing of the resulting solid.
Separation and purification using additives that adsorb or react with impurities
Separation and purification using distillation

In commercial and practical industrial production, these separation methods can be used in combination. However, considering the instability of the organotin compound (a1), the fact that the organotin compound (a1) is a liquid at room temperature, and the fact that the boiling point of the organotin compound (a1) is close to those of the impurities during distillation, there are technical challenges in increasing the purity through separation and purification by distillation. In such cases, separation and purification using additives that adsorb or react with the impurities are particularly effective.

This production method of an organotin compound in this embodiment is characterized by the addition of a specific additive to the crude product, which is mainly composed of the organotin compound (a1). By adding a specific additive to the crude product, specific impurities can be selectively and efficiently removed.

It is important to select an additive that selectively reacts with or adsorbs impurities that are difficult to separate by distillation because of their similar structure or boiling point to that of the organotin compound (a1), or impurities that have a similar structure to that of the organotin compound (a1), in order to facilitate separation from the target organotin compound (a1). However, even if an additive exhibits reactivity or absorptivity with impurities, if the additive also exhibits reactivity or absorptivity with the organotin compound (a1), this will result in a decrease in the purity and yield of the resulting tin compound, which is not preferable. In order to make an additive act selectively on impurities by reacting with or adsorbing to them, it is important to appropriately select and implement the parameters that affect not only the selection of the additive structure but also the amount of additive added, mixing conditions, mixing time, mixing temperature, addition and concentration of the solvent, and stirring conditions.

By adding an appropriately selected additive to the crude product under appropriate conditions, the additive can be selectively reacted with or adsorbed onto the impurities, making it easier to separate the impurities in the subsequent purification step. For example, the reaction with the additive is expected to cause a chemical structure change, oligomerization, polymerization, crystallization, and gelation. As a result, it is expected that the impurities will change into compounds having solubility, compatibility, melting points, and crystallinity significantly different from those of the organotin compound (a1). On the other hand, the chemical structure change, oligomerization, polymerization, crystallization, gelation, and other processes can cause problems such as increased viscosity of the liquid to be distilled, increased slurry concentration, and adhesion of solids or highly viscous materials to the walls of the reactor. These can cause problems in the distillation process, such as reduced agitation during distillation and reduced separation efficiency. From these two perspectives, it is important to select appropriate additive structures and reaction conditions.

For example, separation by filtration or adsorption, which is difficult before the additive acts, becomes possible, and the change in boiling point is expected to improve separation performance by distillation. As for the change in boiling point, it is particularly desirable that the boiling point of the impurity becomes higher or that the impurity changes to a non-volatile compound.

Therefore, in the production method of an organotin compound according to this embodiment, an essential technical means is adopted to recover the organotin compound (a1) having a purity of 95 mol % or more by separating the mixture (X³) containing the crude product and a specific additive by filtration, adsorption, or decantation, or by distillation, etc. Although filtration alone may be used, distillation is preferable.

As for the mixing temperature when mixing the crude product and the specific additive, a lower limit of −5° C. or higher is preferred, especially 0° C. or higher, and even 5° C. or higher is preferred, especially 10° C. or higher. The upper limit is preferably less than 100° C., especially less than 80° C., and even more preferably less than 60° C., and further preferably 40° C. If the mixing temperature is too low, the compatibility of the organotin compound and the additive may decrease, or the viscosity of the slurry obtained after addition may increase, resulting in poor agitation. If the mixing temperature is too high, the reaction between the additive and the organotin compound may not proceed selectively, resulting in lower purity and a lower yield of the obtained organotin compound (a1).

The time required for mixing varies depending on the amount of additive used, but is preferably about 1 to 60 minutes, and more preferably about 5 to 40 minutes. The time required for mixing typically means the time from the start of dropwise addition to the end of dropwise addition, when the additive is mixed by dropwise addition. After mixing, it is preferable to proceed with the reaction by holding the mixture at the above temperature with stirring for a while, and the holding time after mixing is preferably from 20 to 300 minutes, and even more preferably from 60 to 240 minutes. If distillation is to be continued, the holding time may be shorter.

As for the agitation speed (rpm) during mixing, 50 rpm or more is preferred as the lower limit, 100 rpm or more is even more preferred, and 150 rpm or more is even more preferred. As the upper limit, 1000 rpm or less is preferred, 800 rpm or less is preferred, and 600 rpm or less is even more preferred. When the stirring number is at least above the lower limit, sufficient uniformity can be ensured even in a slurry state. When the stirring speed is equal to or lower than the upper limit, it is possible to prevent poor stirring due to the slurry being finely divided by too strong stirring power or to prevent a load on the stirring device when the slurry becomes highly viscous.

In some non-limiting examples, the mixture (X³) may be filtered prior to distillation. As a result of the improved separation performance of the distillation, the purity and other qualities of the purified tin compound are expected to be improved. Filtration to remove solid and high-viscosity components may improve the purity of the mixture (X³) prior to distillation, reduce viscosity and slurry concentration during distillation to improve purification efficiency in the distillation operation, and improve handleability in industrial manufacturing. These effects may also allow for simplification of distillation operations (e.g., distillation without a high number of distillation column stages, single distillation, etc.), which is especially important on an industrial scale.

Filtration refers to the process of separating solids and liquids through a filter or similar, but any unit operation that can separate solids and liquids can be used as an alternative to filtration, such as decantation (a method of precipitating solids and obtaining the supernatant), centrifugation, and column chromatography using adsorbents. Among these, to apply to unstable organotin compounds, filtration using a filter or decantation is preferred.

The types of mixtures (X³) include a mixture (x1), mixture (x2), mixture (x3), and mixture (x4), depending on the type of additive and conditions of use. The appropriate additives and their appropriate conditions of use are described below.

Suitable Additives and their Appropriate Use Conditions

The following is a description of use of appropriate additives that show selective reactivity with and adsorption to impurities (especially the organotin compound (a2), organotin compound (a3), and organotin compound (a4) that are difficult to separate by distillation) in the production method of the organotin compound according to this embodiment, along with their conditions of use.

The additive is a compound that may be expressed as a weak acid or a weak base. Typical compounds include alcohols or phenols as weak acids and amines as weak bases.

Among them, the compounds described below as (b1) and (b2) are preferably used, where (b1) is a part of (b2) and is a preferred compound.

### Additive (b1)

The additive (b1) is a hydrocarbon compound with 2 to 20 carbons, and the additive (b1) has either or both nitrogen and oxygen atoms and satisfies condition (1a) and condition (2) described below.

Condition (1a): When the number of nitrogen atoms is m and the number of oxygen atoms is n, m is 0, 1, 2, or 3, n is 0, 1, 2, or 3, and m+n is 2 or 3.

Condition (2): When the number of nitrogen atoms bonded to hydrogen atoms among m nitrogen atoms is denoted by x and the number of oxygen atoms bonded to hydrogen atoms among n oxygen atoms is denoted by y, x+y is 1 or more.

In some non-limiting examples, the hydrocarbon compounds usable as additives (b1) may be linear, branched, or cyclic.

In some non-limiting examples, a lower limit of the number of carbons in the additive (b1) is 2 or more preferred, 3 or more preferred, and 4 or more further preferred. As an upper limit of the number of carbons, 20 or less is preferred, 10 or less is more preferred, 7 or less is even more preferred, and 5 or less is especially preferred. When the number of carbons in the additive (b1) is above the lower limit of the above numerical range, hydrophobicity may be improved, compatibility and solubility with organic solvents applicable to the tin compounds shown above may be sufficiently obtained, or viscosity may be reduced and operability may be improved. When the number of carbons in the additive (b1) is no more than the upper limit of the aforementioned numerical range, the hydrophobicity is not excessively increased, sufficient compatibility with the organic solvent applicable to the tin compounds described above is obtained, and the boiling point is not too high relative to the target tin compound, making it easy to separate from the tin compounds during distillation.

In some non-limiting examples, the hydrocarbon compound that can be used as an additive (b1) may be an aliphatic hydrocarbon compound. The additive (b1) may be an aliphatic saturated hydrocarbon compound or an aliphatic unsaturated hydrocarbon compound. Aliphatic saturated hydrocarbon compounds are preferred from the viewpoint of low coloration and thermal stability.

Some non-limiting examples of aliphatic saturated hydrocarbon compounds that can be used as additives (b1) include, for example, diethanolamine, dipropanolamine, dibutanolamine, N-methyl diethanolamine, bis(aminoethyl)amine, bis(aminopropyl)amine, bis(aminobutyl)amine, diethylene glycol, trimethylolpropane, etc.

Some non-limiting examples of aliphatic unsaturated hydrocarbon compounds that can be used as additives (b1) include, for example, N-allylethylenediamine (H₂NCH₂CH₂NHCH₂CH═CH₂), ethylene glycol vinyl ether (HOCH₂CH₂OCH═CH₂), and the like.

Regarding the condition 2, in some non-limiting examples, x+y may be 1 to 3, and is preferably 2 to 3. When x+y is no lower than the lower limit of the above-mentioned numerical range, the reactivity or adsorption of the additive (b1) with the organotin compound of the impurity is good.

In some non-limiting examples, the additive (b1) may have a nitrogen atom. In these examples, m may be 1, 2, or 3. When m is 1, n is 1 or 2, and when m is 2, n is 0 or 1, and when m is 3, n is 0.

The Additive (b1) may not have a nitrogen atom. When m is 0, n is 2 or 3.

When m is 1, examples of the additive (b1) include those in which n is 1, such as 2-aminoethanol (HOCH₂CH₂NH₂), 2-methoxyethylamine (CH₃OCH₂CH₂NH₃), and N-methyl-2-aminoethanol (CH₃NHCH₂CH₂OH), and the like. Examples of those in which n is 2, such as diethanolamine (HOCH₂CH₂NHCH₂CH₂OH), dipropanolamine (HOCH₂CH₂CH₂NHCH₂CH₂CH₂OH), dibutanolamine (HOCH₂CH₂CH₂CH₂NHCH₂CH₂CH₂CH₂OH), N-methyldiethanolamine (HOCH₂CH₂N(CH₃)CH₂CH₂OH), and bis(2-methoxyethyl)amine (CH₃OCH₂CH₂NHCH₂CH₂OCH₃) and like.

When m is 2, examples of the additive (b1) in which n is 0 include ethylenediamine (H₂NCH₂CH₂NH₂), 1,2-propanediamine (H₂NCH₂CH(NH₂)CH₃), 1,3-propanediamine (H₂NCH₂CH₂CH₂NH₂), N,N-dimethylethylenediamine ((CH₃)₂NCH₂CH₂NH₂), N,N′-dimethylethylenediamine (CH₃NHCH₂CH₂NHCH₃), and N,N,N′,N′-tetramethylethylenediamine ((CH₃)₂NCH₂CH₂N(CH₃) 2). Examples of the additive (b1) in which n is 1 include N-(2-hydroxyethyl)ethylenediamine (H₂NCH₂CH₂NHCH₂CH₂OH), N-(2-methoxyethyl)-1.2-ethanediamine (CH₃OCH₂CH₂NHCH₂CH₂NH₂), and the like.

When m is 3, n is 0, and examples of the additive (b1) include bis(aminoethyl)amine (H₂NCH₂CH₂NHCH₂CH₂NH₂), bis(aminopropyl)amine (H₂NCH₂CH₂CH₂NHCH₂CH₂CH₂NH₂), bis[2-(dimethylamino)ethyl]amine ((CH₃) ₂NCH₂CH₂NHCH₂CH₂N(CH₃)₂), and the like.

When m is 0, examples of the additive (b1) in which n is 2 include ethylene glycol (HOCH₂CH₂OH), 1,2-propanediol (HOCH₂CH(OH)CH₃), 1,3-propanediol (HOCH₂CH₂CH₂OH), 2-methoxyethanol (CH₃OCH₂CH₂OH), etc. Examples of the additive (b1) in which n is 3 include glycerin (HOCH₂CH(OH)CH₂OH), diethylene glycol (HOCH₂CH₂OCH₂CH₂OH), diethylene glycol monomethyl ether (CH₃OCH₂CH₂OCH₂CH₂OH), trimethylolpropane (CH₃CH₂C(CH₂OH)₃), and the like.

In some non-limiting examples, the additive (b1) may have an oxygen atom. In these examples, n is 1, 2, or 3. n may be 1, 2, or 3.

When n is 1, m (the number of nitrogen atoms) is 1 or 2, when n is 2, m is 0 or 1, and when n is 3, m is 0.

It is also possible for the compound to have no oxygen atoms, i.e., when n is 0, m is 2, or 3.

The additive (b1) is preferably one having both an oxygen atom and a nitrogen atom, i.e., one in which m is 1 and n is 1, one in which m is 1 and n is 2, or one in which m is 2 and n is 1. Among these, those in which m is 1 and n is 2, those in which m is 2 and n is 1 are more preferred, and those in which m is 1 and n is 2 are particularly preferred. The above preferred compounds have high selectivity and can be efficiently removed by reacting with the organotin compounds (a3) and (a4), which are particularly highly reactive.

The number of carbons between the respective oxygen and/or nitrogen atoms of the additive (b1) is preferably 1 to 3, and more preferably 2. With such a number of carbons, when one oxygen or nitrogen atom of the additive (b1) is coordinated to the organotin compound, the second oxygen or nitrogen atom can easily react with it in terms of distance.

The additive (b1) is preferably a compound having at least one nitrogen atom with high electron density (for example, a nitrogen atom having two or three carbon atoms bonded thereto) and at least one OH group.

Such an additive (b1) has high abilities to coordinate with specific organotin compounds and high reactivity, and therefore has high selectivity, and can remove by-products such as the organotin compound (a2), the organotin compound (a3), and the organotin compound (a4), while very efficiently improving the yield and purity of the target organotin compound (a1). Examples of such an additive (b1) include diethanolamine, N-methyldiethanolamine, and 2-methoxyethylaminoethanol (CH₃OCH₂CH₂NHCH₂CH₂OH). These preferred compounds have high selectivity and can be efficiently removed by reacting with the organotin compound (a3) in particular.

In some non-limiting examples of the additive (b1), m+n may be 2 or 3. When the additive is intended to react with the organotin compound (a3) having 4 reactive ligands in the crude product, m+n is preferably 3 because there are just the right number of coordination sites and the possibility of selective reaction is increased. If the value of m+n is too high, there are too many sites that coordinate or react with organotin compounds, which may cause oligomerization or gelation, or the target organotin compound (a1) may be simultaneously adsorbed, resulting in a decrease in its purity.

When m+n is 2, examples of the additive (b1) include ethylenediamine (H₂NCH₂CH₂NH₂), ethanolamine (HOCH₂CH₂NH₂), and ethylene glycol (HOCH₂CH₂OH).

When m+n is 3, examples of the additive (b1) include diethanolamine (HOCH₂CH₂NHCH₂CH₂OH), N-(2-hydroxyethyl)ethylenediamine (H₂NCH₂CH₂NHCH₂CH₂OH), N-(2-aminoethyl)-1,2-ethanediamine (H₂NCH₂CH₂NHCH₂CH₂NH₂), diethylene glycol (HOCH₂CH₂OCH₂CH₂OH), and the like.

In some non-limiting examples, the additive (b1) may have both nitrogen atoms and oxygen atoms. In these examples, non-limiting examples of hydrocarbon compounds that can be used as the additive (b1) include, for example, diethanolamine (HOCH₂CH₂NHCH₂CH₂OH), and N-(2-hydroxyethyl)ethylenediamine (H₂NCH₂CH₂NHCH₂CH₂OH). Having one or more nitrogen atoms is effective in efficiently coordinating with a tin compound because of its high abilities to coordinate and react with tin atoms. On the other hand, since nitrogen atoms are more polar, there may be problems in handling the additive, such as water absorption and high viscosity problems. Compounds having both nitrogen atoms and oxygen atoms are preferred because they may have both reactivity and ease of handling as additives. In particular, the combination of m=1 and n=2, which has an excellent balance of the two performances, is the most preferred. These preferred compounds have high selectivity and can be efficiently removed by being reacted with the organotin compound (a3) in particular.

The purity of the additive (b1) is not particularly limited but is preferably 98 wt % or higher, more preferably 98.5 wt % or higher, and even more preferably 99 wt % or higher. The higher the purity of the additive (b1), the less likely side reactions caused by additive impurities will occur, which is desirable. The impurities such as compounds having alcohol or amine structures unlike the structure of the additive (b1), such as water, methanol, ethanol, methylamine, and ethylamine, which react with the organotin compound (a1), are problematic. The content of such impurities is preferably 2 wt % by mass or less, more preferably 1.5 wt % or less, even more preferably 1.0 wt % or less, and even more preferably 0.5 wt % or less. In particular, moisture gets into the additive from air, so stricter management is required, and the amount of moisture is preferably 0.5% or less, more preferably 0.3%, and still more preferably 0.1% or less.

When the additive (bi) is selected, the organotin compound (a1) having a purity of 95 mol % or higher can be recovered by filtering, adsorbing, decanting, distilling, etc., of the mixture (x1) containing the crude product and the additive (b1). Since the organotin compound (a2) and the organotin compound (a3) in the crude product easily react with or be adsorbed by the additive (b1), the mixture (x1) is in a state in which, compared to that without the additive (b1), the organotin compound (a3) of the impurities is particularly easy to be removed by distillation. Thus, it is possible to obtain the organotin compound (a1) having a purity of 95 mol % or more.

The content of additive (b1) in mixture (x1) is not particularly limited, but to obtain a high-purity organotin compound (a1) with a high yield, preferably the amount added is selected based on the content of the organotin compound (a3) that is difficult to remove by distillation. When the content of the organotin compound (a3) is taken as 100 mol %, the content of the additive (bi) is preferably in the range of 50-1000 mol %, more preferably 100-800 mol %, even more preferably 150-600 mol %, particularly preferably 200-500 mol %, and still more preferably 250-450 mol %.

When the content of the additive (b1) in the mixture (x1) is not lower than the lower limit of the above-mentioned numerical ranges, the reaction or adsorption of the organotin compound (a3) and the additive (b1) is promoted, and a high-purity tin compound can be obtained after purification by filtration or distillation. When the content of additive (b1) in the mixture (x1) is not higher than the upper limit of the above-mentioned numerical ranges, the reaction of excess additive with the target organotin compound (a1) can be avoided, and the yield and purity of the purified organotin compound (a1) may be improved. The content here means the content of the additive (b1) in the final mixture (x1) after all additions are completed. The additive (b1) may be added slowly until it reaches the target content, or after adding a portion of it, it may be added again after thorough stirring (divided addition). Divided addition is preferred, particularly when considering stirability and uniformity of the mixture. When the content is optimally controlled, the addition is preferably conducted in divided batches while the contents of impurities such as the organotin compound (a3) are measured as appropriate. On the other hand, if the divided addition takes too long, decomposition of the organotin compound (a1) may occur or gelation may occur.

### Additive (b2)

The additive (b2) is a hydrocarbon compound having 2 to 20 carbon atoms, and the additive (b2) has either nitrogen atoms or oxygen atoms, or both, and satisfies the following condition (1b) and condition (2):

Condition (1b): When the number of nitrogen atoms is m and the number of oxygen atoms is n, m is 0, 1, 2, 3, 4, or 5, n is 0, 1, 2, 3, 4, or 5, and m+n is 2, 3, 4, 5, 6, 7, 8, 9, or 10. When the number of oxygen atoms and nitrogen atoms that can coordinate with a tin atom is 2 or more, coordination and reaction with the organotin compound (a2) and the organotin compound (a3) can occur efficiently and selectively.

Condition (2): If, in the m nitrogen atoms, the number of nitrogen atoms bonded to hydrogen atoms is denoted by x, and in the n oxygen atoms, the number of oxygen atoms bonded to hydrogen atoms is denoted by y, then x+y is 1 or more.

In some non-limiting examples, the hydrocarbon compound that can be used as additive (b2) may be linear, branched, or cyclic.

In some non-limiting examples, the additive (b2) may have 2 to 30 carbon atoms, 3 to 20 carbon atoms, or 4 to 10 carbon atoms.

When the carbon number of additive (b2) is not lower than the lower limit of the above-mentioned ranges, hydrophobicity is improved, and compatibility and solubility with organic solvents suitable for the above-mentioned tin compound of the present disclosure may be satisfactory, and viscosity may be reduced to improve operability. When the carbon number of additive (b2) is not higher than the upper limit of the above-mentioned ranges, hydrophobicity is not increased too much, and compatibility with organic solvents suitable for the above-mentioned tin compound of the present disclosure may be satisfactory, and the boiling point is not too high relative to the target tin compound, making it easy to separate from the tin compound during distillation.

In some non-limiting examples, the hydrocarbon compound that can be used as the additive (b2) may be an aliphatic hydrocarbon compound. The additive (b2) may be an aliphatic saturated hydrocarbon compound or an aliphatic unsaturated hydrocarbon compound. To have lower coloring and good thermal stability, an aliphatic saturated hydrocarbon compound is preferred.

Non-limiting examples of aliphatic saturated hydrocarbon compounds that can be used as the additive (b2) include, for example, diethanolamine (DEA), ethanolamine, and the like.

Non-limiting examples of aliphatic unsaturated hydrocarbon compounds that can be used as the additive (b2) include, for example, N-allylethylenediamine (H₂NCH₂CH₂NHCH₂CH═CH₂), ethylene glycol vinyl ether (HOCH₂CH₂OCH═CH₂), 1,4-bis(2-hydroxyethoxy)-2-butyne (HOCH₂CH₂OCH₂C≡CCH₂OCH₂CH₂OH), etc., wherein ≡ means a carbon-carbon triple bond.

Regarding condition 2, in some non-limiting examples, x+y may be 1 to 10, 2 to 5, or 2 to 3. When x+y is not lower than the lower limit of the above-mentioned numerical ranges, reactivity or adsorption of the additive (b2) with/to the organotin compound, an impurity, is good. When x+y is not higher than the upper limit of the above-mentioned numerical ranges, the viscosity of the additive (b2) tends to be low, making it easy to handle. In addition, excessive gelation after mixing the additive (b2) with the crude product is easily suppressed.

In some non-limiting examples, the additive (b2) may have nitrogen atoms. In these examples, m may be 1, 2, 3, 4, or 5. In some non-limiting preferred examples, m may be 1, 2, or 3. There may also be no nitrogen atom, i.e., m may be 0.

In some non-limiting examples, the additive (b2) may have oxygen atoms. In these examples, n may be 1, 2, 3, 4, or 5. In some non-limiting preferred examples, n may be 1, 2, or 3. There may also be no oxygen atoms, i.e., n may be 0.

The additive (b2) preferably has both an oxygen atom and a nitrogen atom, i.e., m is an integer of 1 to 5 and n is an integer of 1 to 5. Among them, more preferably m is an integer of 1 to 4 and n is an integer of 1 to 4, and even more preferably m is an integer of 1 to 3 and n is an integer of 1 to 3.

m+n is an integer of 2 to 10 but is preferably an integer of 2 to 5. When the additive is intended to react with the organotin compound (a3) having 4 reactive ligands in the crude product, the value is more preferably an integer of 2 to 4, and particularly preferably 2 or 3, in terms of the suitable number of coordination sites and the increased possibility of selective reaction. If the value of m+n is too high, there are too many sites for coordination or reaction with the organotin compounds, which may cause oligomerization or gelation, or the target organotin compound (a1) may be simultaneously adsorbed, reducing the yield. In addition, in the method described below, the additive (b2) having m+n of 2 to 4 may be more efficiently utilized by controlling its amount appropriately according to the amount of the target impurities or by combined use of an appropriate organic solvent.

The number of carbon atoms between the respective oxygen atoms and/or nitrogen atoms of the additive (b2) is preferably 1 to 3, and more preferably 2. With such a carbon number, when one oxygen atom or nitrogen atom of the additive (b2) is coordinated to an organotin compound, it is possible to create a state in which the second oxygen atom or nitrogen atom is easily reactive due to distance.

The additive (b2) is preferably a compound having at least one nitrogen atom with high electron density (for example, a nitrogen atom with two or three carbon atoms bonded thereto) and at least one OH group. Such an additive (b2) has high ability to coordinate with the organotin compound and high reactivity, and therefore can efficiently remove byproducts such as the organotin compound (a3). Examples of such an additive are diethanolamine, N-methyldiethanolamine, 2-methoxyethylaminoethanol (CH₃OCH₂CH₂NHCH₂CH₂OH), triethanolamine ((HOCH₂CH₂)₃N), N,N-bis(2-hydroxyethyl)ethylenediamine ((HOCH₂CH₂)₂NCH₂CH₂NH₂), and the like.

Specific examples thereof when m is from 0 to 3, n is from 0 to 3, and m+n is 2 or 3 are the same as those of the additive (b1) described above.

Where m+n is 4

When m is 1 and n is 3, examples of the additive (b2) are triethanolamine ((HOCH₂CH₂)₃N), tripropanolamine, tributanolamine, and the like.

When m is 2 and n is 2, examples of the additive (b2) are ethylene glycol bis(2-aminoethyl ether) (H₂NCH₂CH₂OCH₂CH₂OCH₂CH₂NH₂), and the like.

When m is 3 and n is 1, examples of the additive (b2) are N-2-hydroxyethyldiethylenetriamine (HOCH₂CH₂NHCH₂CH₂NHCH₂CH₂NH₂), and the like.

When m is 4 and n is 0, examples of the additive (b2) are triethylenetetramine (H₂NCH₂CH₂NHCH₂CH₂NHCH₂CH₂NH₂), and the like.

When m is 0 and n is 4, examples of the additive (b2) are 1,4-bis(2-hydroxyethoxy)-2-butyne (HOCH₂CH₂OCH₂C≡CCH₂OCH₂CH₂OH), triethylene glycol (HOCH₂CH₂OCH₂CH₂OCH₂CH₂OH), and the like.

Where m+n is 5

When m is 1 and n is 4, examples of the additive (b2) are N-methyl-N-bis[2-(2-hydroxyethoxy)ethyl]amine (HOCH₂CH₂OCH₂CH₂N(CH₃)CH₂CH₂OCH₂CH₂OH), and the like.

When m is 2 and n is 3, examples of the additive (b2) are N-hydroxyethyl-N′-hydroxyethoxyethylethylenediamine (HOCH₂CH₂NHCH₂CH²NHCH₂CH₂OCH₂CH₂OH), and the like.

When m is 3 and n is 2, examples of the additive (b2) are 2-[(2-aminoethyl)[2-[(2-hydroxyethyl)amino]ethyl]amino]ethanol (H₂NCH₂CH₂N(CH₂CH₂OH)CH₂CH₂NHCH₂CH₂OH), and the like.

When m is 4 and n is 1, examples of the additive (b2) are N-2-hydroxyethyltriethylenetetramine (HNCH₂CH₂NHCH₂CH₂NHCH₂CH₂NHCH₂CH₂OH), and the like.

When m is 5 and n is 0, examples of the additive (b2) are N,N,N′,N′-tetrakis(aminoethyl)diethylenetriamine ((H₂NCH₂CH₂)₂NCH₂CH₂NCH₂CH₂N(CH₂CH₂NH₂)₂), and the like.

When m is 0 and n is 5, examples of the additive (b2) are tetraethylene glycol (HOCH₂CH₂OCH₂CH₂OCH₂CH₂OCH₂CH₂OH), and the like.

When m+n is 6, examples of the additive (b2) are N,N,N′,N′-tetrakis(2-hydroxyethyl)ethylenediamine ((HOCH₂CH₂)₂NCH₂CH₂N(CH₂CH₂OH)₂), and the like.

When m+n is 7, examples of the additive (b2) are N,N,N′,N′,N″-pentakis(2-hydroxypropyl)diethylenetriamine ((CH₃CH(OH)CH₂)₂NCH₂CH₂N(CH₂CH(OH)CH₃)CH₂CH₂N(CH₂CH(OH)CH₃)₂).

When m+n is 8, examples of the additive (b2) are bis(di-2-hydroxyethylaminoethyl)ethylene glycol ((HOCH₂CH₂)₂NCH₂CH₂OCH₂CH₂OCH₂CH₂N(CH₂CH₂OH)₂).

When m+n is 9, examples of the additive (b2) are N,N,N′,N′-tetrakis(2-hydroxyethyl)tetraethylenepentamine ((HOCH₂CH₂)₂NCH₂ CH₂NHCH₂CH₂NHCH₂CH₂NHCH₂CH₂N(CH₂CH₂OH)₂).

When m+n is 10, examples of the additive (b2) are N, N, N′,N′-tetrakis(2-hydroxyethoxyethyl)ethylenediamine ((HOCH₂CH₂OCH₂CH₂)₂NCH₂CH₂N(CH₂CH₂OCH₂CH₂OH)₂).

In some non-limiting examples of the additive (b2), m may be 0, 1, 2 or 3, n may be 0, 1, 2 or 3, m+n may be 2 or 3, and x+y may be 1 or greater. Examples of the additive (b2) that satisfy this condition are diethanolamine, N-(2-hydroxyethyl)ethylenediamine, and N-(2-aminoethyl)-1,2-ethanediamine, and the like.

In some non-limiting examples, the additive (b2) may have both nitrogen atoms and oxygen atoms. Of them, non-limiting examples of hydrocarbon compounds that can be used as the additive (b2) are diethanolamine (DEA), ethanolamine, N-methyldiethanolamine, and the like.

The purity of the additive (b2) is not particularly limited but is preferably 98 wt % or higher, more preferably 98.5 wt % or higher, and even more preferably 99 wt % or higher. The higher the purity of the additive (b2), the less likely side reactions caused by additive impurities will occur, which is desirable. The impurities such as compounds having alcohol or amine structures unlike the structure of the additive (b1), such as water, methanol, ethanol, methylamine, and ethylamine, which react with the organotin compound (a1), are problematic. The content of such impurities is preferably 2 wt % or less, more preferably 1.5 wt % or less, even more preferably 1.0 wt % or less, and even more preferably 0.5 wt % or less. In particular, moisture gets into the additive from air, so stricter management is required, and the amount of moisture is preferably 0.5% or less, more preferably 0.3%, and still more preferably 0.1% or less

When the additive (b2) is selected, the organotin compound (a1) having a purity of 95 mol % or higher can be recovered by filtering, adsorbing, decanting, distilling, etc., of the mixture (x2) containing the crude product and the additive (b2). Since the organotin compound (a3) in the crude product easily react with or be adsorbed by the additive (b2), the mixture (x2) is in a state in which, compared to that without the additive (b2), the organotin compound (a3) of the impurities is particularly easy to be removed by distillation. Thus, it is possible to obtain the organotin compound (a1) having a purity of 95 mol % or more.

The content of the additive (b2) in the mixture (x2) is 150-1000 mol % when the content of the organotin compound (a3) is 100 mol %. When the content of the organotin compound (a3) is taken as 100 mol %, the content of the additive (b2) in the mixture (x2) is preferably 180-800 mol %, more preferably 200-500 mol %, further preferably 250-400 mol %, and still more preferably 300-400 mol %. The content here means the content of the additive (b2) in the final mixture (x1) after all additions have been completed. The additive (b2) may be added slowly until it reaches the desired content, or after adding a portion of it, it may be added again after thorough stirring (divided addition). Divided addition is preferred, particularly when considering stirrability and uniformity of the mixture. When the content is optimally controlled, the addition is preferably conducted in divided batches while the contents of impurities such as the organotin compound (a3) are measured as appropriate. On the other hand, if the divided addition takes too long, decomposition of the organotin compound (a1) may occur or gelation may occur.

When the content of the additive (b2) in mixture (x2) is not lower than the lower limit of the above-mentioned numerical ranges, the reaction or adsorption of the organotin compound (a3) with/to the additive (b2) is further promoted. When the content of the additive (b2) in the mixture (x2) is not higher than the upper limit of the above-mentioned numerical ranges, the side reaction with the organotin compound (a1) is suppressed, and the yield of the organotin compound is further improved.

### Additive (b3)

The additive (b3) is a polymer resin having sulfur atoms. The polymer resin may be a homopolymer or a copolymer.

In some non-limiting preferred embodiments, the polymer resin having sulfur atoms may have a thiol functional group. In some other non-limiting embodiments, the polymer resin having sulfur atoms may have a disulfide functional group, a thioketone functional group, an isothiocyanate functional group, etc., instead of a thiol functional group.

In some non-limiting preferred embodiments, the polymer resin having sulfur atoms may have units based on a monomer having a styrene skeleton. In some other non-limiting embodiments, the polymer resin having sulfur atoms may have units based on an ethylene monomer, a propylene monomer, or units based on a monomer such as acrylic acid, methacrylic acid, an acrylic acid ester, or a methacrylic acid ester, instead of the units based on a monomer having a styrene skeleton.

The weight average molecular weight of the polymer resin having sulfur atoms is not particularly limited. In some non-limiting preferred examples, the weight average molecular weight of the polymer resin having sulfur atoms may be 1,000-1,000,000, 1,000-30,000, or 1,000-10,000.

The purity of the additive (b3) is not particularly limited but is preferably 98 wt % or higher, more preferably 98.5 mol % or higher, and even more preferably 99 wt % or higher. Combined use of the additive (b2) and an organic solvent

The details and preferred examples of the additive (b2) have already been described. In some non-limiting examples, for example, when a highly viscous additive is used as the additive (b2), preferably it is used in combination with an organic solvent to improve dispersibility. At this time, the organotin compound (a1) having a purity of 95 mol % or higher is recovered by filtration, adsorption, decantation, distillation, etc., of the mixture (x4) containing the crude product, the additive (b2), and the organic solvent. On the other hand, it is preferable not to use an organic solvent so that the step of removal of the organic solvent by distillation can be omitted.

In some non-limiting examples, the content of the organic solvent in the mixture (x4) is 100 parts or more by mass when the additive (b2) is 100 parts by mass. The content of the organic solvent in the mixture (x4) may be 100-1000 parts by mass, 100-500 parts by mass, or 100-300 parts by mass. If the amount of the solvent is too small relative to the additive (b2), its compatibility with the tin compound may not be satisfactorily improved, and the purification effect may be satisfactory. If the amount of the solvent is too large, the productivity may decrease, or the concentration of the additive (b2) in the mixture (x4) may decrease such that it may not have a satisfactory effect.

In some non-limiting examples, the mixture (x4) may be prepared by stirring the crude product and a premixture of the organic solvent and the additive (b2) to mix them.

In some non-limiting examples, the solubility of the organotin compound (a1) in the organic solvent at 20° C. may be 10% by mass or higher, and the solubility of the additive (b2) in the organic solvent at 20° C. may be 10% by mass or higher.

Here, an ideal organic solvent shall be compatible with both the organotin compound (a1) and the additive (b2) and shall not be reactive with the organotin compound. In consideration of these, non-limiting examples of the organic solvent include a hydrocarbon solvent, an ether solvent, and an ester solvent. For versatility, an ether solvent is preferred.

The larger the values of m and n of the additive (b2), the higher the polarity and hydrogen bonding ability, and therefore, a more polar solvent is preferred. On the other hand, the smaller the values of m and n of the additive (b2), a more non-polar solvent is preferred.

When m+n of the additive (b2) is 2 or less, the organic solvent is preferably a hydrocarbon solvent or an ether solvent.

When m+n of the additive (b2) is greater than 2, the organic solvent is preferably an ether solvent or an ester solvent.

Examples of the hydrocarbon solvent are pentane, hexane, heptane, octane, nonane, decane, undecane, dodecane, cyclohexane, methylcyclohexane, benzene, toluene, xylene, decalin, and the like.

Examples of the ether solvent are diethyl ether, diisopropyl ether, t-butyl methyl ether, tetrahydrofuran, methyltetrahydrofuran, methoxycyclopentane, dioxane, 4-methyltetrahydropyran, ethylene glycol dimethyl ether, diethylene glycol dimethyl ether, and the like.

Examples of the ester solvent are ethyl acetate, propyl acetate, isopropyl acetate, butyl acetate, and the like.

The organic solvent may be used alone or two or more organic solvents may be used in combination.

In some non-limiting examples, at least 50 wt % or more of the organic solvent may be an ether solvent.

In some non-limiting examples, the water content of the organic solvent may be 100 ppm or less, 50 ppm or less, 30 ppm or less, or 20 ppm or less by weight.

### Distillation

In the distillation of the crude product, the purity of the organotin compound (a1) can be increased by removing impurities having boiling points close to its boiling point while preventing the decomposition of the organotin compound (a1). For this purpose, it is important to optimize the equipment and conditions involved in the distillation. The following are some points that may be considered in commercial and practical industrial production. Quality of the crude product before distillation:

Particularly, in commercial and practical industrial production, it is desirable to optimize the reaction conditions for producing the crude product, the conditions for post-treatment after producing the crude product, the purity of the organotin compound (a1) in the crude product, and the amount of metal and the amount of the solvent contained in the crude product.

### Distillation Still:

Particularly, in commercial and practical industrial production, it is desirable to optimize the material, shape and capacity of the distillation still, the heat transfer area of the distillation still, the stirring blades in the distillation still, and the stirring speed of the stirring blades.

### Distillation Column:

Particularly, in commercial and practical industrial production, it is desirable to optimize the height, diameter, and theoretical number of stages of the distillation column. In addition, it is desirable to optimize the shape, material, separation performance, and surface area of the packing in the distillation column, the amount of packing, and the time of stay in the packing.

### Distillation Conditions:

Particularly, in commercial and practical industrial production, it is desirable to optimize the reflux ratio (cooling temperature and extracting time), extracting rate, boiling amount, temperature (external temperature and internal temperature), time (heating time and distillation time), degree of vacuum during distillation, and pressure loss during distillation.

### Other Facilities and Conditions:

Particularly, in commercial and practical industrial production, it is desirable to optimize the method of fractionating the distillate into fractions, the method of extracting the distillate, the location for extracting the distillate, and the light shielding conditions. In addition, it is desirable to consider distillation under an inert atmosphere, packing the fractions under an inert atmosphere, packing method, the number of distillations, and whether to select continuous distillation or batch distillation in commercial and practical industrial production.

### Distillation Equipment

The distillation equipment is not particularly limited as long as it is capable of purifying an organotin compound by distillation. In some non-limiting examples, the distillation equipment is heating equipment, distillation purification equipment, and pressure reduction equipment.

In some non-limiting examples, the heating equipment may include a distillation still, etc.

In some non-limiting examples, the distillation purification equipment may include a distillation column, a reflux condenser, a fractionation device, etc.

In some non-limiting examples, the pressure reduction equipment may include a vacuum pump, etc.

In some non-limiting examples, the distillate after distillation may be divided into a plurality of fractions. By dividing into a plurality of fractions, the purity of each fraction can be analyzed. By selecting a fraction with a higher purity from among the plurality of fractions, it is possible to collect the organotin compound (a1) with a higher purity.

The material of the distillation still (the inside of the still and the stirring blades) is not particularly limited. In some non-limiting examples, preferably it is fluororesin, glass, SUS (Stainless Steel), or the like. Glass is preferred for preventing metal contamination. SUS is preferred in consideration of strength and thermal conductivity.

The shape and capacity of the distillation still can be set arbitrarily according to the volume for distillation. In some non-limiting examples, to perform distillation efficiently, preferably the capacity is 100 mL or more, and more preferably 1 L or more. Depending on the shape and capacity of the still, the heat transfer area (surface area of the heat transfer part) may vary.

Examples of the shape of the stirring blade of the distillation still are a paddle, anchor, twin star, ribbon, three-blade swept-back, log bone, full zone, and Maxblend®. A paddle, twin star, and three-blade swept-back are preferred because great stirring power can be obtained whether the liquid amount is large or small. By installing multiple stirring blades, it is possible to expect an improvement in stirring capacity. When using a stirrer, a stirrer that is large enough for the liquid amount is preferred.

The stirring speed (number of rotations) varies depending on the size and shape of the stirring blade. In some non-limiting examples, the stirring speed is preferably 50 rpm or higher, more preferably 100 rpm or higher, and even more preferably 150 rpm or higher.

When the stirring speed (rotation speed) is high, the liquid is easily dispersed in a thin film on the inner wall surface of the distiller, so distillation is quick. As a result, it can contribute to shortening the distillation time. In addition, if heated, the solution will have an increased in its diffusion, which will reduce the unevenness in temperature during distillation. As a result, it can contribute to preventing decomposition of the organotin compound that occurs in the higher temperature part close to the jacket temperature. If the stirring speed is increased, it is easy to achieve distillation in a shorter time or at a lower temperature, making is easy to obtain the organotin compound (a1) with a high purity.

### Distillation Column

The theoretical number of stages of the distillation column is not limited as long as it is enough for separating the impurities. When the boiling point of the organotin compound (a1) is particularly close to the boiling points of the impurities and separation is difficult, preferably there are 5 stages or more, and more preferably 10 stages or more. On the other hand, if the theoretical number of stages is too large, remember that the distillation takes time, and as a result, decomposition of the organotin compound (a1) may be promoted, and the distillation rate may decrease, resulting in a decrease in productivity. Therefore, in some non-limiting examples, the theoretical number of stages of the distillation column is preferably 100 stages or less, more preferably 70 stages or less, and even more preferably 50 stages or less. It shall also be considered that the larger the theoretical number of stages of the distillation column, the larger the distillation equipment, and therefore the likely higher equipment cost. From the viewpoint of equipment cost, preferably the theoretical number of stages is on the small side within the range that satisfies the required distillation capacity.

The packing and structure in the distillation column are not particularly limited, but in consideration of increasing the theoretical number of stages and reducing the pressure loss, a structure packed with structured packing is preferred. The packing material is preferably glass or SUS.

Examples of suitable packing materials are Sulzer Packing (Gauze packing and other products), Sulzer laboratory packing, Mellapak, Flexipac, Goodloe Packing, Rombopak, etc. In consideration of increasing the theoretical number of stages and reducing the pressure loss, Sulzer Packing (Gauze packing and other products) and Sulzer laboratory packing are preferred.

In some non-limiting examples, the HETP (m/stage) of the packing under distillation conditions is preferably 1.0 or lower, more preferably 0.8 or lower, further preferably 0.5 or lower, and particularly preferably 0.3 or lower.

The lower the HETP, the lower the pressure loss. In addition, by reducing the height of the distillation column, the distillation time can be shortened and distillation can be achieved at a lower temperature, making it easier to obtain the organotin compound (a1) with a high purity.

To control the temperature inside the distillation column, to improve the productivity of distillation, and to improve the purity of the organotin compound (a1), heat-retaining equipment and heating equipment may be used in combination with the distillation column.

The heat-retaining equipment may be, for example, a vacuum insulation jacket, a heat-retaining material, a heat insulating material, etc., but from the viewpoint of heat-retaining effect, a vacuum jacket is preferred.

Examples of heating equipment are an internal heater (internal coils, heat exchanger, etc.), external heater (sheet heater, tape heater, etc.), heat medium jacket, and hot air heating equipment (dryer, etc.). In consideration of local temperature control, an external heater is preferred.

By providing both heat-retaining equipment and heating equipment, more effective temperature control will be possible. In particular, to purify a compound that may be decomposed by heating during distillation, such as the organotin compound (a1), the start-up time of the distillation (the operation of filling the distillation column with a liquid and stabilizing it) may be shortened. In addition, the distillation rate, which will be described later, may be increased, so that the organotin compound (a1) with a higher purity may be easily obtained.

More preferably, when heat-retaining equipment and/or heating equipment is used in combination with a distillation column packed with structured packing, there is a synergistic effect that can further shorten the distillation time and achieve distillation at a lower temperature, so that it is easier to obtain the organotin compound (a1) with a high purity. Examples of structured packing and their HETPs have already been described.

The distillation column may further be provided with heat insulating equipment.

### Distillation Conditions

The conditions for distillation are described below. Regarding the distillation conditions, individual equipment and suitable conditions may be combined to obtain the organotin compound (a1) with a higher purity. By combining specific distillation equipment and distillation conditions, a synergistic effect may be obtained, resulting in higher purification efficiency and productivity.

Although distillation can be performed without controlling the reflux ratio, proper control of the reflux ratio can increase the separation efficiency and shorten the distillation time. The method for controlling the reflux ratio is not particularly limited, and it can be controlling the time for opening/closing the outlet, controlling the reflux/distillate flow rate, etc.

Here, for example, “reflux ratio 10” means that the extracting amount and the reflux amount are controlled at a ratio of 1:10.

In some non-limiting examples, the lower limit of the reflux ratio is preferably 0.1 or higher, more preferably 1 or higher, and even more preferably 3 or higher. If the reflux ratio is not lower than the lower limit, it is easy to ensure distillation efficiency, and therefore it is easy to prevent the inclusion of impurity fractions.

In some non-limiting examples, the upper limit of the reflux ratio is preferably 200 or lower, more preferably 150 or lower, and even more preferably 100 or lower. When the reflux ratio is not higher than the upper limit, the distillation time is unlikely to be prolonged. Therefore, it is easy to prevent decomposition of the organotin compound or a decrease in the distillation rate, so that the productivity is improved.

The distillation time is not limited by the scale or equipment of the distillation, but preferably the distillation time is as short as possible within the range that ensures productivity.

In some non-limiting examples, the distillation time is typically 200 hours or less, preferably 100 hours or less, and more preferably 50 hours or less.

In some non-limiting examples, the lower limit of the distillation time is preferably 1 hour or more, and more preferably 10 hours or more.

The distillation time refers to the time of distillation until the target purity condition is met.

The heating time during distillation is preferably as short as possible within the range that ensures productivity. In some non-limiting examples, the heating time during distillation is usually 200 hours or less, preferably 100 hours or less, and more preferably 50 hours or less.

The distillation temperature refers to the temperature of the solution in the still during distillation. The distillation temperature also depends on the boiling point of the target product and other distillation conditions.

In some non-limiting examples, the lower limit of the distillation temperature is preferably 20° C. or higher, more preferably 30° C. or higher, and even more preferably 50° C. or higher. If the distillation temperature is too low, the amount of distillate is too small, and the distillation may take longer than necessary, and as a result, the separation performance tends to decrease.

In some non-limiting examples, the upper limit of the distillation temperature is preferably 200° C. or lower, more preferably 180° C. or lower, and even more preferably 150° C. or lower. If the distillation temperature is too high, the organotin compound may decompose, and in addition, the amount of distillate will be too large, and flapping may occur in the distillation column, resulting in decreased separation performance.

As already explained, the distillation temperature refers to the internal temperature during distillation. In addition to the distillation temperature (internal temperature), temperatures at various locations, such as the jacket temperature (heat medium temperature) and the column top temperature of the distillation column may also affect the decomposition rate of the organotin compound (a1).

In some non-limiting examples, from the viewpoint of separation performance, the difference between the jacket temperature and the distillation temperature (internal temperature) is preferably 3-40° C., more preferably 5-30° C., and even more preferably 10-20° C.

In some non-limiting examples, the cooling temperature by the cooling condenser at the top of the distillation column is preferably not higher than the boiling point of the organotin compound (a1), and more preferably 10-70° C. lower than the boiling point of the organotin compound (a1).

In some non-limiting examples, the temperature difference between the cooling temperature of the condenser and the boiling point of the organotin compound (a1) is preferably within 50° C., more preferably within 30° C., and even more preferably within 10° C. If the temperature is excessively cooled, there is a concern that the organotin compound may precipitate in the distillation column, and further, with the further cooling of the distillation still, it is expected that the jacket temperature will be increased more than necessary.

The boiling point of the organotin compound (a1) is relatively high under normal pressure. Therefore, the distillation of the crude product is basically conducted under reduced pressure conditions. The pressure at this time is preferably as low as possible so that the distillation can be conducted at the lowest possible temperature such that the organotin compound (a1) will not be decomposed.

In some non-limiting examples, the pressure is preferably 100 torr or lower, more preferably 50 torr or lower, even more preferably 20 torr or lower, particularly preferably 15 torr or lower, particularly preferably 10 torr or lower, and particularly preferably 5 torr or lower. On the other hand, under conditions requiring a particularly high degree of separation or conditions of an increased scale, the pressure is preferably 0.01 torr or higher, more preferably 0.1 torr or higher, and even more preferably 1 torr or higher, taking into consideration the performance of the vacuum pump and the pressure loss of the distillation column.

Now, total reflux will be explained. The state, in which all the cocks are closed and all the distillate is refluxed without any distillation extraction, is called “total reflux”. Before starting the distillation, heating may be done under total reflux conditions before various distillation conditions are stabilized.

In some non-limiting examples, the total reflux time is preferably 20 hours or less, more preferably 10 hours or less, even more preferably 8 hours or less, and particularly preferably 5 hours or less. If the total reflux time is too long, decomposition tends to be accelerated. On the other hand, as the scale of distillation increases, the time required to fill the distillation column with the liquid and reach the appropriate distillation conditions increases, so if the time is too short, the separation efficiency of distillation may be lowered. In that case, the lower limit of total reflux time is preferably 1 hour or more, and more preferably 3 hours or more.

The distillation rate is a rate based on the distillation ratio expressed by:

$$Distillation ratio [ \% ] = Extracted mass [ g ] / fed {mass [ g ]}^{′} 100$$

$$Distillation rate [ \% / h ] = Extracting ratio [ \% ] / extracting time [ h ]$$

The extracting time refers to the time during which distillation is taking place and which does not include the time when the distillate amount is zero or the holding time under total reflux conditions. The distillation rate can be calculated from the total distillate amount and distillation time during distillation, but it can also be calculated from the distillation time and distillate amount of each fraction.

In some non-limiting examples, the distillation rate (%/h) is preferably 1 or higher, more preferably 2 or higher, even more preferably 3 or higher, particularly preferably 4 or higher, and especially preferably 5 or higher. If the distillation rate is too low, the distillation time will be long, decomposition will occur during distillation, and the purity of the obtained fraction tends to decrease. Also, from the viewpoint of distillation productivity, a high distillation rate is preferred. On the other hand, if the distillation rate is too high, the solution will accumulate too much in the distillation column, causing flapping and making the separation difficult.

The distillation mode and the configuration of the device are not particularly limited. For example, both batch distillation and continuous distillation are applicable distillation modes. However, batch distillation is preferred from the viewpoint of recovering high-purity fractions, and continuous distillation may be preferred from the viewpoint of yield. In addition, for efficient purification, distillation may be performed multiple times or multiple distillation equipment may be combined. In addition, the feeding position of the distillate or the extracting position of the distillate may be changed.

### Other Disclosure

The crude product is unstable when exposed to water and air. Therefore, preferably the distillation operations and the filling of a fraction into a storage container are carried out under an inert gas atmosphere. For example, when recovering a fraction, preferably it is recovered into a connected storage container under an inert gas atmosphere. It is also preferable to transfer it to a storage container while maintaining the inert gas atmosphere. Sampling and composition analysis are also preferably carried out under an inert gas atmosphere.

The crude product may be unstable when exposed to light. Therefore, it is preferable to handle the crude product protected from light. In some non-limiting examples, the mixing of the crude product with the additives and the subsequent distillation are carried out under conditions protected from light.

In some non-limiting examples, SUS device may be used at all positions such as the still, distillation column, and fractions, or a light-shielded glass device (e.g., amber glass or glass device shielded from the surroundings) may be used. In addition, the light shielding is not particularly limited and any technique known in the art can be used, such as enclosing the equipment in a light-shielding cover such as cloth, foil, or film, using a light-shielding coating, carrying out distillation in a dark room, etc.

Purity after Purification

In some non-limiting examples, the purified tin compounds contain the organotin compound (a1) of a purity of 95 mole % or higher.

The higher the purity (content) of the purified organotin compound (a1), the better the performance of the resist made with it. Therefore, the purity of the purified organotin compound (a1) may be 96 mol % or higher, 97 mol % or higher, 98 mol % or higher, 99% mol % or higher, 99.2 mol % or higher, 99.5 mol % or higher, 99.8 mol % or higher, 99.9 mol % or higher, etc.

On the other hand, if the purity of the organotin compound is too high, the organotin compound may be decomposed or become unstable during storage or during use due to the disproportionation reaction of the substituent R³ of the organotin compound. Taking this into consideration, the purity of the organotin compound (a1) after purification may be, for example, no higher than 99.9 mol %.

Here, the above-mentioned purity expressed as mole % based on the weight of tin atoms is the ratio of the number of tin atoms of the target compound to the number of tin atoms of all the compounds having tin atoms (including unidentified compounds). In practice, it is calculated by using the sum of the integral values of all peaks observed by ¹¹⁹Sn-NMR as the denominator and the integral value of the peak of the target compound as the numerator.

According to this calculation method, only compounds having tin atoms are included in the calculation. Even if an additive or a solvent is added to the purified tin compounds and the purified tin compounds containing the organotin compound (a1) and other organotin compounds as impurities are, strictly speaking, a composition, the composition can be used as the organotin compound (a1).

According to the method of analysis by ¹¹⁹Sn-NMR, to improve the sensitivity, the analysis is performed without diluting the organotin compounds, and the results can be obtained using the conditions of a large number of integrations (1000 integrations or more, preferably 10000 integrations or more), sufficient relaxation time (1 second or more), and reverse gate decoupling. As a result, the detection limits of impurities (organotin compound (a2), organotin compound (a3), organotin compound (a4), etc.) can reach 0.01 mol %. No detection of peak by ¹¹⁹Sn-NMR is equivalent to a detection limit of 0.01 mol % or lower.

If the sensitivity of the peak detection is still not high enough, a high-sensitivity NMR can be used. For example, by using a cryoprobe with a 600 MHz NMR, the detection sensitivity can be further increased, and detection of 0.001 mol % is possible.

### Amounts of Impurities in the Refined Tin Compounds

Regarding the amounts of impurities in the purified tin compounds, organotin compound (a2), organotin compound (a3), and organotin compound (a4) as impurities are disclosed here.

In some non-limiting examples, the content of the organotin compound (a2), based on the weight of its tin atoms in the purified tin compounds, is preferably 3 mol % or lower, more preferably 2 mol % or lower, even more preferably 1 mol % or lower, 0.5 mol % or lower, 0.3 mol % or lower, 0.1 mol % or lower, 0.05 mol % or lower, and particularly preferably 0.01 mol % or lower.

Too much organotin compound (a2) leads to reduced crosslinking ability and reduced toughness when used in EUV lithography resists. The organotin compound (a2) can cause outgassing when the photoresist is exposed to extreme UV radiation. In extreme circumstances, it can also lead to degradation of very expensive multi-coated optical components.

In some non-limiting examples, the content of the organotin compound (a3), based on the weight of its tin atoms in the purified tin compounds, is preferably 3 mol % or lower, more preferably 2 mol % or lower, even more preferably 1 mol % or lower, 0.5 mol % or lower, 0.3 mol % or lower, 0.1 mol % or lower, and particularly preferably 0.01 mol % or lower.

If the content of the organotin compound (a3) is too high, when the resist material is formed by hydrolysis or the like, crosslinking ability will be too high, which may cause gelation or generation of nonhomogeneous aggregates, leading to decreased adhesion or increased roughness.

In some non-limiting examples, the content of the organotin compound (a4) based on the weight of its tin atoms in the purified tin compounds is preferably 3 mol % or lower, more preferably 2 mol % or lower, even more preferably 1 mol % or lower, 0.5 mol % or lower, 0.3 mol % or lower, 0.1 mol % or lower, and particularly preferably 0.01 mol % or lower.

If the content of the organotin compound (a4) is too high, when the resist material is subjected to hydrolysis or the like, the hydrolysis reactivity varies, which may result in poor crystallinity or generation of nonhomogeneous aggregates, leading to decreased adhesion or increased roughness.

In some non-limiting examples, other impurities may include polyalkyl compounds such as R₃SnX³ and R₄Sn, divalent organotin compounds such as SnX³₂, and tin oxides having an RSnO structure produced by hydrolysis, etc. The amount of each of these impurities, based on the weight of its tin atoms in the purified tin compounds is preferably 2 mol % or lower, more preferably 1 mol % or lower, 0.5 mol % or lower, 0.3 mol % or lower, 0.1 mol % or lower, and even more preferably 0.01 mol % or lower.

### Storage

In some non-limiting examples, the purified tin compound can maintain the high purity for extended periods of time, so it is particularly suitable for storage and/or transportation as well as for keeping in containers.

In some non-limiting examples, the purified tin compound can be stored for a short time or a long time, such as from about 3 days to about 1 year, under conditions of substantially no exposure to light and temperatures of no higher than about 30° C. For example, the purified tin compound can be stored for a period from about 1 week to about 10 months, from about 2 weeks to about 6 weeks, and for any period desired.

By “substantially no exposure to light” it is meant that the purified tin compound is protected from light as much as possible, such as by storing it in an amber or stainless-steel container. In some examples, the purified tin compound (i.e., the high-purity organotin compound (a1)) is substantially not decomposed after a storage period from about 3 days to about 1 year, as described above.

In some non-limiting examples, the storage temperature of the purified tin compound is preferably about 30° C. or lower, more preferably about 25° C. or lower, and even more preferably about 20° C. or lower. The lower limit of the storage temperature is preferably not lower than about −10° C.

### Uses of the Organotin Compound (a1)

A purified tin compound containing the high-purity organotin compound (a1) is useful as a material for making EUV resists and the like.

In some non-limiting examples, the purified tin compound can be diluted with a solvent as necessary and be used as a composition containing the organotin compound (a1). It is preferable to dilute the purified tin compound with a solvent to apply or deposit it as a resist material. The solvent is not particularly limited but is preferably, for example, an organic solvent such as an alcohol solvent, an ether solvent, a ketone solvent, an amide solvent, or an ester solvent, and more preferably, an alcohol solvent. These solvents can be used alone or two or more of them can be used in combination.

The alcohol-based solvent may be, for example, an aliphatic or alicyclic alcohol, and it may be a monoalcohol or a polyhydric alcohol, and a partial ether of polyhydric alcohol solvent, and the like can also be used. The number of carbon atoms of the solvent is not particularly limited and may be, for example, 2-18.

Preferably, the solvent itself does not contribute metal contaminants.

The amount of the solvent used is preferably 0.01-30 parts by mass, more preferably 0.1-20 parts by mass, and even more preferably 1-10 parts by mass, per part by mass of the purified tin compound.

The purified tin compound may be used as a resist material after undergoing a reaction such as hydrolysis. The method of using it as a resist material may be, for example, the method disclosed in the JP-A2021-21953. The tin compound contains a group that can be hydrolyzed with water or another suitable reagent under appropriate conditions to form an alkyl oxo-hydroxo tin patterning composition that can be represented by the formula RSnO_{(3/2-x/2)}(OH)ₓ (wherein 0<x≤3). The hydrolysis and condensation reactions that can change the precursor compound into the patterning composition by the hydrolyzable group (X³) are shown in the following reactions.

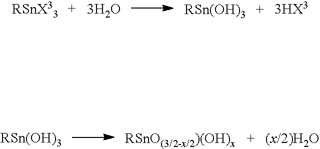

An alkyl oxo-hydroxy tin compound is produced by hydrolysis of the organotin compound (a1) (or a composition containing the organotin compound (a1)) as a raw material. The alkyl oxo-hydroxy tin compound is represented by RSnO_{(3/2-X/2)}(OH)ₓ and is sometimes referred to as the “organotin compound p1” hereinafter. The organotin compound p1 can be used as an EUV resist material.

The method for obtaining the tin compound p1 by hydrolysis of the organotin compound (a1) (or a composition containing the organotin compound (a1)) may be, for example, a method in which water vapor or the like is made to react with a vapor generated by evaporating the organotin compound (a1) under heating or a reduced pressure or with a substrate on which the organotin compound (a1) is vapor-deposited (dry method). In this method, a thin membrane (film) containing the organotin compound p1 can be formed on a thin membrane (film) substrate.

There is a method in which the organotin compound (a1) (or a composition containing the organotin compound (a1)) is made to react with water or the like while being in a solution or solid state to conduct hydrolysis, thereby obtaining the organotin compound p1. Then, the organotin compound p1 can be used as a coating solution by dissolving it in an organic solvent or the like. The alkyl oxo-hydroxy tin compound (p 1) can be produced in the same way from monoalkyl tin compounds (1), (A1), and (A11), which are compounds of the same type as (a1). This solution can be applied to a substrate by any coating or printing technique to form a thin film (coating film) containing the organotin compound p1 on the substrate.

The film obtained by any of the above methods may be dried, heated, etc., to stabilize or partially condense it prior to exposure to light. Generally, the film is thin, e.g., having an average thickness of no more than 10 microns, although very thin submicron films, e.g., a thickness of about 100 nanometers (nm) or less, even 50 nm or less, and especially 30 nm or less, may be desired for patterning tiny features. The resulting film may be referred to as a “resist” since portions of the composition are resistant to development/etching after they have undergone a treatment by exposure to light.

The thin film can be exposed in a selected pattern or the negative portions of the pattern of the film can be exposed to suitable radiation, e.g., extreme ultraviolet, electron beam, or ultraviolet to form a latent image with developer-resistant regions and developer-soluble regions. After exposure to suitable radiation and prior to development, the thin film can be made to react by heating or another method to differentiate the latent image from non-irradiated regions. The latent image becomes a physical image upon contact with a developer, resulting in the formation of a patterned thin film. The patterned thin film can be further heated to stabilize the remaining film on the surface after the patterning. The patterned thin film can be used as a physical mask to perform further processing, e.g., etching the substrate and/or depositing additional materials according to the pattern. After using the patterned resist as desired, the remaining patterned thin film can be removed at an appropriate point of time in processing, but the patterned thin film can also be incorporated into the final structure.

As described above, in the method for producing a monoalkyltin triamide compound or the like, when the tin compound as a raw material is made to contact and react with a reactant such as a metal amide, the generation of dialkyltin diamide compounds can be suppressed by making SnCl₄ present or by carrying out the contact at a relatively high temperature (10 to 70° C.). Furthermore, by treating with a compound capable of selectively coordinating with or reacting with tin tetraamide, the tin tetraamide can be quenched, and as a result, a monoalkyltin triamide with a high purity can be obtained.

Therefore, it is more effective to use these inventions in combination. For example, (1) SnCl₄ is present during the reaction, and a treatment with an additive is performed after the reaction. (2) The reaction is carried out at a contact temperature of 10 to 70° C., and a treatment with an additive is performed after the reaction. (3) The reaction is carried out at a contact temperature of 10 to 70° C. and in the presence of SnCl₄. (4) The reaction is carried out at a contact temperature of 10 to 70° C. and in the presence of SnCl₄, and a treatment with an additive is performed after the reaction.

The invention will now be described in connection with the following, non-limiting examples.

### GROUP A EXAMPLES

### Example A1: Synthesis and Purification of Isopropyl Tris(Dimethylamido)Tin

Anhydrous hexanes (2.4 kg, 82.74 mol) and n-BuLi (1.24 kg, 4.64 mol, 2.4 M solution in hexanes) were charged into a 316 stainless steel reactor. Dimethylamine (417 g, 9.27 mol) was added subsurface at about 0 to 10° C. The reaction mixture was stirred for an additional four hours while warming to room temperature before tetrachlorotin (11.72 g, 0.5 mmol) and isopropyl trichloro tin (390.5 g, 1.5 mol) in hexanes were added dropwise at −10° C. to 10° C. The resulting mixture was allowed to warm to room temperature over four hours and stirred for an additional four hours at room temperature. The reaction mixture was filtered through sparkler to remove the LiCl byproduct. The salt was rinsed with anhydrous hexanes (2×500 mL). The solvent was removed under reduced pressure to form a crude product.

The crude product sample (50 mL) after concentration contained no detectable amount of iPr₂(NMe₂)₃, 97.89% iPrSn(NMe₂)₃, 0.73% Sn(NMe₂)₄, and some other impurities. To the filtrate, 6.31 g of diethanolamine (0.6 mole) was added before being concentrated under vacuum. The concentrated mixture was distilled with short packed column distillation to remove any byproduct and impurities to yield a product having the following: (¹¹⁹Sn NMR): >99.99% of iPrSn(NMe₂)₃. ¹¹⁹Sn NMR (400 mHz; neat): 6-64.85 ¹H NMR (400 mHz; C₆D₆): δ 2.85 (s. 18H, NCH₃), δ 1.61 (m, 1H, methine), δ 1.27 (d, 6H).

### Example (A2): Synthesis of Isopropyl Tris(Dimethylamido)Tin by Adding SnCl₄ Followed by iPrSnCl₃

Anhydrous hexanes (2.48 kg, 82.74 mol) and n-BuLi (1.24 kg, 4.64 mol, 2.4 M solution in hexanes) were charged into a 22 L reactor. Dimethylamine (417 g, 9.27 mol) was added subsurface at about −10 to 10° C. The reaction mixture was stirred for an additional four hours and continuously cooled to about −20° C. to −15° C. before tetrachlorotin (11.72 g, 0.5 mmol, 50% in hexanes) was added into the reaction mixture followed by adding isopropyl trichloro tin (390.5 g, 1.5 mol in hexanes) dropwise at about −15° C. to −5° C. The resulting mixture was allowed to warm to room temperature over four hours and stirred for an additional four hours at room temperature. The reaction mixture was filtered through sparkler to remove the LiCl byproduct. The salt was rinsed with anhydrous hexanes (2×500 mL). The solvent was removed under reduced pressure to yield a product with no detectable iPr₂(NMe₂)₃, 97.89% iPrSn(NMe₂)₃, 0.73% Sn(NMe₂)₄, and 2.19% photo decomposed byproduct (−84 ppm) by ¹¹⁹Sn NMR.

### Example(A3): Selective Purification of Isopropyl tris(dimethylamido)tin with GT74

To a 100 ml amber flask a 50 g of the sample prepared in Example 2 was transferred to the glovebox and 50 g of AmberSep GT75 was added in 5 portions at room temperature. After addition, the mixture was stirred overnight. After filtration, the sample showed no detectable Sn(NMe₂)₄ and no photo decomposed byproduct in the ¹¹⁹Sn NMR.

### GROUP B EXAMPLES

In the following examples, the tin compounds may be referred to as shown below; their peak shift (ppm) in the ¹¹⁹Sn-NMR is also shown.
iPrSn(NMe₂)₃: isopropyltris(dimethylamido)tin, corresponding to the monoalkyltin compound (A1) (RSnX₃), ¹¹⁹Sn-NMR: −64 ppm—Compound (1)
iPrSnCl₃: isopropyltrichlorotin, corresponding to the raw material tin compound B1 (R²SnY²₃)
LiNMe₂: Lithium dimethylamide, corresponding to the reactant M1 (MX²)
   [Tin Compounds that are Impurities]
iPr₂Sn(NMe₂)₂: a diisopropyl form, ¹¹⁹Sn-NMR: −18 ppm—Compound (2)
Sn(NMe₂)₄: a tetrakisamide form, ¹¹⁹Sn-NMR: −119 ppm—Compound (3)
iPrSn(NMe₂)₂(NMeCHNMe₂)₂, ¹¹⁹Sn-NMR: −82 ppm—Compound (4)
Tin compounds other than compounds (1) to (4): Other impurities

Unless otherwise specified, the following raw materials were used after checking their moisture content.
iPrSnCl₃: purity 99.9% or higher (product purified by distillation)
n-Butyllithium hexane solution (made by Kanto Chemical)
Dimethylamine: made by TCI
Hexane: n-hexane (made by Kanto Chemical), density 0.67 g/cm³

Using the above-mentioned material components, the raw material tin compound B1 is made to react with the reactant M1 or the reactant M2 by the method described below to synthesize a synthetic tin composition P1 mainly composed of the monoalkyltin compound A1.

### Example B1-1

A 100 mL four-neck flask (brown glass) equipped with a tightly sealed magnetic stirring device (stirring blade: crescent shape, diameter 30 mm, material PTFE) and a cooling condenser (cooling water of 10° C.) was used. After the pressure was reduced to 3 kPa or lower, replacement of N₂ was performed three times. Hexane (37.6 mL, measured moisture content 10 ppm) and n-butyllithium (17.3 mL, 11.9 g, 46.1 mmol of 2.66 M hexane solution (25% hexane solution: containing 13.5 mL of hexane, equivalent to 8.9 g) were added at 22° C. and cooled in an ice bath under stirring at 200 rpm. When the temperature reached 0° C., dimethylamine (4.16 g,92.2 mmol) was added dropwise over 15 minutes while the temperature was kept between −5 and 5° C. The obtained lithium dimethylamide slurry (reactant M1) was stirred at a temperature of −5 to 5° C. for 3 h.

The obtained lithium dimethylamide slurry (reactant M1) was heated to 12° C. in a temperature-controlled water bath while it was being stirred at 200 rpm [blade tip speed (m/s)=3.14×0.03×200/60=0.31 (m/s)], the hexane solution (3.1 mL hexane) of 22° C. containing isopropyltrichlorotin (4.00 g, 14.9 mmol) was added dropwise using a syringe pump (15 mL/h) while the temperature (contact temperature T1) was kept in the range of 12-15° C. During this time, the reaction solution was cooled in a jacket (water bath) of 12° C. Given the amount of the organic solvent (S1) used in the reaction (54 M1 hexane, 35.6 g), the concentration of isopropyltrichlorotin (4.00 g, 14.9 mmol) was calculated to be 4.0/(4.0+35.6)×100=10.1%.

Then, after stirring for 16 h while the temperature was kept at 23° C., the obtained reaction solution was filtered under pressurized N₂ for 5 minutes using a SUS pressure filter [light-shielded, PTFE membrane filter (product name: Omnipore JAWP04700, pore size: 1.0 m, diameter: 47 mm)] to remove the white solid (LiCl) and obtain a transparent filtrate. The white solid was further washed with dehydrated hexane (5 mL), and the filtrates were combined in an eggplant-shaped flask, shielded from light by aluminum foil. The obtained reaction solution was stirred while being shielded from light, and the solvent was concentrated under a reduced pressure (80 hPa, 40° C.) until it was confirmed that there was no distillation, thereby obtaining a concentrated solution of a synthetic tin compound containing isopropyl tris(dimethylamido)tin. The obtained concentrated solution was filled into a light-shielded glass container (brown glass container) under an N₂ atmosphere. The results of a content analysis of the tin compound (1) (isopropyl tris(dimethylamido) tin) and the like in the obtained synthetic tin compound are shown in Table 2 below.

### Examples B1-2 to B1-6

The reaction conditions were adjusted as shown in Table 2 below, and the same experiment as in the Example B1-1 was conducted. The results of the content analysis of the obtained synthetic tin compound are shown in Table 2 below.

### Example B1-7: Experiment by Changing the Production Equipment and Scale

Instead of the reaction device of Example B1-1, a reaction device installed in a room shielded from light by a yellow film was used. Specifically, a 200 L glass reactor (inner diameter: 600 mm, jacketed with circulating water), a cooling condenser with an internal coil, and a stirring device (stirring blade: twin star, diameter: 350 mm, width: 110 mm, Teflon (registered trademark) coated SUS, and 50 L glass dropping device) were prepared and used.

After reducing the pressure inside the reactor to 3 kPa or lower, N₂ replacement was performed three times. Hexane (36.6 kg, water content 21 ppm) and n-butyllithium [41.0 kg, 96.8 mol (3.09 eq), 15% hexane solution (containing hexane equivalent to 34.9 kg)] were added and stirred at 150 rpm [stirring blade tip speed (m/s)=3.14×0.35×150/60=2.74 (m/s)], and dimethylamine (8.69 kg, 193.6 mol, 6.18 eq) was added dropwise over 1 h while the temperature was maintained between −5 and 10° C. The resulting lithium dimethylamide slurry was stirred at 23-27° C. for 1 h.

The temperature of the obtained lithium dimethylamide slurry was adjusted to 21° C., and a hexane solution (4.20 kg of hexane) containing isopropyltrichlorotin (8.40 kg, 31.3 moles, 1.00 eq) was added dropwise from a dropping device made of glass over 2 h while the temperature was maintained in the temperature range (internal temperature 21-26° C., and JK temperature 20-25° C.). The dropping device was then washed with hexane (0.61 kg), which was dropped. During the dropping, stirring also continued at 150 rpm [tip speed (m/s)=3.14×0.35×150/60=2.74 (m/s)]. In addition, given the amount of organic solvent (S1) used in this reaction (hexane 40.8 kg), the concentration of isopropyltrichlorotin (8.40 kg, 31.3 mol) was calculated to be 8.4/(8.4+71.0)×100=10.6%.

After the dropping, the mixture was stirred for 16 h while the temperature was maintained. The reaction solution obtained was filtered with a pressure filter to remove the white solid (LiCl) and obtain a transparent filtrate. The white solid was further washed with dehydrated hexane (7.3 kg×3), and the filtrates were combined. The reaction solution obtained was concentrated under a reduced pressure. The concentrated solution obtained (10.3 kg) was filled into a light-shielded glass container under a N₂ atmosphere. The results of the content analysis of the tin compound (1) (isopropyltris(dimethylamido)tin) in the obtained concentrated solution, i.e., the synthetic tin compound, are shown in Table 2 below.

In the Examples B1-1 to B1-7, the target tin compound (1) was obtained at a high purity from the synthesized tin compounds. Further, it was possible to suppress the compound (2) which is difficult to remove by distillation.

### Example B1-8

A 100 mL four-neck flask (shielded from light) equipped with a tightly sealed magnetic stirring device (stirring: rod-shaped stirrer tip, diameter 15 mm, material PTFE) and a cooling condenser (cooling water 10° C.) was used. The pressure was reduced to 3 kPa or lower, and then N₂ replacement was performed three times. Hexane (5.0 mL, water content 10 ppm) and isopropyltris(dimethylamido)tin (5.0 g, 16.8 mmol of the tin compound P2 after being purified by distillation obtained in Example 2-1) were added, and the mixture was stirred at 1000 rpm, and the internal temperature was adjusted to 20° C. in a temperature-controlled water bath. Then, while stirring was performed at 1,000 rpm [stirring blade tip speed (m/s)=3.14×0.015×1000/60=0.785 (m/s)], t-amyl alcohol (made by MERCK, water content 15 ppm), (4.60 g, 52.1 mmol, 3.1 equivalents) of 22° C. was added while the temperature (contact temperature T1) was maintained in the range of 20-30° C. Next, the temperature was raised to 50° C. and the mixture was stirred for 3 h, and then the resulting reaction liquid was filtered under N₂ for 5 minutes using a glass filter (filter: Kiriyama funnel filter paper 5B made by Kiriyama Mfg. Co., Ltd., 60 mm diameter, the entire filter being shielded from light) to obtain a transparent filtrate. Then, the resulting reaction liquid was stirred while being shielded from light, and the solvent was concentrated under a reduced pressure (10 hPa, 40° C.) until no distillate was observed, thereby obtaining a concentrated solution of a synthetic tin compound containing isopropyltri-t-amyloxytin. The obtained concentrated solution was filled into a light-shielded glass container (brown glass container) under an N₂ atmosphere. The resulting isopropyltri-t-amyloxytin after the reaction was identified by NMR, and its purity as measured by ¹¹⁹Sn-NMR was 99.3%.
¹¹⁹Sn-NMR(223.8 MHz; C₆D₆): δ −218 ppm.
¹H-NMR (400 MHz; C₆D₆): δ 1.5-1,6 (m, 7H), 1.28 (s, 18H), 1.22 (d, 6H), 0.94 (t, 9H).

### Comparative Example B1-1

A follow-up test of the Examples (Experiment H) disclosed in US Patent Application Publication No. 2022/0242888 (A1) was conducted under the conditions shown in Table 2 below. Compared with the Examples, the purity of the tin compound (1) in the synthesized tin compound was lower, and there was a large amount of the compound (2) that was difficult to remove by distillation.

### Comparative Example B1-2

The same experiment as in the Example B1-1 was performed under conditions where the contact temperature T1 was between −4 and −2° C. There was a large amount of the compound (2) that was difficult to remove by distillation.

### Comparative Example B1-3

Except that the stirring speed in the Example B1-1 was changed to 100 rpm [blade tip speed (m/s) 3.14×0.35×100/60=0.16 (m/s)], the same experiment as in the Example B1-1 was performed, and it was found that the purity of the tin compound (1) was reduced compared to that in the Example B1-1, and a synthetic tin compound was obtained in which there was a large amount of the compound (2) that was difficult to remove by distillation.

### Comparative Example B1-4

Except that the water content of the hexane (organic solvent S1) used in the Example B1-1 was changed to 3 ppm, the same experiment as in Example B1-1 was performed, and it was found that, compared to the Example B1-1, a tin compound having a lower purity of the tin compound (1) was obtained.

### Comparative Example B1-5

Except that the water content of the hexane (organic solvent S1) used in the Example B1-1 was changed to 100 ppm, the same experiment as in the Example B1-1 was performed, and it was found that, compared to the Example B1-1, a tin compound having a lower purity of the tin compound (1) was obtained.

### Comparative Example B1-6

An experiment corresponding to the Example 1-8 was carried out by referring to the method described in Example 5 of JP-A 2021-519340. Specifically, a 100 mL 4-neck flask (shielded from light) equipped with a tightly sealed magnetic stirring device (stirring: rod-shaped stirrer tip, diameter 15 mm, material PTFE) and a cooling condenser (cooling water 10° C.) was used. The pressure was reduced to 3 kPa or lower, and then N₂ replacement was performed three times. Isopropyltris(dimethylamido)tin (5.0 g, 16.8 mmol of the tin compound P2 after being purified by distillation obtained in the Example 2-1) was added, stirred at 1,000 rpm, and cooled in a dry ice bath (dry ice/isopropanol) without adding a solvent. Then, isopropyl tris (dimethylamido) tin) solidified and could no longer be stirred. The stirring in the flask stopped, and a mixed liquid of t-amyl alcohol (made by MERCK, water content 15 ppm) (4.60 g, 52.1 mmol, 3.1 equivalents)/hexane (5.0 mL, water content 10 ppm) of 22° C. was added, the contact temperature T1 was between −50 and −30° C., and after more than half of it was added, stirring was possible, but the stirrability during adding of it was worse than that of Example 1-8. Next, the temperature was raised to 50° C. and the mixture was stirred for 3 h, and then the resulting reaction liquid was filtered under N₂ for 5 minutes using a glass filter (filter: Kiriyama funnel filter paper 5B made by Kiriyama Mfg. Co., Ltd., 60 mm diameter, the entire filter being shielded from light) to obtain a transparent filtrate. Then, the resulting reaction liquid was stirred while being shielded from light, and the solvent was concentrated under a reduced pressure (10 hPa, 40° C.) until no distillate was observed, thereby obtaining a concentrated solution of a synthetic tin compound containing isopropyltri-t-amyloxytin. The obtained concentrated solution was filled into a light-shielded glass container (brown glass container) under an N₂ atmosphere. The isopropyltri-t-amyloxytin obtained after the reaction was identified by NMR, and its purity measured by ¹¹⁹Sn-NMR was 97.2%. Compared to Example 1-8, a tin compound with a lower purity was obtained.

TABLE 2

| | Conditions for | | | | | | | | | | | |
|---|---|---|---|---|---|---|---|---|---|---|---|---|
| | preparing the reactant M1 | | | Reaction conditions of the tin | | | | | | | | |
| | | Curing | | compound B1 and reactant M1 | | | | Sn-NMR- | | | | |
| | Temperature | temperature | Curing | Lowest | Highest | | | 18 ppm | −64 ppm | | −120 ppm | |
| | when adding | after adding | time | contact | contact | Jacket | Water | Chemical | Chemical | −82 ppm | Chemical | |
| | dimethyl- | dimethyl- | after | temper- | temper- | temper- | in the | compound | compound | Chemical | compound | Other |
| | amine | amine | adding | ature | ature | ature | solvent | (2) | (1) | compound | (3) | Other |
| | (° C.) | (° C.) | (h) | T1 (° C.) | T1 (° C.) | (° C.) | (ppm) | R₂SnX₂ | RSnX₃ | (4) | SnX₄ | impurities |
| Example | 0 | 0 | 3 | 12 | 15 | 12 | 10 | 0.14% | 98.01% | 1.25% | 0.00% | 0.60% |
| 1-1 | | | | | | | | | | | | |
| Example | 0 | 24 | 5 | 22 | 24 | 22 | 10 | 0.02% | 96.85% | 3.08% | 0.00% | 0.05% |
| 1-2 | | | | | | | | | | | | |
| Example | 0 | 0 | 3 | 29 | 33 | 29 | 19 | 0.05% | 97.80% | 0.94% | 0.00% | 1.22% |
| 1-3 | | | | | | | | | | | | |
| Example | 0 | 0 | 3 | 39 | 42 | 40 | 10 | 0.03% | 97.03% | 1.21% | 0.00% | 1.72% |
| 1-4 | | | | | | | | | | | | |
| Example | 0 | 0 | 16 | 22 | 25 | 22 | 19 | 0.04% | 99.14% | 0.58% | 0.00% | 0.24% |
| 1-5 | | | | | | | | | | | | |
| Example | 0 | 0 | 3 | 23 | 25 | 23 | 39 | 0.05% | 98.41% | 0.89% | 0.00% | 0.65% |
| 1-6 | | | | | | | | | | | | |
| Example | 0 | 0 | 0 | 21 | 26 | 20 | 23 | 0.04% | 97.19% | 2.57% | 0.00% | 0.20% |
| 1-7 | | | | | | | | | | | | |
| Example | 0 | 0 | 3 | −4 | −1 | −5 | 10 | 0.08% | 97.17% | 1.79% | 0.00% | 0.96% |
| 1-8 | | | | | | | | | | | | |
| Example | 0 | 5 | 3 | −5 | −1 | 5 | 19 | 0.13% | 97.61% | 2.26% | 0.00% | 0.00% |
| 1-9 | | | | | | | | | | | | |
| Com- | 0 | 0 | 5 | −11 | −3 | −11 | 10 | 0.48% | 95.10% | 0.42% | 0.00% | 4.00% |
| parative | | | | | | | | | | | | |
| example | | | | | | | | | | | | |
| 1-1 | | | | | | | | | | | | |
| Com- | 10 | 27 | 5 | −4 | −2 | −5 | 10 | 0.19% | 97.92% | 1.86% | 0.00% | 0.03% |
| parative | | | | | | | | | | | | |
| example | | | | | | | | | | | | |
| 1-2 | | | | | | | | | | | | |

As shown in Table 2 above, the production method of this embodiment can reduce impurities that are difficult to remove by distillation and efficiently produce a high-purity monoalkyltin compound.

### Second Embodiment

### Example B2-1

In the same way as in Examples B1-1 to B1-7, a synthetic tin compound containing the tin compound (A1) was synthesized and purified by distillation under the following conditions. Specifically, 3.1 kg of the synthetic tin compound was introduced into a distillation device under an N₂ inert gas atmosphere, and simple distillation was carried out under a reduced pressure and heating to obtain 2.3 kg of the corresponding purified tin composition as a fraction.

### (Conditions)

Distillation device: A glass simple distillation device wrapped in a light-shielding cloth
Distillation conditions: internal temperature: 70-80° C., reduced pressure: 0.3 kPa

The results of a content analysis of isopropyl tris(dimethylamido)tin (compound (1)) in the tin composition P2 purified by distillation are shown in Table 3 below.

TABLE 3

| | Sn-NMR- | | | | |
|---|---|---|---|---|---|
| | 18 ppm | −64 ppm | −82 ppm | −120 ppm | |
| | Chemical | chemical | Chemical | Chemical | Other |
| | compound | compound | compound | compound | Other |
| | (2) R₂SnX₂ | (1) RSnX₃ | (4) | (3) SnX₄ | impurities |
| Example | 0.09% | 99.41% | 0.50% | 0.00% | 0.00% |
| 2-1 | | | | | |

As can be seen from Table 3 above, by reducing the compound (2), which is difficult to remove by distillation, in the state of a synthetic tin compound before distillation (crude product after reaction), it was possible to obtain the target product with a high yield and high purity by simple distillation without using a distillation column or performing a reflux or fractional distillation.

### GROUP C EXAMPLES

### Organotin Compounds

The details of some distillation examples are shown below, and each organotin compound may be referred to as follows. The peak shift (ppm) in ¹¹⁹Sn-NMR is also shown.
Organotin compound (a1)
iPrSn(NMe₂)₃: isopropyltris(dimethylamino)tin, ¹¹⁹Sn-NMR: −64 ppm.
Organotin compound (a2)
iPr2Sn(NMe₂)₂: a diisopropyl form, ¹¹⁹Sn-NMR: −18 ppm.
Organotin compound (a3)
Sn(NMe₂)₄: a tetrakisamide form, ¹¹⁹Sn-NMR: −119 ppm.
Organotin compound (a4)
iPrSn(NMe₂)₂N(Me)CH₂NMe₂ ¹¹⁹Sn-NMR: −84 ppm.

### [Crude Product C1]

The crude product of iPrSn(NMe₂)₃ was prepared. A composition analysis of it detected 97.89 mol % of iPrSn(NMe₂)₃, 0.73 mol % of Sn(NMe₂)₄, and other impurities.

### Example C1-1

Into a light-shielded brown flask, 58 g of the crude product C1 was placed under an N₂ gas atmosphere. Diethanolamine (DEA) (cas 111-42-2, purity 99% or higher, 0.61 g (5.8 mmol)) was added as an additive to the crude product C1 (197 mmol, assuming iPrSn(NMe₂)₃(MW294) was 100 mol %). The mixture was then stirred at 25° C. for 3 hours. The mixture was then distilled in a column containing SUS packing (product name: Pro-Pak Distillation Packing 0.16) to obtain a purified product as a fraction. The purified product was analyzed by ¹¹⁹Sn-NMR, and Sn(NMe₂)₄ and iPr₂Sn(NMe₂)₂ were not detected.

Here, the amount of Sn(NMe₂)₄ in the crude product could be calculated to be about 1.44 mmol, so diethanolamine was used in an amount of about 4.0 equivalents relative to the amount of Sn(NMe₂)₄.

### Example C1-2

The additive was changed to N-methyldiethanolamine (5.8 mmol). The purified product obtained by distillation under the same conditions was analyzed by ¹¹⁹Sn-NMR, and Sn(NMe₂)₄ and iPr₂Sn(NMe₂)₂ were not detected.

### Example C1-3

The additive was changed to ethylenediamine (5.8 mmol). The purified product obtained by distillation under the same conditions was analyzed by ¹¹⁹Sn-NMR, and Sn(NMe₂)₄ and iPr₂Sn(NMe₂)₂ were not detected.

### Example C1-4

The additive was changed to a resin adsorbent having a thiol functional group (product name: DuPont AmberSep GT75). 250 g of the additive was used (added in 5 separate portions of 50 g each). After stirring for 12 hours, filtration was performed. After the additive was added, the mixture was stirred overnight, and insoluble matter and resin were removed by filtration to obtain a solution. The purified product obtained by distillation under the same conditions was analyzed by ¹¹⁹ Sn-NMR, and Sn(NMe₂)₄ and iPr₂Sn(NMe₂)₂ were not detected.

### [Crude Product C2]

iPrSn(NMe₂)₃ was prepared. Its composition was analyzed, 96.5 mol % of iPrSn(NMe₂)₃, 1.01 mol % of Sn(NMe₂)₄, and other impurities were detected.

### Example C2-1

Into a light-shielded brown flask, 45 g of the crude product C2 was placed under an N₂ gas atmosphere. 0.49 g (4.64 mmol, 300 mol % relative to Sn(NMe₂)₄) of diethanolamine (DEA) (cas 111-42-2, purity >99%) was added as an additive to the crude product C2 (containing 153 mmol of iPrSn(NMe₂)₃ taken as 100 mol %, and 1.55 mmol of Sn(NMe₂)₄). Then, the mixture was mixed for 1 hour by stirring at 400 rpm and 25° C. The solution obtained from the reaction was allowed to stand, and the resulting supernatant (a liquid obtained by separating the solid by decantation) was analyzed by ¹¹⁹Sn-NMR to determine the purity of iPrSn(NMe₂)₃ and the content of Sn(NMe₂)₄.

### Example C2-2

Into a light-shielded brown flask, 45 g of crude product C2 was placed under an N₂ gas atmosphere. A THF solution containing 0.49 g (300 mol % equivalent to 4.64 mmol of Sn(NMe₂)₄) of diethanolamine (cas 111-42-2) (a solution in which DEA was uniformly dissolved at a concentration of 13 wt %, containing 87 wt % of THF, 3.3 g) was added as an additive to the crude product C2 (containing 153 mmol equivalent of iPrSn(NMe₂)₃ taken as 100 mol %, and 1.55 mmol of Sn(NMe₂)₄) under stirring at 400 rpm and 25° C. At the time when the THF solution of DEA was added to iPrSn(NMe₂)₃, they were compatible and quickly mixed. Then, they were further mixed for 1 hour with stirring at 400 rpm and 25° C. The obtained reaction solution was allowed to stand, and the resulting supernatant (the liquid obtained by separating the solid by decantation) was analyzed by ¹¹⁹Sn-NMR to determine the purity of iPrSn(NMe₂)₃ and the content of Sn(NMe₂)₄.

### Examples C2-2, C2-3, C2-4, C2-5, C2-6, and C2-7

The conditions were changed as shown in Table 4.

### Comparative Example C2-1

Referring to Example Part A of JP-A2023-27327 (Imperial), tris(2-aminoethyl)amine (TREN, manufactured by TCI, purity >98%) was used in an amount equivalent to 1.2 mol % relative to Sn(NMe₂)₄. Other than this, the same conditions as described in Example C2-1 were used.

### Comparative Example C2-2

In the method of Comparative Example 2-1, the amount added was changed to 3.0 mol %.

TABLE 4

| | Additive | DEA etc. | | | | Organotin | Organotin |
|---|---|---|---|---|---|---|---|
| | DEA | solution | Stirring | Reaction | Reaction | compound | compound |
| | etc. | concentration | speed | temperature | time | (a1) | (a3) |
| | (mol %) | (wt %) | (rpm) | (° C.) | (h) | mol % | mol % |
| Before | 0 | — | — | — | — | 96.5% | 1.01 |
| mixing DEA | | | | | | | |
| Example 2-1 | 3 | 100% | 400 | 25 | 1 hr | 96.9% | ND |
| | | (No THF | | | | | |
| | | dilution) | | | | | |
| Example 2-2 | 1 | 13% | 400 | 25 | 1 hr | 96.8% | 0.52 |
| Example 2-3 | 2 | 13% | 400 | 25 | 1 hr | 97.2% | 0.10 |
| Example 2-4 | 3 | 13% | 400 | 25 | 1 hr | 97.3% | ND |
| Example 2-5 | 5 | 13% | 400 | 25 | 1 hr | 97.1% | ND |
| Example 2-6 | 3 | 13% | 400 | 5 | 1 hr | 97.4% | ND |
| Example 2-7 | 3 | 13% | 400 | 50 | 1 hr | 97.1% | ND |
| Comparative | TREN | 100% | 400 | 25 | 1 hr | 96.1% | 0.10 |
| example 2-1 | 1.2 | | | | | | |
| Comparative | TREN | 100% | 400 | 25 | 1 hr | 92.4% | ND |
| example 2-2 | 3 | | | | | | |

In the method of the examples, the amount of Sn(NMe₂)₄, which is difficult to remove by distillation, was reduced, and the purity of iPrSn(NMe₂)₃ was increased. In particular, when the amount added was 3 mol % or more as in Examples C2-1 and C2-4 to C2-7, Sn(NMe₂)₄ could be removed to a level that was undetectable in the NMR analysis (lower detection limit of 0.01% or less). On the other hand, as shown in the Comparative Examples C2-1 and C2-2, when tris(2-aminoethyl)amine was used, although a reduction in Sn(NMe₂)₄ was confirmed, the purity of iPrSn(NMe₂)₃ was reduced.

From the above results, it can be said that Sn(NMe₂)₄, which is difficult to remove by distillation, can be efficiently removed by adding an additive. In addition, as shown in some examples, when an organic solvent THF compatible with both the additive and iPrSn(NMe₂)₃ was used, the additive and iPrSn(NMe₂)₃ were mixed more quickly, so a condition for better operability was created.

### Example C3-1 (Prophetic)

The liquids obtained by filtration in Example C2-4 are distilled in columns containing SUS packing (product name: Pro-Pak Distillation Packing 0.16). The fraction from the distillation was the product. The product obtained by distillation is analyzed in the same way as described above. In the ¹¹⁹Sn-NMR analysis, it is predicted that iPrSn(NMe₂)₃ with a purity of >99.9% is obtained, and Sn(NMe₂)₄ is not detected.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-2. (canceled)

3. A method of synthesizing a monoalkyl tin triamide compound having formula (1) and containing no detectable amount of a dialkyl tin diamide compound having formula (2): 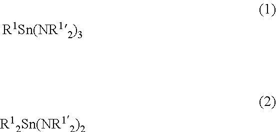
wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dialkylamide having a concentration in the solution of up to about 10 wt %;
(b) preparing a premix solution comprising tetrachlorotin and an alkyltrichloro tin compound R¹SnCl₃ in a second solvent, wherein an amount of the tetrachlorotin in the premix solution is about 0.1 to about 5 mol % relative to the amount of the alkyl trichlorotin compound;
(c) adding the premix solution to the lithium dimethylamide at about −10° C. to about 10° C. to produce a reaction mixture, wherein the amount of lithium dimethylamide in the reaction mixture is at least about 3.09 equivalents relative to the amount of the alkyl trichlorotin compound;
(d) removing the LiCl salt product by filtration; and
(e) removing the first solvent and the second solvent under vacuum to produce a product containing the monoalkyl tin triamide having formula (1) and no detectable amount of the dialkyl tin diamide compound having formula (2).

4. A method of synthesizing a monoalkyl tin triamide compound having formula (1) and containing no detectable amount of a dialkyl tin diamide compound having formula (2): 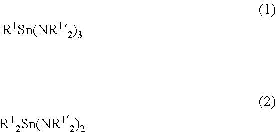
wherein R¹ and R^{1′} are each independently a primary alkyl group having about 1 to about 10 carbon atoms or a secondary alkyl group having about 3 to about 10 carbon atoms, the method comprising:
(a) lithiating a dialkylamine in a solution containing a first solvent to produce a lithium dimethylamide having a concentration in the solution of up to about 10 wt %;
(b) adding a solution of tetrachlorotin in a second solvent to the lithium dialkylamide at about −15° C. to about 0° C. to produce a reaction mixture containing about 0.3% to about 2 mol % tetrakis(dialkylamino)tin relative to an amount of the lithium dialkylamide;
(c) adding a solution of an alkyl trichlorotin compound R¹SnCl₃ in a third solvent to the reaction mixture at about −15° C. to about 10° C., wherein the amount of lithium dimethylamide in the reaction mixture is at least about 3.09 equivalents relative to the amount of the alkyl trichlorotin compound and wherein the amount of tetrachlorotin in the reaction mixture is about 0.1 mol % to about 5 mol % relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

5. A method of synthesizing a monoalkyl tin triamide compound having formula (1) and containing no detectable amount of a dialkyl tin diamide compound having formula (2): 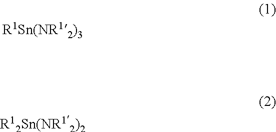
wherein R¹ and R^{1′} are each independently a primary alkyl group having about 1 to 10 carbon atoms or a secondary alkyl group having about 3 to 10 carbon atoms, the method comprising:
(a) lithiating a dialkylamine in a solution containing a first solvent to produce a lithium dimethylamide having a concentration in the solution of up to about 10 wt %;
(b) adding a solution of tetrakis(dialkylamino)tin in a second solvent to the lithium dimethylamide at about −15° C. to about 0° C. to produce a reaction mixture, wherein an amount of tetrakis(dialkylamino)tin in the reaction mixture is about 0.3 mol % to about 2 mol % relative to the amount of the lithium dialkylamide;
(c) adding a solution of an alkyl trichlorotin compound R¹SnCl₃ in a third solvent to the reaction mixture at about −15° C. to about 0° C., wherein the amount of lithium dimethylamide in the reaction mixture is at least about 3.09 equivalents relative to the amount of the alkyl trichlorotin compound;
(d) removing the LiCl salt product by filtration; and
(e) removing the first solvent, the second solvent, and the third solvent under vacuum to produce a product containing the monoalkyl tin triamide having formula (1) and no detectable amount of the dialkyl tin diamide compound having formula (2).

6. The method according to claim 3, wherein R¹ is an isopropyl group and the compound having formula (1) has formula (3):

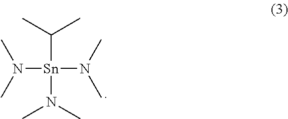

7. The method according to claim 4, wherein R¹ is an isopropyl group and the compound having formula (1) has formula (3):

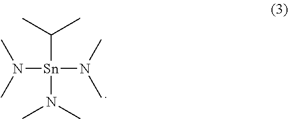

8. The method according to claim 5, wherein R¹ is an isopropyl group and the compound having formula (1) has formula (3):

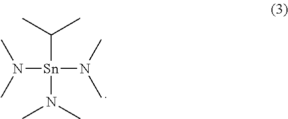

9. (canceled)

10. The method according to claim 6, wherein the compound having formula (1) contains no detectable amount of substances having a chemical shift in a ¹¹⁹Sn NMR spectrum around −84 ppm.

11. The method according to claim 7, wherein the compound having formula (1) contains no detectable amount of substances having a chemical shift in a ¹¹⁹Sn NMR spectrum around −84 ppm.

12. The method according to claim 8, wherein the compound having formula (1) contains no detectable amount of substances having a chemical shift in a ¹¹⁹Sn NMR spectrum around −84 ppm.

13. A method for producing a tin composition (P1) comprising a monoalkyl tin compound having formula (A1) and a purity of at least about 80 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T1: 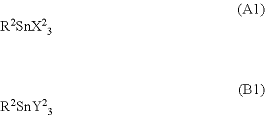
wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13.

14. A method for producing a tin composition (P1) comprising a monoalkyl tin compound having formula (A1) and a purity of at least about 80 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1, wherein the blending is performed at the contact temperature T1 for at least half of the time period t, and wherein a lower limit of T1 is a temperature at which a formation ratio (A1)/(A2) of the monoalkyl tin compound having formula (A1) from a reaction intermediate R²SnX²₂Y² to the dialkyltin compound having formula (A2) from a disproportionation of R²SnX²₂Y² is 600 or more and an upper limit of T1 is less than a lowest value of the decomposition temperatures of (B1), (A1) and (M1), and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T1: 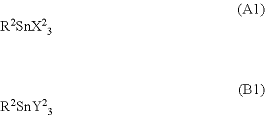
wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13.

15. The method according to claim 13, wherein a temperature fluctuation range when the raw material tin compound (B1) and the reactant (M1) are in contact is 10° C. or less.

16. The method according to claim 14, wherein a temperature range of T1 is about 22° C. to about 30° C.

17. The method according to claim 13, wherein the method is performed using a reactor with a jacket than can be heated and cooled, and wherein a temperature difference between the contact temperature (T1) and a jacket temperature is maintained within about 10° C.

18. A method for producing a tin composition (P11) comprising a monoalkyl tin compound having formula (A11), the method comprising contacting a raw material tin compound having formula (B11) and a reactant (M11) in an organic solvent and blending the raw material tin compound having formula (B11) and the reactant (M11) in the organic solvent for a blending time period t at a contact temperature T1, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B11) is blended with the reactant (M11) at the contact temperature T1, or
(b) at least 50% by weight of the reactant (M11) is blended with the raw material tin compound having formula (B 11) at the contact temperature T1: 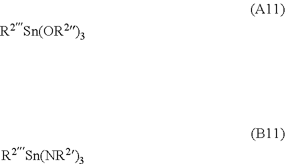
wherein each R^{2″″} is independently a secondary or tertiary organic group having about 3 to 30 carbon atoms, which may be substituted with at least one halogen atom, oxygen atom or nitrogen atom; each R^{2′} is independently an organic group having about 1 to 10 carbon atoms, which may be the same or different and may be substituted with at least one halogen atom; each R^{2″} is independently an organic group having about 2 to 10 carbon atoms, which may be the same or different and may be substituted with at least one halogen atom, and wherein when there is more than one R^{2″} in a molecule, the structures may be different from each other, and may be bonded together to form a cyclic structure; and
wherein (M11) is a compound having formula HOR^{2″}.

19. The method according to claim 18, wherein a temperature fluctuation range when the raw tin compound (B 11) and the reactant (M11) are in contact is 10° C. or less.

20. The method according to claim 18, wherein a temperature range of T1 is about 22° C. to about 30° C.

21. The method according to claim 18, wherein the method is performed using a reactor with a jacket than can be heated and cooled, and wherein a temperature difference between the contact temperature (T1) and a jacket temperature is maintained within about 10° C.

22. A method for producing a tin composition (P1) comprising a monoalkyl tin compound having formula (A1) and a purity of at least about 80 mol %, the method comprising contacting a raw material tin compound having formula (B1) and a reactant (M2) in an organic solvent and blending the raw material tin compound having formula (B1) and the reactant (M2) in the organic solvent for a blending time period t at a contact temperature T1, wherein the blending is performed at the contact temperature T1 for at least half of the time period t, wherein the contact temperature T1 is in a range of about 10° C. to about 70° C., and wherein:
at least 50% by weight of the raw material tin compound (B1) is blended with the reactant (M2), or the blade tip speed, calculated by the following formula as the agitation speed when at least 50% by weight of the raw material tin compound (B1) is blended with the reactant (M2), is 1.2 m/s or higher;
blade tip speed (m/s)=3.14×number of revolutions (rpm)×diameter of mixing blade (m)/60: 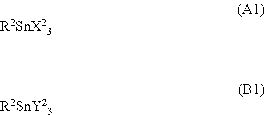
wherein R² is an organic group having about 1 to 30 carbon atoms, which may be substituted with at least one halogen, oxygen, or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M2) is a compound having formula MX², MX²₂, MX²₃, or HX² where M represents a metal atom of Group 1, 2, 12, or 13.

23. The method according to claim 22, wherein the agitation speed during contact is at least about 100 rpm.

24. The method according to claim 22, wherein the concentration of the raw tin compound (B1) in the organic solvent is 15 mass % or less.

25. The method according to claim 22, wherein at least one of the raw tin compound (B1) and the reactant (M2) is dispersed as a solid without being dissolved in the organic solvent.

26. A method for producing a tin composition (P1) comprising a monoalkyl tin compound having formula (A1) and a purity of at least about 80 mol %, the method comprising contacting a raw material tin compound having formula (B1) and a reactant (M2) in an organic solvent and blending the raw material tin compound having formula (B1) and the reactant (M2) in the organic solvent for a blending time period t at a contact temperature T1, wherein the blending is performed at the contact temperature T1 for at least half of the time period t, and wherein the contact temperature T1 is in a range of about 10° C. to about 70° C., and wherein the organic solvent has a moisture content of 10 to 80 ppm: 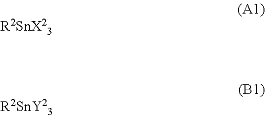
wherein R² is an organic group having about 1 to 30 carbon atoms, which may be substituted with at least one halogen, oxygen or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M2) is a compound having formula MX², MX²₂, MX²₃, or HX² where M represents a metal atom of Group 1, 2, 12, or 13.

27. The method for producing a tin composition according to claim 26, wherein the method is performing in a reactor capable of decompression and under a N₂ atmosphere, the method further comprising performing a N₂ replacement operation by reducing a pressure in the reactor below 1 kPa and introducing N₂ two or more times to prevent entry of water from outside the system while maintaining the N₂ atmosphere.

28. The method according to claim 13, wherein the raw tin compound (B1) is monoalkyltin trichloride.

29. The method according to claim 13, wherein M in the reactant (M1) is a group 1 metal atom.

30. The method according to claim 13, further comprising preparing the reactant (M1) and bringing the reactant (M1) into contact with the raw material tin compound (B1) within about 3 to 48 hours after the preparation.

31. The method according to claim 13, wherein a purity of the monoalkyltin compound (A1) in the tin composition (P1) is 90 mol % or more.

32. The method according to claim 13 wherein a content of a dialkyltin compound (A2) in the tin composition (P1) is 3 mol % or less:

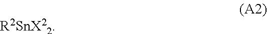

33. The method according to claim 13, wherein in the monoalkyltin compound (A1), a difference in molecular weight between substituents R² and X² is about 30 or less.

34. The method according to claim 18, wherein in the monoalkyltin compound (A11), a difference in molecular weight between substituents R^{2″″} and OR^{2″} is 30 or less.

35. The method according to claim 13, wherein reactant (M11) is a secondary or tertiary alcohol.

36. The method according to claim 13, wherein an amount of the raw material tin compound (B1) is about 10 mol or more.

37. The method according to claim 13, wherein the method further comprises a filtering step after the blending step.

38. The method according to claim 13, wherein the method is performed in a reactor having a volume of between about 100 mL and 50 kL.

39. A method for purifying the tin composition (P1) produced by the method according to claim 13, the method comprising performing a simple distillation of the tin composition (P1) to produce a purified tin compound (P2) having a monoalkyltin compound (A1) with a purity of about 99 mol % or more.

40. A method for producing an organotin compound, comprising steps of:
mixing a crude product containing an organotin compound having formula (a1) with an additive (b1) to form a mixture (x1) containing the crude product and the additive (b1), and
recovering the organotin compound (a1) having a purity of 95 mol % or higher by distilling the mixture (x1) containing the crude product and the additive (b1): 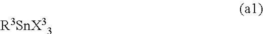
wherein in the formula (a1), R³ represents a hydrocarbon group having about 1 to 30 carbon atoms, which may each be substituted with a halogen atom, an oxygen atom, or a nitrogen atom,
each X³ is independently OR^{3′} or NR^{3′}₂, wherein R^{3′} is a hydrocarbon group having about 1 to 30 carbon atoms, which may each be substituted with a halogen atom, an oxygen atom, or a nitrogen atom, the three R^{3′} may be the same or different from each other; and R³ and R^{3′} may be bonded to each other to form a cyclic structure;
the additive (b1) is a hydrocarbon compound containing about 2 to about 20 carbon atoms substituted with at least one nitrogen and/or oxygen atom and satisfies a condition (1a) and a condition (2):
condition (1a): when the number of nitrogen atoms in the hydrocarbon compound is m and the number of oxygen atoms is n, m is 0, 1, 2 or 3, n is 0, 1, 2 or 3, and m+n is 2 or 3;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

41. The method according to claim 40, wherein the additive (b1) has a nitrogen atom and m is 1, 2 or 3.

42. The method according to claim 40, wherein the additive (b1) has an oxygen atom and n is 1, 2 or 3.

43. The method according to claim 40, wherein m+n is 3.

44. The method according to claim 40, wherein the hydrocarbon compound is an aliphatic hydrocarbon compound.

45. The method according to claim 40, wherein the hydrocarbon compound is an aliphatic saturated hydrocarbon compound.

46. The method according to claim 40, wherein mixture (x1) further contains an organotin compound having formula (a3), and wherein an amount of the additive (b1) in the mixture is about 0.5 to 10 times an amount of the organotin compound having formula (a3):

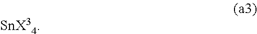

47. A method for producing an organotin compound, comprising:
mixing a crude product containing an organotin compound having formula (a1) with an additive (b2) to form a mixture (x2) containing the crude product and the additive (b2),
wherein the mixture (x2) further contains an organotin compound having formula (a3), and wherein an amount of the additive (b2) in the mixture is about 0.5 to 10 times an amount of the organotin compound having formula (a3): 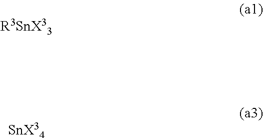
wherein R³ represents a hydrocarbon group having about 1 to 30 carbon atoms, which may each be substituted with a halogen atom, an oxygen atom, or a nitrogen atom, and
each X³ is independently OR^{3′} or NR^{3′}₂, wherein R^{3′} is a hydrocarbon group having about 1 to 30 carbon atoms, which may be substituted with a halogen atom, an oxygen atom, or a nitrogen atom, the three R^{3′} may be the same or different from each other; and R³ and R^{3′} may be bonded to each other to form a cyclic structure;
the additive (b2) is a hydrocarbon compound containing about 2 to about 20 carbon atoms substituted with at least one nitrogen and/or oxygen atom and satisfies a condition (1b) and a condition (2):
condition (1b): when the number of nitrogen atoms in the hydrocarbon compound is m and the number of oxygen atoms is n, m is 0, 1, 2, 3, 4, or 5, n is 0, 1, 2, 3, 4, or 5, and m+n is 2, 3 4, 5,6, 7, 8, 9, or 10;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

48. The production method according to claim 47, further comprising a step of recovering the organotin compound (a1) with a purity of 95 mol % or higher by distilling the mixture (x2) containing the crude product and the additive (b2).

49. A method for producing an organotin compound, comprising steps of:
mixing a crude product containing an organotin compound having formula (a1) with an additive (b3) to form a mixture (x3) containing the crude product and the additive (b3), and
recovering the organotin compound (a1) with a purity of 95 mol % or higher by distilling the mixture (x3) containing the crude product and the additive (b3); 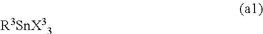
wherein in the formula (a1), R³ represents a hydrocarbon group having about 1 to 30 carbon atoms, which may be substituted with a halogen atom, an oxygen atom, or a nitrogen atom, and
each X³ is independently OR^{3′} or NR^{3′}₂, wherein R^{3′} is a hydrocarbon group having about 1 to 30 carbon atoms, which may be substituted with a halogen atom, an oxygen atom, or a nitrogen atom, the three R^{3′} may be the same or different from each other; and R³ and R^{3′} may be bonded to each other to form a cyclic structure; and
the additive (b3) is a polymer resin containing sulfur atoms.

50. A method for producing an organotin compound, comprising steps of:
mixing a crude product containing an organotin compound having formula (a1) with an additive (b2) and an organic solvent to form a mixture (x4) containing the crude product, the additive (b2), and the organic solvent, and
recovering the organotin compound (a1) with a purity of 95 mol % or higher by distilling the mixture (x4) containing the crude product, the additive (b2), and the organic solvent, wherein
a content of the organic solvent in the mixture (x4) is 100 parts by mass or more relative to 100 parts by mass of the additive (b2); 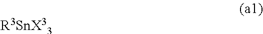
wherein R³ represents a hydrocarbon group having about 1 to 30 carbon atoms, which may be substituted with a halogen atom, an oxygen atom, or a nitrogen atom, and
each X³ is independently OR^{3′} or NR^{3′}₂, wherein R^{3′} is a hydrocarbon group having about 1 to 30 carbon atoms, which may be substituted with a halogen atom, an oxygen atom, or a nitrogen atom, the three R^{2′} may be the same or different from each other; and R³ and R^{3′} may be bonded to each other to form a cyclic structure;
the additive (b2) is a hydrocarbon compound containing about 2 to about 20 carbon atoms substituted with at least one nitrogen and/or oxygen atom and satisfies a condition (1b) and a condition (2):
condition (1b): when the number of nitrogen atoms in the hydrocarbon compound is m and the number of oxygen atoms is n, m is 0, 1, 2, 3, 4, or 5, n is 0, 1, 2, 3, 4, or 5, and m+n is 2, 3 4, 5,6, 7, 8, 9, or 10;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

51. The method according to claim 40, wherein a difference in molecular weight between R³ and X³ in the organotin compound (a1) is 50 or less.

52. The method according to claim 40, wherein the mixing of the crude product containing the organotin compound (a1) with the additive (b1) or (b2) and the distillation are carried out under a condition of protection from light.

[symbol]

53. The method according to claim 40, further comprising, after the distillation, filling the organotin compound (a1) into a storage container under an inert atmosphere.

54. A method for producing a tin composition (P1) comprising a monoalkyl tin compound having formula (A1) and a purity of at least about 95 mol %, the method comprising contacting a raw material tin compound having formula (B1) and a reactant (M1) in an organic solvent and blending the raw material tin compound having formula (B1) and the reactant (M1) in the organic solvent for a blending time period t at a contact temperature T1 to produce a crude product, wherein the blending is performed at the contact temperature T1 for at least half of the time period t, and wherein the contact temperature T1 is in a range of about 10° C. to about 70° C., and wherein:
(a) at least 50% by weight of the raw material tin compound having formula (B1) is blended with the reactant (M1) at the contact temperature T1, or
(b) at least 50% by weight of the reactant (M1) is blended with the raw material tin compound having formula (B1) at the contact temperature T1: 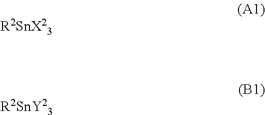
wherein R² is an organic group having about 1 to 30 carbon atoms, which may be substituted with at least one halogen, oxygen or nitrogen atom, each X² is independently selected from the group consisting of OR^{2′}, NR^{2′}₂, and C≡CR^{2′}, wherein each R^{2′} is independently an organic group having about 1 to 10 carbon atoms, which may be substituted with at least one halogen, and wherein when there is more than one R^{2′} in a molecule, they may be the same or different and may be bonded together to form a cyclic structure, each Y² is independently selected from the group consisting of halogen atoms, OR′, and NR′₂, and
wherein (M1) is a compound having formula MX², MX²₂, or MX²₃, where M represents a metal atom of Group 1, 2, 12, or 13;
the method further comprising:
mixing the crude product with an additive (b1) to form a mixture (y1) containing the crude product and the additive (b1), and
recovering the tin composition (P1) comprising the monoalkyl tin compound having formula (A1) and a purity of at least about 95 mol %, by distilling the mixture (y1) containing the crude product and the additive (b1):
wherein the additive (b1) is a hydrocarbon compound containing about 2 to about 20 carbon atoms substituted with at least one nitrogen and/or oxygen atom and satisfies a condition (1a) and a condition (2):
condition (1a): when the number of nitrogen atoms in the hydrocarbon compound is m and the number of oxygen atoms is n, m is 0, 1, 2 or 3, n is 0, 1, 2 or 3, and m+n is 2 or 3;
condition (2): in the hydrocarbon compound, when the number of nitrogen atoms among the m nitrogen atoms that are bonded to a hydrogen atom is defined as x, and the number of oxygen atoms among the n oxygen atoms that are bonded to a hydrogen atom is defined as y, x+y is 1 or more.

55. (canceled)

56. A method of purifying a mixture containing a monoalkyl tin triamide compound having formula (1), no detectable amount of a dialkyl tin diamide compound having formula (2), and about 0.1 to about 5 mol % of a tetrakis(dialkylamino)tin compound having formula (8): 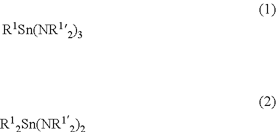 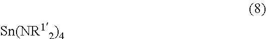
wherein R¹ and R^{1′} are each independently a primary alkyl group having about 1 to about 10 carbon atoms or a secondary alkyl group having about 3 to about 10 carbon atoms, the method comprising:
adding at least one weak acid, at least one weak base, at least one weak acid polymer, or at least one weak base polymer to the mixture containing compounds (1) and (8) at about 15° C. to about 30° C. to produce a reaction mixture, wherein an amount of the at least one weak acid, the at least one weak base, the at least one weak acid polymer, or the at least one weak base polymer in the reaction mixture is at least about 2 equivalents relative to the amount of compound (8); and
removing reaction byproducts to produce a mixture containing the monoalkyl tin triamide having formula (1), no detectable amount of the dialkyl tin diamide compound having formula (2), and no detectable amount of the tetrakis(dimethylamino)tin compound having formula (8).

57. A method of purifying a mixture containing a monoalkyl tin triamide compound having formula (1), less than 0.05 mol % of a dialkyl tin diamide compound having formula (2), and about 0.1 to about 5 mol % of a tetrakis(dialkylamino)tin compound having formula (8): 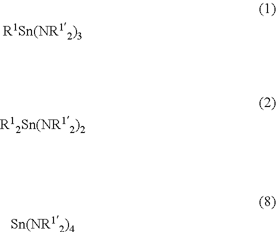
wherein R¹ and R^{1′} are each independently a primary alkyl group having about 1 to about 10 carbon atoms or a secondary alkyl group having about 3 to about 10 carbon atoms, the method comprising:
(a) adding at least one weak acid, at least one weak base, at least one weak acid polymer, or at least one weak base polymer to the mixture containing compounds (1) and (8) at about 15° C. to about 30° C. to produce a reaction mixture, wherein an amount of the at least one weak acid, the at least one weak base, the at least one weak acid polymer, or the at least one weak base polymer in the reaction mixture is at least about 2 equivalents relative to the amount of compound (8); and
(b) removing reaction byproducts to produce a mixture containing the monoalkyl tin triamide having formula (1), less than 0.05 mol % of the dialkyl tin diamide compound having formula (2), and less than 0.1 mol % of the tetrakis(dimethylamino)tin compound having formula (8).

58. The method according to claim 56, wherein the at least one weak acid, at least one weak base, at least one weak acid polymer, or at least one weak base polymer comprises a resin functionalized with at least one of OH, COOH, NH₂, or SH.
